(19) United States
(12) Patent Application Publication
(10) Pub. No.: US 2019/0130189 A1
(43) Pub. Date: May 2, 2019

(54) SUPPRESSING DUPLICATED BOUNDING BOXES FROM OBJECT DETECTION IN A VIDEO ANALYTICS SYSTEM

(71) Applicant: QUALCOMM Incorporated, San Diego, CA (US)

(72) Inventors: Yang ZHOU, San Jose, CA (US); Ying CHEN, San Diego, CA (US); Ning BI, San Diego, CA (US)

(21) Appl. No.: 16/160,970

(22) Filed: Oct. 15, 2018

Related U.S. Application Data
(60) Provisional application No. 62/579,032, filed on Oct. 30, 2017.

(51) Int. Cl. G06K 9/00; G06T 7/246

(52) U.S. Cl. CPC G06K 9/00718; G06T 2207/30196; G06T 2207/10016; G06T 7/248

(57) ABSTRACT

Techniques and systems are provided for tracking objects in one or more video frames. For example, based on an application of an object detector to at least one key frame in the one or more video frames, a first set of bounding regions for a video frame can be obtained. A group of bounding regions can be determined from the first set of bounding regions. A bounding region from the group of bounding regoins can be removed based on one or more metrics associated with the bounding region. Object tracking for the video frame can be performed using an updated set of bounding regions that is based on removal of the bounding region from the group of bounding regions.

### CROSS-REFERENCE TO RELATED APPLICATIONS

This application claims the benefit of U.S. Provisional Application No. 62/579,032, filed Oct. 30, 2017, which is hereby incorporated by reference, in its entirety and for all purposes.

### FIELD

The present disclosure generally relates to video analytics for detecting and tracking objects, and more specifically to techniques and systems for detecting and tracking objects in images by applying complex object detection in a video analytics system.

### BACKGROUND

Many devices and systems allow a scene to be captured by generating video data of the scene. For example, an Internet protocol camera (IP camera) is a type of digital video camera that can be employed for surveillance or other applications. Unlike analog closed circuit television (CCTV) cameras, an IP camera can send and receive data via a computer network and the Internet. The video data from these devices and systems can be captured and output for processing and/or consumption. In some cases, the video data can also be processed by the devices and systems themselves.

Video analytics, also referred to as Video Content Analysis (VCA), is a generic term used to describe computerized processing and analysis of a video sequence acquired by a camera. Video analytics provides a variety of tasks, including immediate detection of events of interest, analysis of pre-recorded video for the purpose of extracting events in a long period of time, and many other tasks. For instance, using video analytics, a system can automatically analyze the video sequences from one or more cameras to detect one or more events. The system with the video analytics can be on a camera device and/or on a server. In some cases, video analytics system can send alerts or alarms for certain events of interest. More advanced video analytics is needed to provide efficient and robust video sequence processing.

### BRIEF SUMMARY

In some examples, techniques and systems are described for detecting and tracking objects in images by applying a hybrid video analytics system. The hybrid video analytics system combines blob detection and complex object detection to more accurately detect objects in the images. For example, a blob detection component of a video analytics system can use image data from one or more video frames to generate or identify blobs for the one or more video frames. A blob represents at least a portion of one or more objects in a video frame (also referred to as a “picture”). Blob detection can utilize background subtraction to determine a background portion of a scene and a foreground portion of scene. Blobs can then be detected based on the foreground portion of the scene. Blob bounding regions (e.g., bounding boxes or other bounding region) can be associated with the blobs, in which case a blob and a blob bounding region can be used interchangeably. A blob bounding region is a shape surrounding a blob, and can be used to represent the blob.

A complex object detector can be used to detect (e.g., classify and/or localize) objects in one or more images. In some cases, the complex object detector can be part of a deep learning system and can apply a trained classification network. For instance, the complex object detector can apply a deep learning neural network (also referred to as deep networks and deep neural networks) to identify objects in an image based on past information about similar objects that the detector has learned based on training data (e.g., training data can include images of objects used to train the system). Any suitable type of deep learning network can be used, including convolutional neural networks (CNNs), autoencoders, deep belief nets (DBNs), Recurrent Neural Networks (RNNs), among others. One illustrative example of a deep learning network detector that can be used includes a single-shot object detector (SSD). Another illustrative example of a deep learning network detector that can be used includes a You only look once (YOLO) detector. Any other suitable deep network-based detector can be used.

In some cases, the hybrid video analytics system can apply the complex object detector at a very low frequency, while background subtraction based tracking and detection can be performed for the majority of the frames. For example, the complex object detector can apply neural network-based object detection (e.g., using a trained network) every N frames, with N being determined based on the delay required to process a frame using the deep learning network and the frame rate of the video sequence. Each frame for which the complex object detector is applied is referred to as a key frame. For other frames (non-key frames), blob detection is applied without also applying the complex object detector. An object classified by the complex object detector can be localized using a bounding region (e.g., a bounding box or other bounding region) representing the classified object. A bounding region generated using the complex object detector is referred to herein as a detector bounding region. For key frames, the bounding regions from the neural network-based object detection and the bounding regions from background subtraction can be combined to generate a final set of bounding regions for tracking. For non-key frames, the bounding regions from the key frames can be used assist in the tracking process.

After the object detection process, there may be false positive detector bounding regions output to the tracking system of the video analytics system. The tracking system may include the false positive bounding regions in the final set of bounding regions, which may lead to tracking of false positive blobs (e.g., due to a tracker associated with the false positive blob being output to the system, such as being displayed as a tracked object). One potential source of false positive detector bounding regions may be due to, for example, the complex object detection process generating multiple bounding regions for a single object.

The techniques and systems described herein operate to identify and remove multiple (duplicated) bounding regions being generated for a single object. By removing the duplicated bounding regions, the likelihood of outputting false positive detector bounding regions to the tracking system can be reduced, and the likelihood of tracking false positive blobs can be reduced.

According to at least one example, a method of tracking objects in one or more video frames is provided. The method includes obtaining, based on an application of an object detector to at least one key frame in the one or more video frames, a first set of bounding regions for a video frame, wherein the first set of bounding regions are associated with detection of one or more objects in the video frame. The method further comprises determining a group of bounding regions from the first set of bounding regions, wherein the group of bounding regions includes at least a first bounding region and a second bounding region. The method further comprises removing a bounding region from the group of bounding regions based on one or more metrics associated with the bounding region. The method further comprises performing object tracking for the video frame using an updated set of bounding regions. The updated set of bounding regions is based on removal of the bounding region from the group of bounding regions .

In another example, an apparatus for tracking objects in one or more video frames is provided. The apparatus comprises a memory configured to store the one or more video frames and a processor coupled to the memory. The processor is configured to obtain, based on an application of an object detector to at least one key frame in the one or more video frames, a first set of bounding regions for a video frame, wherein the first set of bounding regions are associated with detection of one or more objects in the video frame. The processor is further configured to determine a group of bounding regions from the first set of bounding regions, wherein the group of bounding regions includes at least a first bounding region and a second bounding region. The processor is further configured to remove a bounding region from the group of bounding regions based on one or more metrics associated with the bounding region, and perform object tracking for the video frame using an updated set of bounding regions. The updated set of bounding regions is based on removal of the bounding region from the group of bounding regions.

In another example, a non-transitory computer-readable medium is provided. The non-transitory computer-readable medium stores instructions that, when executed by one or more processors, cause the one or more processor to: obtain, based on an application of an object detector to at least one key frame in the one or more video frames, a first set of bounding regions for a video frame, wherein the first set of bounding regions are associated with detection of one or more objects in the video frame; determine a group of bounding regions from the first set of bounding regions, wherein the group of bounding regions includes at least a first bounding region and a second bounding region; remove a bounding region from the group of bounding regions based on one or more metrics associated with the bounding region; and perform object tracking for the video frame using an updated set of bounding regions, the updated set of bounding regions being based on removal of the bounding region from the group of bounding regions.

In another example, an apparatus for tracking objects in one or more video frames is provided. The apparatus comprises means for obtaining, based on an application of an object detector to at least one key frame in the one or more video frames, a first set of bounding regions for a video frame, wherein the first set of bounding regions are associated with detection of one or more objects in the video frame. The apparatus further comprises means for determining a group of bounding regions from the first set of bounding regions, wherein the group of bounding regions includes at least a first bounding region and a second bounding region. The apparatus further comprises means for removing a bounding region from the group of bounding regions based on one or more metrics associated with the bounding region, and means for performing object tracking for the video frame using an updated set of bounding regions. The updated set of bounding regions is based on removal of the bounding region from the group of bounding regions.

As used herein, a key frame is a frame from the sequence of video frames to which the object detector is applied. In some cases, blob detection is performed for each video frame of the sequence of video frames to detect one or more blobs in each video frame, and the object detector is applied only to key frames of the sequence of video frames. The frames that the object detector (e.g., the complex object detector) are not applied to are referred to as non-key frames.

In some aspects, the methods, apparatuses, and computer-readable medium described above further comprise determining the one or more metrics, where determining the one or more metrics comprises: determining an intersection-over-union (IoU) ratio associated with the first bounding region and the second bounding region in the group; and determining the IoU ratio exceeds a first ratio threshold.

In some aspects, the bounding region is removed based on determining that the IoU ratio exceeds the first ratio threshold.

In some aspects, the methods, apparatuses, and computer-readable medium described above further comprise determining the one or more metrics, where determining the one or more metrics comprises: determining a first area of a first intersection region between the first bounding region and the second bounding region in the group; determining a second area of the first bounding region, the first bounding region being smaller than the second bounding region; and determining a second ratio between the first area and the second area.

In some aspects, the methods, apparatuses, and computer-readable medium described above further comprise determining that the second ratio exceeds a second ratio threshold, the second ratio threshold being higher than the first ratio threshold. The bounding region can be removed based on the second ratio exceeding the second ratio threshold.

In some aspects, the methods, apparatuses, and computer-readable medium described above further comprise determining that the second ratio exceeds a third ratio threshold, the third ratio threshold being lower than the second ratio threshold; and determining that the first bounding region intersects with the second bounding region at a pre-determined location. The bounding region can be removed based on the second ratio exceeding the third ratio threshold and the first bounding region intersecting with the second bounding region at the pre-determined location.

In some aspects, the methods, apparatuses, and computer-readable medium described above further comprise determining that the second ratio exceeds a fourth ratio threshold, the fourth ratio threshold being lower than each of the second ratio threshold and the third ratio threshold; and determining that a confidence level of at least one of the first bounding region and the second bounding region is below a first confidence threshold. The bounding region can be removed based on the second ratio exceeding the fourth ratio threshold and the confidence level of at least one of the first bounding region and the second bounding region being below the first confidence threshold.

In some aspects, the group further comprises a third bounding region. In some aspects, determining the one or more metrics comprises: determining a third area of a third intersection region between the first bounding region and the third bounding region; determining a fourth area of a fourth intersection region between the second bounding region and the third bounding region; determining an aggregate area based on the third area and the fourth area; and determining a third ratio between an area of the third bounding region and the aggregate area.

In some aspects, the bounding region can be removed based on determining that the third ratio exceeds a fifth ratio threshold, that each of a first confidence level of the first bounding region and a second confidence level of the second bounding region exceeds a second confidence threshold, and that a third confidence level of the third bounding region is below a third confidence threshold, the third confidence threshold being lower than the second confidence threshold.

In some aspects, the bounding region is removed from the group further based on a confidence level associated with the bounding region. In such aspects, the methods, apparatuses, and computer-readable medium described above can further comprise: determining the bounding region is associated with a minimum confidence level within the group of bounding regions; and determining the minimum confidence level is below a fourth confidence threshold. In some aspects, the bounding region is removed from the group of bounding regions based on the minimum confidence level being below the fourth confidence threshold. The object tracking for the video frame may be performed without the bounding region. In some aspects, the confidence level associated with the bounding region indicates a probability of the bounding region enclosing an object of the one or more objects.

In some aspects, the methods, apparatuses, and computer-readable medium described above can further comprise: determining the first bounding region is the bounding region to be removed from the group of bounding regions; determining whether the first bounding region and the second bounding region are associated with different objects; and maintaining the first bounding region in the group in response to determining that the first bounding region and the second bounding region are associated with different objects. In some aspects, the object tracking for the video frame is performed with the updated set of bounding regions including the first bounding region.

In some aspects, the determination of whether the first bounding region and the second bounding region are associated with different objects can be based on trajectories of the first bounding region and the second bounding region across a plurality of video frames.

In some aspects, the methods, apparatuses, and computer-readable medium described above further comprise detecting one or more blobs for the video frame, and obtaining a set of blob bounding regions based on the detected one or more blobs. The object tracking can be performed based on a combination of the updated set of bounding regions and the set of blob bounding regions.

In some aspects, the object detector comprises a feature-based detector. In some aspects, the object detector is a complex object detector. In some aspects, the object detector is based on a trained classification network. For example, the object detector can be a complex object detector that is based on a trained classification network.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and embodiments, will become more apparent upon referring to the following specification, claims, and accompanying drawings.

### BRIEF DESCRIPTION OF THE DRAWINGS

Illustrative embodiments of the present application are described in detail below with reference to the following figures:

FIG. 1 is a block diagram illustrating an example of a system including a video source and a video analytics system, in accordance with some examples.

FIG. 2 is an example of a video analytics system processing video frames, in accordance with some examples.

FIG. 3 is a block diagram illustrating an example of a blob detection system, in accordance with some examples.

FIG. 4 is a block diagram illustrating an example of an object tracking system, in accordance with some examples.

FIG. 5A, FIG. 5C, and FIG. 5D are video frames of an environment with various objects, and FIG. 5B illustrates an intersection and union of two bounding boxes for analyzing the video frames of FIG. 5A, FIG. 5C, and FIG. 5D in accordance with some examples.

FIG. 6 is a block diagram illustrating an example of a video analytics system including a deep learning system, in accordance with some examples.

FIG. 7 is a block diagram illustrating a duplicated bounding box suppression system, in accordance with some examples.

FIG. 8 is a diagram illustrating an example of three bounding boxes to be analyzed by the duplicated bounding box suppression system of FIG. 7, in accordance with some examples.

FIG. 9-FIG. 14 are flowcharts illustrating examples of an object detection processes, in accordance with some examples.

FIG. 15-FIG. 32 are images illustrating representative results generated by the duplicated bounding box suppression system of FIG. 7, in accordance with some examples.

FIG. 33 is a block diagram illustrating an example of a deep learning network, in accordance with some examples.

FIG. 34 is a block diagram illustrating an example of a convolutional neural network, in accordance with some examples.

FIG. 35A-FIG. 35C are diagrams illustrating an example of a single-shot object detector, in accordance with some examples.

FIG. 36A-FIG. 36C are diagrams illustrating an example of a you only look once (YOLO) detector, in accordance with some examples.

### DETAILED DESCRIPTION

Certain aspects and embodiments of this disclosure are provided below. Some of these aspects and embodiments may be applied independently and some of them may be applied in combination as would be apparent to those of skill in the art. In the following description, for the purposes of explanation, specific details are set forth in order to provide a thorough understanding of embodiments of the application. However, it will be apparent that various embodiments may be practiced without these specific details. The figures and description are not intended to be restrictive.

The ensuing description provides exemplary embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the application as set forth in the appended claims.

Specific details are given in the following description to provide a thorough understanding of the embodiments. However, it will be understood by one of ordinary skill in the art that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Also, it is noted that individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

Furthermore, embodiments may be implemented by hardware, software, firmware, middleware, microcode, hardware description languages, or any combination thereof. When implemented in software, firmware, middleware or microcode, the program code or code segments to perform the necessary tasks (e.g., a computer-program product) may be stored in a computer-readable or machine-readable medium. A processor(s) may perform the necessary tasks.

A video analytics system can obtain a sequence of video frames from a video source and can process the video sequence to perform a variety of tasks. One example of a video source can include an Internet protocol camera (IP camera) or other video capture device. An IP camera is a type of digital video camera that can be used for surveillance, home security, or other suitable application. Unlike analog closed circuit television (CCTV) cameras, an IP camera can send and receive data via a computer network and the Internet. In some instances, one or more IP cameras can be located in a scene or an environment, and can remain static while capturing video sequences of the scene or environment.

An IP camera can be used to send and receive data via a computer network and the Internet. In some cases, IP camera systems can be used for two-way communications. For example, data (e.g., audio, video, metadata, or the like) can be transmitted by an IP camera using one or more network cables or using a wireless network, allowing users to communicate with what they are seeing. In one illustrative example, a gas station clerk can assist a customer with how to use a pay pump using video data provided from an IP camera (e.g., by viewing the customer's actions at the pay pump). Commands can also be transmitted for pan, tilt, zoom (PTZ) cameras via a single network or multiple networks. Furthermore, IP camera systems provide flexibility and wireless capabilities. For example, IP cameras provide for easy connection to a network, adjustable camera location, and remote accessibility to the service over Internet. IP camera systems also provide for distributed intelligence. For example, with IP cameras, video analytics can be placed in the camera itself. Encryption and authentication is also easily provided with IP cameras. For instance, IP cameras offer secure data transmission through already defined encryption and authentication methods for IP based applications. Even further, labor cost efficiency is increased with IP cameras. For example, video analytics can produce alarms for certain events, which reduces the labor cost in monitoring all cameras (based on the alarms) in a system.

Video analytics provides a variety of tasks ranging from immediate detection of events of interest, to analysis of pre-recorded video for the purpose of extracting events in a long period of time, as well as many other tasks. Various research studies and real-life experiences indicate that in a surveillance system, for example, a human operator typically cannot remain alert and attentive for more than 20 minutes, even when monitoring the pictures from one camera. When there are two or more cameras to monitor or as time goes beyond a certain period of time (e.g., 20 minutes), the operator's ability to monitor the video and effectively respond to events is significantly compromised. Video analytics can automatically analyze the video sequences from the cameras and send alarms for events of interest. This way, the human operator can monitor one or more scenes in a passive mode. Furthermore, video analytics can analyze a huge volume of recorded video and can extract specific video segments containing an event of interest.

Video analytics also provides various other features. For example, video analytics can operate as an Intelligent Video Motion Detector by detecting moving objects and by tracking moving objects. In some cases, the video analytics can generate and display a bounding box around a valid object. Video analytics can also act as an intrusion detector, a video counter (e.g., by counting people, objects, vehicles, or the like), a camera tamper detector, an object left detector, an obj ect/asset removal detector, an asset protector, a loitering detector, and/or as a slip and fall detector. Video analytics can further be used to perform various types of recognition functions, such as face detection and recognition, license plate recognition, object recognition (e.g., bags, logos, body marks, or the like), or other recognition functions. In some cases, video analytics can be trained to recognize certain objects. Another function that can be performed by video analytics includes providing demographics for customer metrics (e.g., customer counts, gender, age, amount of time spent, and other suitable metrics). Video analytics can also perform video search (e.g., extracting basic activity for a given region) and video summary (e.g., extraction of the key movements). In some instances, event detection can be performed by video analytics, including detection of fire, smoke, fighting, crowd formation, or any other suitable even the video analytics is programmed to or learns to detect. A detector can trigger the detection of an event of interest and can send an alert or alarm to a central control room to alert a user of the event of interest.

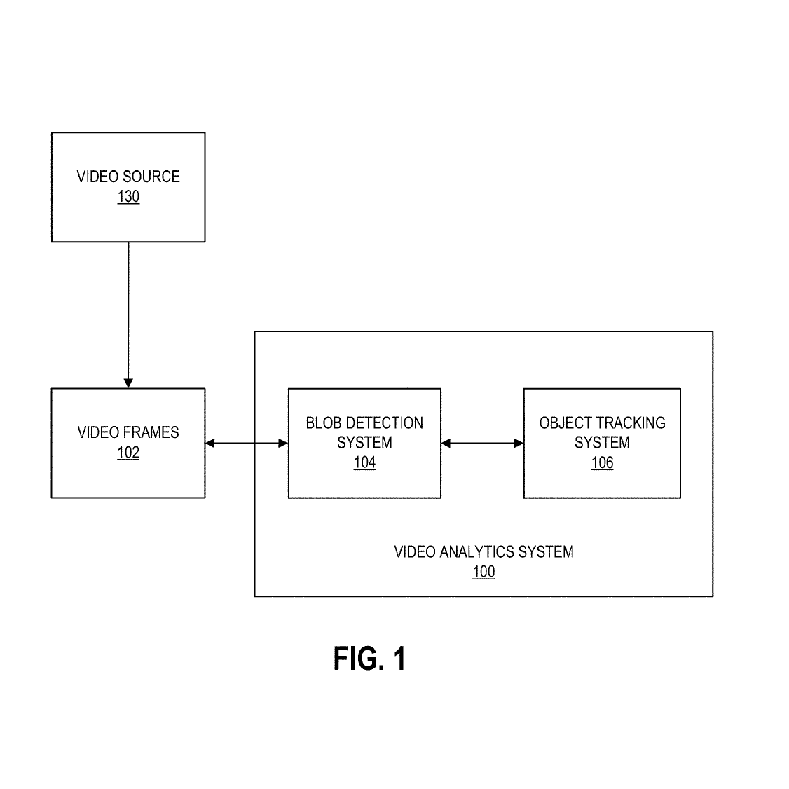

As described in more detail herein, a video analytics system can generate and detect foreground blobs that can be used to perform various operations, such as object tracking (also called blob tracking) and/or the other operations described above. A blob tracker (also referred to as an object tracker) can be used to track one or more blobs in a video sequence using one or more bounding boxes. Details of an example video analytics system with blob detection and object tracking are described below with respect to FIG. 1-FIG. 4.

FIG. 1 is a block diagram illustrating an example of a video analytics system 100. The video analytics system 100 receives video frames 102 from a video source 130. The video frames 102 can also be referred to herein as a video picture or a picture. The video frames 102 can be part of one or more video sequences. The video source 130 can include a video capture device (e.g., a video camera, a camera phone, a video phone, or other suitable capture device), a video storage device, a video archive containing stored video, a video server or content provider providing video data, a video feed interface receiving video from a video server or content provider, a computer graphics system for generating computer graphics video data, a combination of such sources, or other source of video content. In one example, the video source 130 can include an IP camera or multiple IP cameras. In an illustrative example, multiple IP cameras can be located throughout an environment, and can provide the video frames 102 to the video analytics system 100. For instance, the IP cameras can be placed at various fields of view within the environment so that surveillance can be performed based on the captured video frames 102 of the environment.

In some embodiments, the video analytics system 100 and the video source 130 can be part of the same computing device. In some embodiments, the video analytics system 100 and the video source 130 can be part of separate computing devices. In some examples, the computing device (or devices) can include one or more wireless transceivers for wireless communications. The computing device (or devices) can include an electronic device, such as a camera (e.g., an IP camera or other video camera, a camera phone, a video phone, or other suitable capture device), a mobile or stationary telephone handset (e.g., smartphone, cellular telephone, or the like), a desktop computer, a laptop or notebook computer, a tablet computer, a set-top box, a television, a display device, a digital media player, a video gaming console, a video streaming device, or any other suitable electronic device.

The video analytics system 100 includes a blob detection system 104 and an object tracking system 106. Object detection and tracking allows the video analytics system 100 to provide various end-to-end features, such as the video analytics features described above. For example, intelligent motion detection, intrusion detection, and other features can directly use the results from object detection and tracking to generate end-to-end events. Other features, such as people, vehicle, or other object counting and classification can be greatly simplified based on the results of object detection and tracking. The blob detection system 104 can detect one or more blobs in video frames (e.g., video frames 102) of a video sequence, and the object tracking system 106 can track the one or more blobs across the frames of the video sequence. As used herein, a blob refers to foreground pixels of at least a portion of an object (e.g., a portion of an object or an entire object) in a video frame. For example, a blob can include a contiguous group of pixels making up at least a portion of a foreground object in a video frame. In another example, a blob can refer to a contiguous group of pixels making up at least a portion of a background object in a frame of image data. A blob can also be referred to as an object, a portion of an object, a blotch of pixels, a pixel patch, a cluster of pixels, a blot of pixels, a spot of pixels, a mass of pixels, or any other term referring to a group of pixels of an object or portion thereof In some examples, a bounding box can be associated with a blob. In some examples, a tracker can also be represented by a tracker bounding region. A bounding region of a blob or tracker can include a bounding box, a bounding circle, a bounding ellipse, or any other suitably-shaped region representing a tracker and/or a blob. While examples are described herein using bounding boxes for illustrative purposes, the techniques and systems described herein can also apply using other suitably shaped bounding regions. A bounding box associated with a tracker and/or a blob can have a rectangular shape, a square shape, or other suitable shape. In the tracking layer, in case there is no need to know how the blob is formulated within a bounding box, the term blob and bounding box may be used interchangeably.

As described in more detail below, blobs can be tracked using blob trackers. A blob tracker can be associated with a tracker bounding box and can be assigned a tracker identifier (ID). In some examples, a bounding box for a blob tracker in a current frame can be the bounding box of a previous blob in a previous frame for which the blob tracker was associated. For instance, when the blob tracker is updated in the previous frame (after being associated with the previous blob in the previous frame), updated information for the blob tracker can include the tracking information for the previous frame and also prediction of a location of the blob tracker in the next frame (which is the current frame in this example). The prediction of the location of the blob tracker in the current frame can be based on the location of the blob in the previous frame. A history or motion model can be maintained for a blob tracker, including a history of various states, a history of the velocity, and a history of location, of continuous frames, for the blob tracker, as described in more detail below.

In some examples, a motion model for a blob tracker can determine and maintain two locations of the blob tracker for each frame. For example, a first location for a blob tracker for a current frame can include a predicted location in the current frame. The first location is referred to herein as the predicted location. The predicted location of the blob tracker in the current frame includes a location in a previous frame of a blob with which the blob tracker was associated. Hence, the location of the blob associated with the blob tracker in the previous frame can be used as the predicted location of the blob tracker in the current frame. A second location for the blob tracker for the current frame can include a location in the current frame of a blob with which the tracker is associated in the current frame. The second location is referred to herein as the actual location. Accordingly, the location in the current frame of a blob associated with the blob tracker is used as the actual location of the blob tracker in the current frame. The actual location of the blob tracker in the current frame can be used as the predicted location of the blob tracker in a next frame. The location of the blobs can include the locations of the bounding boxes of the blobs.

The velocity of a blob tracker can include the displacement of a blob tracker between consecutive frames. For example, the displacement can be determined between the centers (or centroids) of two bounding boxes for the blob tracker in two consecutive frames. In one illustrative example, the velocity of a blob tracker can be defined as Vₜ=Cₜ−Cₜ₋₁, where Cₜ−Cₜ₋₁=(Cₜₓ−Cₜ₋₁ₓ, C_{ty}−C_{t-1y}). The term Cₜ(Cₜₓ, C_{ty}) denotes the center position of a bounding box of the tracker in a current frame, with Cₜₓ being the x-coordinate of the bounding box, and C_{ty} being the y-coordinate of the bounding box. The term Cₜ₋₁(Cₜ₋₁ₓ, C_{t-1y}) denotes the center position (x and y) of a bounding box of the tracker in a previous frame. In some implementations, it is also possible to use four parameters to estimate x, y, width, height at the same time. In some cases, because the timing for video frame data is constant or at least not dramatically different overtime (according to the frame rate, such as 30 frames per second, 60 frames per second, 120 frames per second, or other suitable frame rate), a time variable may not be needed in the velocity calculation. In some cases, a time constant can be used (according to the instant frame rate) and/or a timestamp can be used.

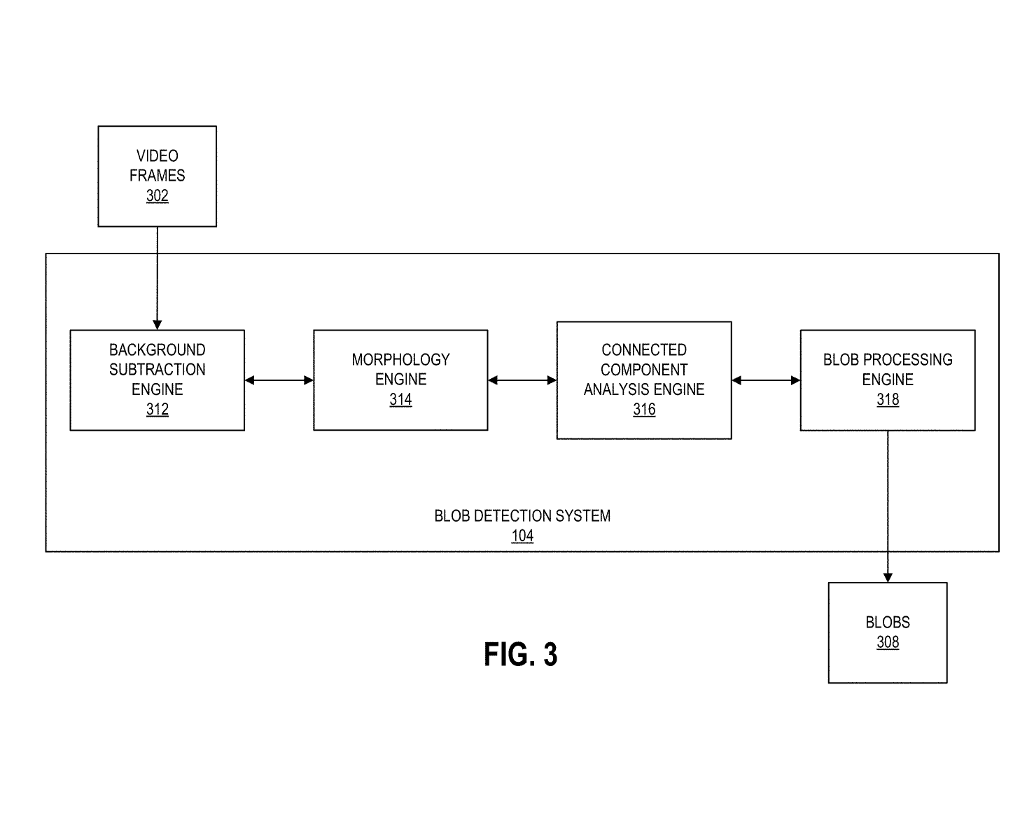

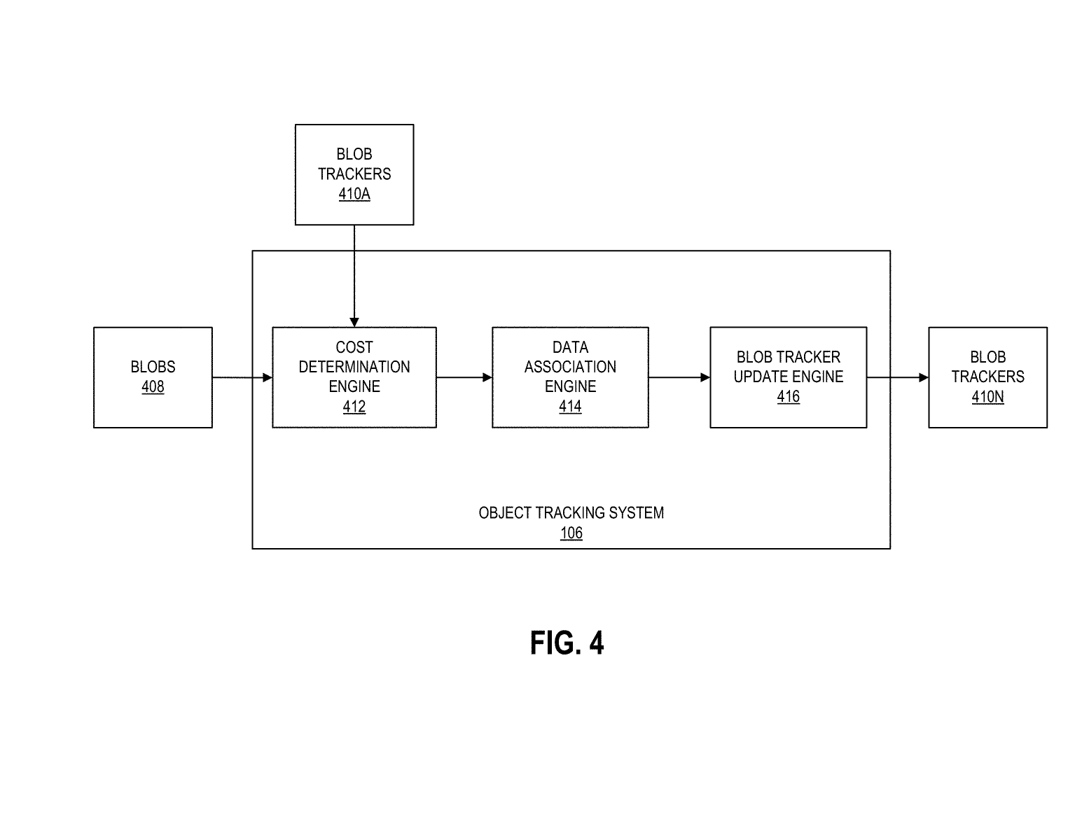

Using the blob detection system 104 and the object tracking system 106, the video analytics system 100 can perform blob generation and detection for each frame or picture of a video sequence. For example, the blob detection system 104 can perform background subtraction for a frame, and can then detect foreground pixels in the frame. Foreground blobs are generated from the foreground pixels using morphology operations and spatial analysis. Further, blob trackers from previous frames need to be associated with the foreground blobs in a current frame, and also need to be updated. Both the data association of trackers with blobs and tracker updates can rely on a cost function calculation. For example, when blobs are detected from a current input video frame, the blob trackers from the previous frame can be associated with the detected blobs according to a cost calculation. Trackers are then updated according to the data association, including updating the state and location of the trackers so that tracking of objects in the current frame can be fulfilled. Further details related to the blob detection system 104 and the object tracking system 106 are described with respect to FIGS. 3-4.

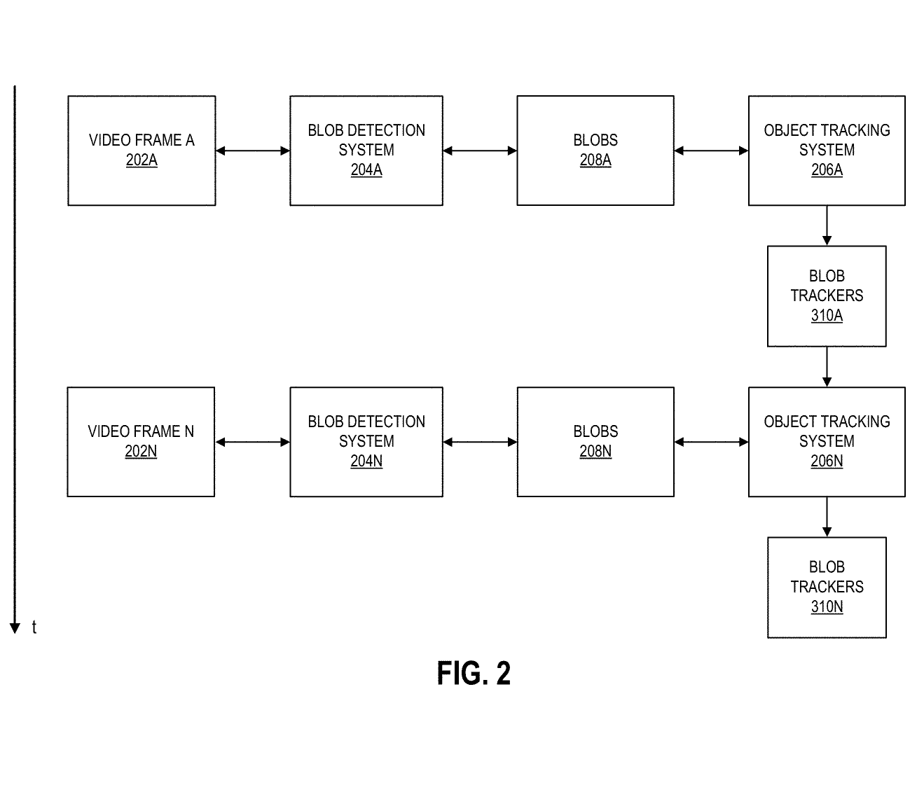

FIG. 2 is an example of the video analytics system (e.g., video analytics system 100) processing video frames across time t. As shown in FIG. 2, a video frame A 202A is received by a blob detection system 204A. The blob detection system 204A generates foreground blobs 208A for the current frame A 202A. After blob detection is performed, the foreground blobs 208A can be used for temporal tracking by the object tracking system 206A. Costs (e.g., a cost including a distance, a weighted distance, or other cost) between blob trackers and blobs can be calculated by the object tracking system 206A. The object tracking system 206A can perform data association to associate or match the blob trackers (e.g., blob trackers generated or updated based on a previous frame or newly generated blob trackers) and blobs 208A using the calculated costs (e.g., using a cost matrix or other suitable association technique). The blob trackers can be updated, including in terms of positions of the trackers, according to the data association to generate updated blob trackers 310A. For example, a blob tracker's state and location for the video frame A 202A can be calculated and updated. The blob tracker's location in a next video frame N 202N can also be predicted from the current video frame A 202A. For example, the predicted location of a blob tracker for the next video frame N 202N can include the location of the blob tracker (and its associated blob) in the current video frame A 202A. Tracking of blobs of the current frame A 202A can be performed once the updated blob trackers 310A are generated.

When a next video frame N 202N is received, the blob detection system 204N generates foreground blobs 208N for the frame N 202N. The object tracking system 206N can then perform temporal tracking of the blobs 208N. For example, the object tracking system 206N obtains the blob trackers 310A that were updated based on the prior video frame A 202A. The object tracking system 206N can then calculate a cost and can associate the blob trackers 310A and the blobs 208N using the newly calculated cost. The blob trackers 310A can be updated according to the data association to generate updated blob trackers 310N.

FIG. 3 is a block diagram illustrating an example of a blob detection system 104. Blob detection is used to segment moving objects from the global background in a scene. The blob detection system 104 includes a background subtraction engine 312 that receives video frames 302. The background subtraction engine 312 can perform background subtraction to detect foreground pixels in one or more of the video frames 302. For example, the background subtraction can be used to segment moving objects from the global background in a video sequence and to generate a foreground-background binary mask (referred to herein as a foreground mask). In some examples, the background subtraction can perform a subtraction between a current frame or picture and a background model including the background part of a scene (e.g., the static or mostly static part of the scene). Based on the results of background subtraction, the morphology engine 314 and connected component analysis engine 316 can perform foreground pixel processing to group the foreground pixels into foreground blobs for tracking purpose. For example, after background subtraction, morphology operations can be applied to remove noisy pixels as well as to smooth the foreground mask. Connected component analysis can then be applied to generate the blobs. Blob processing can then be performed, which may include further filtering out some blobs and merging together some blobs to provide bounding boxes as input for tracking.

The background subtraction engine 312 can model the background of a scene (e.g., captured in the video sequence) using any suitable background subtraction technique (also referred to as background extraction). One example of a background subtraction method used by the background subtraction engine 312 includes modeling the background of the scene as a statistical model based on the relatively static pixels in previous frames which are not considered to belong to any moving region. For example, the background subtraction engine 312 can use a Gaussian distribution model for each pixel location, with parameters of mean and variance to model each pixel location in frames of a video sequence. All the values of previous pixels at a particular pixel location are used to calculate the mean and variance of the target Gaussian model for the pixel location. When a pixel at a given location in a new video frame is processed, its value will be evaluated by the current Gaussian distribution of this pixel location. A classification of the pixel to either a foreground pixel or a background pixel is done by comparing the difference between the pixel value and the mean of the designated Gaussian model. In one illustrative example, if the distance of the pixel value and the Gaussian Mean is less than 3 times of the variance, the pixel is classified as a background pixel. Otherwise, in this illustrative example, the pixel is classified as a foreground pixel. At the same time, the Gaussian model for a pixel location will be updated by taking into consideration the current pixel value.

The background subtraction engine 312 can also perform background subtraction using a mixture of Gaussians (also referred to as a Gaussian mixture model (GMM)). A GMM models each pixel as a mixture of Gaussians and uses an online learning algorithm to update the model. Each Gaussian model is represented with mean, standard deviation (or covariance matrix if the pixel has multiple channels), and weight. Weight represents the probability that the Gaussian occurs in the past history.

P(Xₜ)=Σᵢ₌₁^{K} ω_{i,t}N(Xₜ|μ_{i,t}, Σ_{i,t}) Equation (1)

An equation of the GMM model is shown in equation (1), wherein there are K Gaussian models. Each Guassian model has a distribution with a mean of μ and variance of Σ, and has a weight ω. Here, i is the index to the Gaussian model and t is the time instance. As shown by the equation, the parameters of the GMM change over time after one frame (at time t) is processed. In GMM or any other learning based background subtraction, the current pixel impacts the whole model of the pixel location based on a learning rate, which could be constant or typically at least the same for each pixel location. A background subtraction method based on GMM (or other learning based background subtraction) adapts to local changes for each pixel. Thus, once a moving object stops, for each pixel location of the object, the same pixel value keeps on contributing to its associated background model heavily, and the region associated with the object becomes background.

The background subtraction techniques mentioned above are based on the assumption that the camera is mounted still, and if anytime the camera is moved or orientation of the camera is changed, a new background model will need to be calculated. There are also background subtraction methods that can handle foreground subtraction based on a moving background, including techniques such as tracking key points, optical flow, saliency, and other motion estimation based approaches.

The background subtraction engine 312 can generate a foreground mask with foreground pixels based on the result of background subtraction. For example, the foreground mask can include a binary image containing the pixels making up the foreground objects (e.g., moving objects) in a scene and the pixels of the background. In some examples, the background of the foreground mask (background pixels) can be a solid color, such as a solid white background, a solid black background, or other solid color. In such examples, the foreground pixels of the foreground mask can be a different color than that used for the background pixels, such as a solid black color, a solid white color, or other solid color. In one illustrative example, the background pixels can be black (e.g., pixel color value 0 in 8-bit grayscale or other suitable value) and the foreground pixels can be white (e.g., pixel color value 255 in 8-bit grayscale or other suitable value). In another illustrative example, the background pixels can be white and the foreground pixels can be black.

Using the foreground mask generated from background subtraction, a morphology engine 314 can perform morphology functions to filter the foreground pixels. The morphology functions can include erosion and dilation functions. In one example, an erosion function can be applied, followed by a series of one or more dilation functions. An erosion function can be applied to remove pixels on object boundaries. For example, the morphology engine 314 can apply an erosion function (e.g., FilterErode3×3) to a 3×3 filter window of a center pixel, which is currently being processed. The 3×3 window can be applied to each foreground pixel (as the center pixel) in the foreground mask. One of ordinary skill in the art will appreciate that other window sizes can be used other than a 3×3 window. The erosion function can include an erosion operation that sets a current foreground pixel in the foreground mask (acting as the center pixel) to a background pixel if one or more of its neighboring pixels within the 3×3 window are background pixels. Such an erosion operation can be referred to as a strong erosion operation or a single-neighbor erosion operation. Here, the neighboring pixels of the current center pixel include the eight pixels in the 3×3 window, with the ninth pixel being the current center pixel.

A dilation operation can be used to enhance the boundary of a foreground object. For example, the morphology engine 314 can apply a dilation function (e.g., FilterDilate3×3) to a 3×3 filter window of a center pixel. The 3×3 dilation window can be applied to each background pixel (as the center pixel) in the foreground mask. One of ordinary skill in the art will appreciate that other window sizes can be used other than a 3×3 window. The dilation function can include a dilation operation that sets a current background pixel in the foreground mask (acting as the center pixel) as a foreground pixel if one or more of its neighboring pixels in the 3×3 window are foreground pixels. The neighboring pixels of the current center pixel include the eight pixels in the 3×3 window, with the ninth pixel being the current center pixel. In some examples, multiple dilation functions can be applied after an erosion function is applied. In one illustrative example, three function calls of dilation of 3×3 window size can be applied to the foreground mask before it is sent to the connected component analysis engine 316. In some examples, an erosion function can be applied first to remove noise pixels, and a series of dilation functions can then be applied to refine the foreground pixels. In one illustrative example, one erosion function with 3×3 window size is called first, and three function calls of dilation of 3×3 window size are applied to the foreground mask before it is sent to the connected component analysis engine 316. Details regarding content-adaptive morphology operations are described below.

After the morphology operations are performed, the connected component analysis engine 316 can apply connected component analysis to connect neighboring foreground pixels to formulate connected components and blobs. In some implementation of connected component analysis, a set of bounding boxes are returned in a way that each bounding box contains one component of connected pixels. One example of the connected component analysis performed by the connected component analysis engine 316 is implemented as follows:

for each pixel of the foreground mask {
if it is a foreground pixel and has not been processed, the following steps apply:
   Apply FloodFill function to connect this pixel to other foreground and generate a connected component
   Insert the connected component in a list of connected components.
   Mark the pixels in the connected component as being processed}

The Floodfill (seed fill) function is an algorithm that determines the area connected to a seed node in a multi-dimensional array (e.g., a 2-D image in this case). This Floodfill function first obtains the color or intensity value at the seed position (e.g., a foreground pixel) of the source foreground mask, and then finds all the neighbor pixels that have the same (or similar) value based on 4 or 8 connectivity. For example, in a 4 connectivity case, a current pixel's neighbors are defined as those with a coordination being (x+d, y) or (x, y+d), wherein d is equal to 1 or −1 and (x, y) is the current pixel. One of ordinary skill in the art will appreciate that other amounts of connectivity can be used. Some objects are separated into different connected components and some objects are grouped into the same connected components (e.g., neighbor pixels with the same or similar values). Additional processing may be applied to further process the connected components for grouping. Finally, the blobs 308 are generated that include neighboring foreground pixels according to the connected components. In one example, a blob can be made up of one connected component. In another example, a blob can include multiple connected components (e.g., when two or more blobs are merged together).

The blob processing engine 318 can perform additional processing to further process the blobs generated by the connected component analysis engine 316. In some examples, the blob processing engine 318 can generate the bounding boxes to represent the detected blobs and blob trackers. In some cases, the blob bounding boxes can be output from the blob detection system 104. In some examples, there may be a filtering process for the connected components (bounding boxes). For instance, the blob processing engine 318 can perform content-based filtering of certain blobs. In some cases, a machine learning method can determine that a current blob contains noise (e.g., foliage in a scene). Using the machine learning information, the blob processing engine 318 can determine the current blob is a noisy blob and can remove it from the resulting blobs that are provided to the object tracking engine 106. In some cases, the blob processing engine 318 can filter out one or more small blobs that are below a certain size threshold (e.g., an area of a bounding box surrounding a blob is below an area threshold). In some examples, there may be a merging process to merge some connected components (represented as bounding boxes) into bigger bounding boxes. For instance, the blob processing engine 318 can merge close blobs into one big blob to remove the risk of having too many small blobs that could belong to one object. In some cases, two or more bounding boxes may be merged together based on certain rules even when the foreground pixels of the two bounding boxes are totally disconnected. In some embodiments, the blob detection engine 104 does not include the blob processing engine 318, or does not use the blob processing engine 318 in some instances. For example, the blobs generated by the connected component analysis engine 316, without further processing, can be input to the object tracking system 106 to perform blob and/or obj ect tracking.

In some implementations, density based blob area trimming may be performed by the blob processing engine 318. For example, when all blobs have been formulated after post-filtering and before the blobs are input into the tracking layer, the density based blob area trimming can be applied. A similar process is applied vertically and horizontally. For example, the density based blob area trimming can first be performed vertically and then horizontally, or vice versa. The purpose of density based blob area trimming is to filter out the columns (in the vertical process) and/or the rows (in the horizontal process) of a bounding box if the columns or rows only contain a small number of foreground pixels.

The vertical process includes calculating the number of foreground pixels of each column of a bounding box, and denoting the number of foreground pixels as the column density. Then, from the left-most column, columns are processed one by one. The column density of each current column (the column currently being processed) is compared with the maximum column density (the column density of all columns). If the column density of the current column is smaller than a threshold (e.g., a percentage of the maximum column density, such as 10%, 20%, 30%, 50%, or other suitable percentage), the column is removed from the bounding box and the next column is processed. However, once a current column has a column density that is not smaller than the threshold, such a process terminates and the remaining columns are not processed anymore. A similar process can then be applied from the right-most column. One of ordinary skill will appreciate that the vertical process can process the columns beginning with a different column than the left-most column, such as the right-most column or other suitable column in the bounding box.

The horizontal density based blob area trimming process is similar to the vertical process, except the rows of a bounding box are processed instead of columns. For example, the number of foreground pixels of each row of a bounding box is calculated, and is denoted as row density. From the top-most row, the rows are then processed one by one. For each current row (the row currently being processed), the row density is compared with the maximum row density (the row density of all the rows). If the row density of the current row is smaller than a threshold (e.g., a percentage of the maximum row density, such as 10%, 20%, 30%, 50%, or other suitable percentage), the row is removed from the bounding box and the next row is processed. However, once a current row has a row density that is not smaller than the threshold, such a process terminates and the remaining rows are not processed anymore. A similar process can then be applied from the bottom-most row. One of ordinary skill will appreciate that the horizontal process can process the rows beginning with a different row than the top-most row, such as the bottom-most row or other suitable row in the bounding box.

One purpose of the density based blob area trimming is for shadow removal. For example, the density based blob area trimming can be applied when one person is detected together with his or her long and thin shadow in one blob (bounding box). Such a shadow area can be removed after applying density based blob area trimming, since the column density in the shadow area is relatively small. Unlike morphology, which changes the thickness of a blob (besides filtering some isolated foreground pixels from formulating blobs) but roughly preserves the shape of a bounding box, such a density based blob area trimming method can dramatically change the shape of a bounding box.

Once the blobs are detected and processed, object tracking (also referred to as blob tracking) can be performed to track the detected blobs. FIG. 4 is a block diagram illustrating an example of an object tracking engine 106. The input to the blob/object tracking is a list of the blobs 408 (e.g., the bounding boxes of the blobs) generated by the blob detection engine 104. In some cases, a tracker is assigned with a unique ID, and a history of bounding boxes is kept. Object tracking in a video sequence can be used for many applications, including surveillance applications, among many others. For example, the ability to detect and track multiple objects in the same scene is of great interest in many security applications. When blobs (making up at least portions of objects) are detected from an input video frame, blob trackers from the previous video frame need to be associated to the blobs in the input video frame according to a cost calculation. The blob trackers can be updated based on the associated foreground blobs. In some instances, the steps in object tracking can be conducted in a series manner.

A cost determination engine 412 of the object tracking system 106 can obtain the blobs 408 of a current video frame from the blob detection system 104. The cost determination engine 412 can also obtain the blob trackers 410A updated from the previous video frame (e.g., video frame A 202A). A cost function can then be used to calculate costs between the blob trackers 410A and the blobs 408. Any suitable cost function can be used to calculate the costs. In some examples, the cost determination engine 412 can measure the cost between a blob tracker and a blob by calculating the Euclidean distance between the centroid of the tracker (e.g., the bounding box for the tracker) and the centroid of the bounding box of the foreground blob. In one illustrative example using a 2-D video sequence, this type of cost function is calculated as below:

Cost_{tb}=\sqrt{(tₓ−bₓ)²+(t_{y}−b_{y})²}

The terms (tₓ, t_{y}) and (bₓ, b_{y}) are the center locations of the blob tracker and blob bounding boxes, respectively. As noted herein, in some examples, the bounding box of the blob tracker can be the bounding box of a blob associated with the blob tracker in a previous frame. In some examples, other cost function approaches can be performed that use a minimum distance in an x-direction or y-direction to calculate the cost. Such techniques can be good for certain controlled scenarios, such as well-aligned lane conveying. In some examples, a cost function can be based on a distance of a blob tracker and a blob, where instead of using the center position of the bounding boxes of blob and tracker to calculate distance, the boundaries of the bounding boxes are considered so that a negative distance is introduced when two bounding boxes are overlapped geometrically. In addition, the value of such a distance is further adjusted according to the size ratio of the two associated bounding boxes. For example, a cost can be weighted based on a ratio between the area of the blob tracker bounding box and the area of the blob bounding box (e.g., by multiplying the determined distance by the ratio).

In some embodiments, a cost is determined for each tracker-blob pair between each tracker and each blob. For example, if there are three trackers, including tracker A, tracker B, and tracker C, and three blobs, including blob A, blob B, and blob C, a separate cost between tracker A and each of the blobs A, B, and C can be determined, as well as separate costs between trackers B and C and each of the blobs A, B, and C. In some examples, the costs can be arranged in a cost matrix, which can be used for data association. For example, the cost matrix can be a 2-dimensional matrix, with one dimension being the blob trackers 410A and the second dimension being the blobs 408. Every tracker-blob pair or combination between the trackers 410A and the blobs 408 includes a cost that is included in the cost matrix. Best matches between the trackers 410A and blobs 408 can be determined by identifying the lowest cost tracker-blob pairs in the matrix. For example, the lowest cost between tracker A and the blobs A, B, and C is used to determine the blob with which to associate the tracker A.

Data association between trackers 410A and blobs 408, as well as updating of the trackers 410A, may be based on the determined costs. The data association engine 414 matches or assigns a tracker (or tracker bounding box) with a corresponding blob (or blob bounding box) and vice versa. For example, as described previously, the lowest cost tracker-blob pairs may be used by the data association engine 414 to associate the blob trackers 410A with the blobs 408. Another technique for associating blob trackers with blobs includes the Hungarian method, which is a combinatorial optimization algorithm that solves such an assignment problem in polynomial time and that anticipated later primal-dual methods. For example, the Hungarian method can optimize a global cost across all blob trackers 410A with the blobs 408 in order to minimize the global cost. The blob tracker-blob combinations in the cost matrix that minimize the global cost can be determined and used as the association.

In addition to the Hungarian method, other robust methods can be used to perform data association between blobs and blob trackers. For example, the association problem can be solved with additional constraints to make the solution more robust to noise while matching as many trackers and blobs as possible. Regardless of the association technique that is used, the data association engine 414 can rely on the distance between the blobs and trackers.

Once the association between the blob trackers 410A and blobs 408 has been completed, the blob tracker update engine 416 can use the information of the associated blobs, as well as the trackers' temporal statuses, to update the status (or states) of the trackers 410A for the current frame. Upon updating the trackers 410A, the blob tracker update engine 416 can perform object tracking using the updated trackers 410N, and can also provide the updated trackers 410N for use in processing a next frame.

The status or state of a blob tracker can include the tracker's identified location (or actual location) in a current frame and its predicted location in the next frame. The location of the foreground blobs are identified by the blob detection engine 104. However, as described in more detail below, the location of a blob tracker in a current frame may need to be predicted based on information from a previous frame (e.g., using a location of a blob associated with the blob tracker in the previous frame). After the data association is performed for the current frame, the tracker location in the current frame can be identified as the location of its associated blob(s) in the current frame. The tracker's location can be further used to update the tracker's motion model and predict its location in the next frame. Further, in some cases, there may be trackers that are temporarily lost (e.g., when a blob the tracker was tracking is no longer detected), in which case the locations of such trackers also need to be predicted (e.g., by a Kalman filter). Such trackers are temporarily not shown to the system. Prediction of the bounding box location helps not only to maintain certain level of tracking for lost and/or merged bounding boxes, but also to give more accurate estimation of the initial position of the trackers so that the association of the bounding boxes and trackers can be made more precise.

As noted above, the location of a blob tracker in a current frame may be predicted based on information from a previous frame. One method for performing a tracker location update is using a Kalman filter. The Kalman filter is a framework that includes two steps. The first step is to predict a tracker's state, and the second step is to use measurements to correct or update the state. In this case, the tracker from the last frame predicts (using the blob tracker update engine 416) its location in the current frame, and when the current frame is received, the tracker first uses the measurement of the blob(s) (e.g., the blob(s) bounding box(es)) to correct its location states and then predicts its location in the next frame. For example, a blob tracker can employ a Kalman filter to measure its trajectory as well as predict its future location(s). The Kalman filter relies on the measurement of the associated blob(s) to correct the motion model for the blob tracker and to predict the location of the object tracker in the next frame. In some examples, if a blob tracker is associated with a blob in a current frame, the location of the blob is directly used to correct the blob tracker's motion model in the Kalman filter. In some examples, if a blob tracker is not associated with any blob in a current frame, the blob tracker's location in the current frame is identified as its predicted location from the previous frame, meaning that the motion model for the blob tracker is not corrected and the prediction propagates with the blob tracker's last model (from the previous frame).

Other than the location of a tracker, the state or status of a tracker can also, or alternatively, include a tracker's temporal status. The temporal status can include whether the tracker is a new tracker that was not present before the current frame, whether the tracker has been alive for certain frames, or other suitable temporal status. Other states can include, additionally or alternatively, whether the tracker is considered as lost when it does not associate with any foreground blob in the current frame, whether the tracker is considered as a dead tracker if it fails to associate with any blobs for a certain number of consecutive frames (e.g., two or more), or other suitable tracker states.

There may be other status information needed for updating the tracker, which may require a state machine for object tracking. Given the information of the associated blob(s) and the tracker's own status history table, the status also needs to be updated. The state machine collects all the necessary information and updates the status accordingly. Various statuses can be updated. For example, other than a tracker's life status (e.g., new, lost, dead, or other suitable life status), the tracker's association confidence and relationship with other trackers can also be updated. Taking one example of the tracker relationship, when two objects (e.g., persons, vehicles, or other objects of interest) intersect, the two trackers associated with the two objects will be merged together for certain frames, and the merge or occlusion status needs to be recorded for high level video analytics.

Regardless of the tracking method being used, a new tracker starts to be associated with a blob in one frame and, moving forward, the new tracker may be connected with possibly moving blobs across multiple frames. When a tracker has been continuously associated with blobs and a duration (a threshold duration) has passed, the tracker may be promoted to be a normal tracker. A normal tracker is output as an identified tracker-blob pair. For example, a tracker-blob pair is output at the system level as an event (e.g., presented as a tracked object on a display, output as an alert, and/or other suitable event) when the tracker is promoted to be a normal tracker. In some implementations, a normal tracker (e.g., including certain status data of the normal tracker, the motion model for the normal tracker, or other information related to the normal tracker) can be output as part of object metadata. The metadata, including the normal tracker, can be output from the video analytics system (e.g., an IP camera running the video analytics system) to a server or other system storage. The metadata can then be analyzed for event detection (e.g., by rule interpreter). A tracker that is not promoted as a normal tracker can be removed (or killed), after which the tracker can be considered as dead.

As noted above, blob trackers can have various temporal states, such as a new state for a tracker of a current frame that was not present before the current frame, a lost state for a tracker that is not associated or matched with any foreground blob in the current frame, a dead state for a tracker that fails to associate with any blobs for a certain number of consecutive frames (e.g., 2 or more frames, a threshold duration, or the like), a normal state for a tracker that is to be output as an identified tracker-blob pair to the video analytics system, or other suitable tracker states. Another temporal state that can be maintained for a blob tracker is a duration of the tracker. The duration of a blob tracker includes the number of frames (or other temporal measurement, such as time) the tracker has been associated with one or more blobs.

As previously described, a blob tracker can be promoted or converted to be a normal tracker when certain conditions are met. A tracker is given a new state when the tracker is created and its duration of being associated with any blobs is 0. The duration of the blob tracker can be monitored, as well as its temporal state (new, lost, hidden, or the like). As long as the current state is not hidden or lost, and as long as the duration is less than a threshold duration T1, the state of the new tracker is kept as a new state. A hidden tracker may refer to a tracker that was previously normal (thus independent), but later merged into another tracker C. In order to enable this hidden tracker to be identified later due to the anticipation that the merged object may be split later, it is still kept as associated with the other tracker C which is containing it.

The threshold duration T1 is a duration that a new blob tracker must be continuously associated with one or more blobs before it is converted to a normal tracker (transitioned to a normal state). The threshold duration can be a number of frames (e.g., at least N frames) or an amount of time. In one illustrative example, a blob tracker can be in a new state for 30 frames (corresponding to one second in systems that operate using 30 frames per second), or any other suitable number of frames or amount of time, before being converted to a normal tracker. If the blob tracker has been continuously associated with blobs for the threshold duration (duration>T1), the blob tracker is converted to a normal tracker by being transitioned from a new status to a normal status

If, during the threshold duration T1, the new tracker becomes hidden or lost (e.g., not associated or matched with any foreground blob), the state of the tracker can be transitioned from new to dead, and the blob tracker can be removed from blob trackers maintained for a video sequence (e.g., removed from a buffer that stores the trackers for the video sequence).

In some examples, objects may intersect or group together, in which case the blob detection system can detect one blob (a merged blob) that contains more than one object of interest (e.g., multiple objects that are being tracked). For example, as a person walks near another person in a scene, the bounding boxes for the two persons can become a merged bounding box (corresponding to a merged blob). The merged bounding box can be tracked with a single blob tracker (referred to as a container tracker), which can include one of the blob trackers that was associated with one of the blobs making up the merged blob, with the other blob(s)' trackers being referred to as merge-contained trackers. For example, a merge-contained tracker is a tracker (new or normal) that was merged with another tracker when two blobs for the respective trackers are merged, and thus became hidden and carried by the container tracker.

A tracker that is split from an existing tracker is referred to as a split-new tracker. The tracker from which the split-new tracker is split is referred to as a parent tracker or a split-from tracker. In some examples, a split-new tracker can result when an object is detected as multiple separate blobs, in which case the multiple blobs are associated (or matching or mapping) to one active tracker. For instance, one active tracker can only be mapped to one blob. All the other blobs (the blobs remaining from the multiple blobs that are not mapped to the tracker) cannot be mapped to any existing trackers. In such examples, new trackers will be created for the other blobs, and these new trackers are assigned the state “split-new.” Such a split-new tracker can be referred to as the child tracker of the original tracker its associated blob is mapped to. The corresponding original tracker can be referred to as the parent tracker (or the split-from tracker) of the child tracker. In some examples, a split-new tracker can also result from a merge-contained tracker. As noted above, a merge-contained tracker is a tracker that was merged with another tracker (when two blobs for the respective trackers are merged) and thus became hidden and carried by the container tracker. A merge-contained tracker can be split from the container tracker if the container tracker is active and the container tracker has a mapped blob in the current frame.

As described above, video analytics systems that use motion-based object/blob detection and tracking mainly track moving objects detected as a set of blobs. Each blob does not necessarily correspond to an object. In addition, each blob may not necessarily correspond to a truly moving object. Since the motion detection is performed using background subtraction, the complexity of the solution is not proportional to the number of moving objects in the scene. However, a benefit of video analytics systems that rely on motion-based object/blob detection is that such systems can be performed by relatively low power devices (e.g., less powerful IP camera (IPC) devices). For example, such a video analytics solution could be implemented in a low complexity arm-based chip set, such as the Qualcomm Snapdragon™ 625 (SD625 or the APQ8053 chip). Such a solution could even offer real-time performance (e.g., 30 fps) utilizing only 1 CPU core.

To improve the accuracy of tracking an object, a complex object detector system can also be employed in combination with the aforementioned motion-based object/blob detection system to perform the tracking of an object. The complex object detector system can employ a feature-based scheme to detect or classify objects based on visual features of the objects, and generate a set of detector bounding boxes associated with the classified/detected objects. Various deep learning-based detectors can be used to detect or classify objects in video frames. For example, single shot detector (SSD) is a fast single-shot object detector that can be applied for multiple object categories. A feature of the SSD model is the use of multi-scale convolutional bounding box outputs attached to multiple feature maps at the top of the neural network. SSD can match objects with default boxes of different aspect ratios. Each element of the feature map has a number of default boxes associated with it. Any default box with an intersection-over-union with a ground truth box over a threshold (e.g., 0.4, 0.5, 0.6, or other suitable threshold) can be considered a match for the object. The neural network can also output a probability vector representing the probabilities of the box containing an object of a particular class.

Another deep learning-based detector that can be used to detect or classify objects in video frames includes the You only look once (YOLO) detector, which is an alternative to the SSD object detection system. A YOLO network can divide the image into regions and predicts bounding boxes and probabilities for each region. These bounding boxes are weighted by the predicted probabilities. A confidence score can be provided to indicate how certain it is that the predicted bounding box actually encloses an object.

For each video frame, the video analytics system can generate a final bounding box for tracking a particular object based on a detector bounding box generated by the complex object detector system (e.g., SSD, YOLO, etc.) and a blob bounding box generated by a blob detection system. For example, the blob bounding boxes and the detector bounding boxes can be generated for a same video frame, and can be analyzed to determine a final set of bounding boxes for the video frame. A status can also be determined for each of the bounding boxes, and the associated object tracker, in the final set of bounding boxes. For example, the blob detection can be performed for every frame of a video sequence capturing images of a scene. In some cases, the deep learning system can be applied for only a subset of frames of the video sequence. For example, the deep learning system can apply a deep learning network every N frames, with N being determined based on the delay required to process a frame using the deep learning network and the frame rate of the video sequence.

Each frame for which a deep learning network is applied is referred to as a key frame, and the final set of bounding boxes for the key frame can be generated based on an aggregation of the blob bounding boxes and the detector bounding boxes. The aggregation may include, for example, pairing a detector bounding box (from the complex object detector system) with a blob bounding box (from the blob detection system) based on a degree of overlap between the two bounding boxes, and including the detector bounding box of the pair in the final set of bounding boxes while excluding the blob bounding box of the pair from the final set of bounding boxes. The aggregation may also include, for example, excluding a detector bounding box from the final set of bounding boxes if a confidence level of the detector bounding box is below a confidence threshold. The confidence level can be generated based on, for example, the probability vectors output by SSD, the confidence score output by YOLO, or based on a confidence level generated using another type of complex object detector. The confidence level can indicate a likelihood that the detector bounding box encloses, or otherwise corresponds to, the particular object. If the likelihood exceeds the certain threshold, it can be determined that the detector bounding box provides an accurate tracking of the object regardless of whether the detector bounding box matches with the blob bounding box. In some cases, for other frames (non-key frames), blob detection is applied without also applying the deep learning network, and the final set of bounding regions for the non-key frames can be generated based on the blob bounding regions.

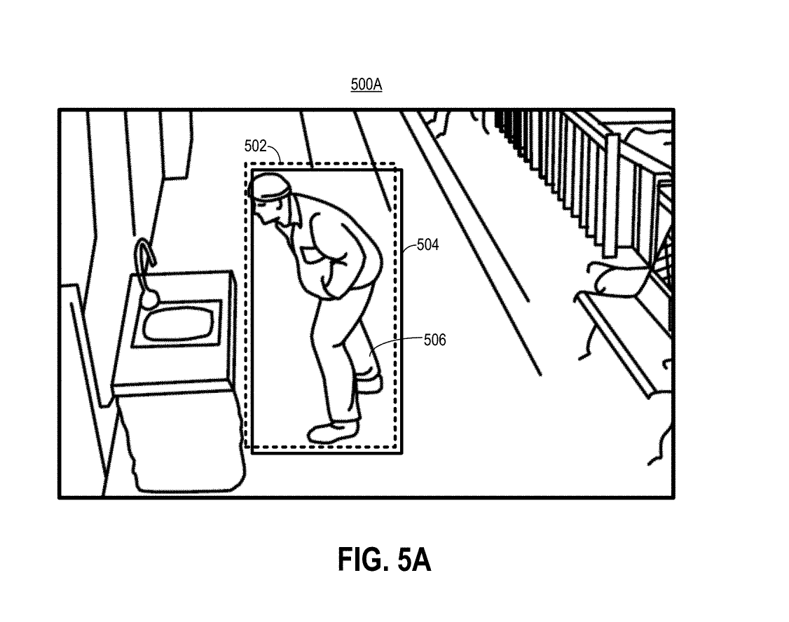

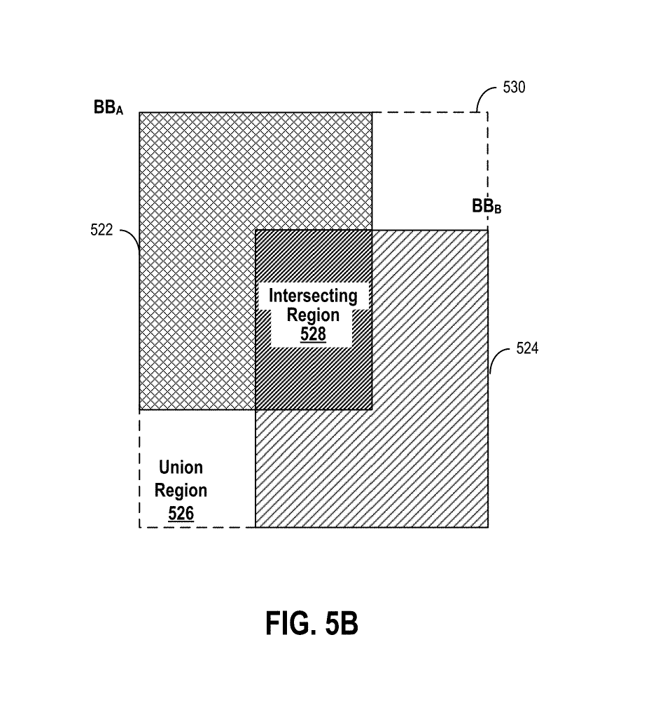

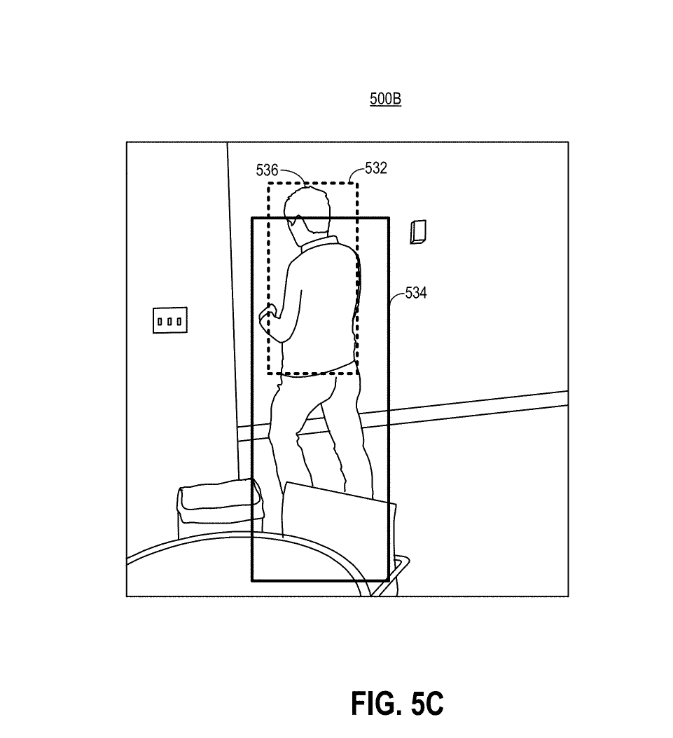

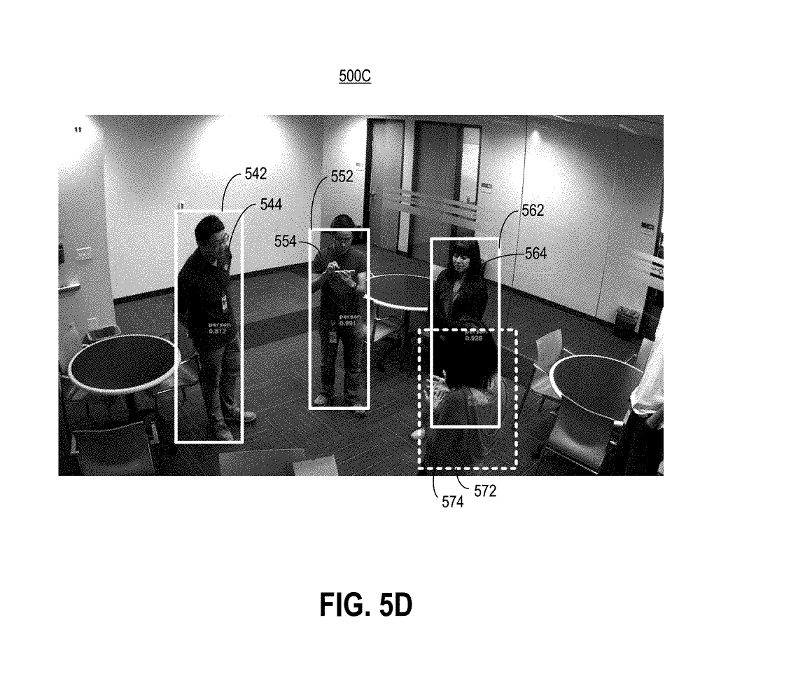

Although the complex object detector system provides an additional source of information for improving the accuracy of tracking an object in a video frame, the complex object detector system may introduce uncertainties, or even errors, to the tracking. For example, the complex object detector system may generate duplicated bounding boxes for a single object from the same video frame. FIG. 5A illustrates examples of duplicated bounding boxes. As shown in FIG. 5A, a complex object detector may generate, from a video frame 500A, detector bounding boxes 502 and 504 for an object 506 (a person).

The duplicated detector bounding boxes 502 and 504 can introduce uncertainties or even errors to the tracking of object 506. For example, referring to FIG. 5A, the video analytics system may not know whether detector bounding boxes 502 and 504 are associated with a single object, or multiple objects (but of the same class). Errors can be introduced if the video analytics system determines that detector bounding boxes 502 and 504 are associated with two different objects, when in fact both boxes are associated with the object 506. Conversely, in some other cases, if detector bounding boxes 502 are 504 are actually associated with two different objects, and the video analytics system erroneously determines that the bounding boxes 502 and 504 are duplicated bounding boxes and removes one of them, the video analytics system may lose track of one of the two different objects. Moreover, assuming that the video analytics system selects one of detector bounding boxes 502 or 504 to perform the tracking of the object 506, errors can be introduced to the tracking if the selected detector bounding box provides a less accurate representation of the location of object 506.

In some cases, duplicated bounding boxes can be removed based on non-maximum suppression (NMS). With NMS, the video analytics system can compute an intersection-over-union (IoU) ratio for a pair of bounding boxes. If the IoU ratio is higher than a threshold, the video analytics system may determine that the two bounding boxes are likely to be associated with a single detected object. FIG. 5B is a diagram showing an example of an intersection I and union U of two bounding boxes, including bounding box BB_{A} 522 and bounding box BB_{B} 524. Both bounding box BB_{A} 522 and bounding box BB_{B} 524 can be detector bounding boxes generated on the same video frame. Intersecting region 528 includes the overlapped region between bounding box BB_{A} 522 and bounding box BB_{B} 524.

Union region 526 includes the union of bounding box BB_{A} 522 and bounding box BB_{B} 524. The union of bounding box BB_{A} 522 and bounding box BB_{B} 524 can be defined to use the far corners of the two bounding boxes to create a new bounding box 530 (shown as dotted line). More specifically, by representing each bounding box with (x, y, w, h), where (x, y) is the upper-left coordinate of a bounding box, w and h are the width and height of the bounding box, respectively, the union of two bounding boxes (denoted in the equation as BB₁ and BB₂) would be represented as follows:

Union(BB₁, BB₂)=(min(xᵢ, x₂), min(y₁, y₂), (max(x₁+w₁−1,x₂+w₂−1)−min(x₁, x₂)), (max(y₁+h₁−1, y₂+h₂−1)−min(y₁, y₂)))

The IoU ratio between bounding box BB_{A} 522 and bounding box BB_{B} 524, IoU_{BBA,BBB}, can be determined based on a ratio between an area of intersecting region 528 and an area of union region 526, as follows:

$${IoU}_{BBA , BBB} = \frac{Area of Intersecting region 528}{Area of Union region 526}$$

Using FIG. 5B as an example, bounding box BB_{A} 522 and bounding box BB_{B} 524 can be determined to be associated with a single object if IoU_{BBA,BBB} is greater than an IoU threshold. The IoU threshold can be set to any suitable amount, such as 50%, 60%, 70%, or other configurable amount. In one illustrative example, bounding box BB_{A} 522 and bounding box BB_{B} 524 can be determined to be associated with the same object if the IoU ratio is higher than a threshold of 80%. With such a threshold, the video analytics system may also be able to determine that detector bounding boxes 502 and 504 of FIG. 5A are associated with the same object (object 506), based on the relatively large overlap area between the two detector bounding boxes relative to the union of the two bounding boxes 502 and 504.

NMS alone may not be effective in detecting duplicated bounding boxes in some scenarios. For example, referring to FIG. 5C, an object detector may generate, from a video frame 500B, detector bounding boxes 532 and 534 for an object 536 (e.g., a person). In the example of FIG. 5C, detector bounding box 532 is almost entirely contained in detector bounding box 534. The intersecting region between detector bounding boxes 532 and 534 is also relatively small compared with the union region between the two detector bounding boxes 532 and 534. In this case, the IoU ratio between detector bounding boxes 532 and 534 may be lower than the IoU threshold, and the video analytics system may be unable to determine that detector bounding boxes 532 and 534 are duplicated bounding boxes for a single object.

A video analytics system, relying on NMS alone, may also erroneously determine that a pair of bounding boxes are duplicated bounding boxes when, in fact, the bounding boxes are associated with different objects. For example, referring to FIG. 5D, an object detector may generate, from a video frame 500C, a detector bounding box 542 for an object 544, a detector bounding box 552 for an object 554, a detector bounding box 562 for an object 564, and a detector bounding box 572 for an object 574. In the example of FIG. 5D, the intersecting region between detector bounding boxes 562 and 572 may be relatively large compared with the union region between the two detector bounding boxes. The IoU ratio between detector bounding boxes 562 and 572 may thus be higher than the IoU threshold. Based on the IoU ratio, the video analytics system may erroneously determine that detector bounding boxes 562 and 572 are duplicated bounding boxes associated with the same object, and may remove one of the bounding boxes. As a result, the video analytics system may be unable to track one of objects 564 or 574, which causes errors in the tracking of the objects in the video frame.

Duplicated bounding box suppression systems and methods are described herein that can be employed to determine whether a set of detector bounding boxes includes potential duplicated bounding boxes. For example, the duplicated bounding box suppression system can identify, based on a set of metrics associated with the set of detector bounding boxes, candidate groups of bounding boxes to be removed (or suppressed) from the detector bounding boxes before they are provided for tracking. The set of metrics may include, for example, an area of an intersection region among the set of detector bounding boxes, the areas of the detector bounding boxes, the locations of the detector bounding boxes, among others. In addition, the duplicated bounding box suppression system can also identify the set of candidate bounding boxes based on the confidence levels associated with the set of detector bounding boxes.

After identifying the set of candidate bounding boxes, the duplicated bounding box suppression system can determine whether any candidate bounding boxes from the set of candidate bounding boxes are to be removed based on additional criteria. For example, the duplicated bounding box suppression system can select candidate bounding boxes associated with confidence levels below a pre-determined confidence threshold for removal from the detector bounding boxes that will be considered for tracking (e.g., for inclusion in the final set of bounding boxes used for tracking). On the other hand, candidate bounding boxes associated with confidence levels above the pre-determined confidence threshold may not be removed from the tracking. As another example, the duplicated bounding box suppression system can determine whether the candidate bounding boxes are associated with different objects. For example, based on a history of locations of the candidate bounding boxes, the duplicated bounding box suppression system can determine whether there is merging of objects in the video frame. Candidate bounding boxes that are determined to be associated with different objects may not be removed from the tracking.

With embodiments of the present disclosure, the accuracy of determination of the duplicated bounding boxes can be improved. Moreover, the likelihood of removing bounding boxes that are true positives, such as bounding boxes associated with different objects and/or bounding boxes associated with high confidence levels, can be reduced. Such enhancements can improve the accuracy of object tracking by video analytics systems.

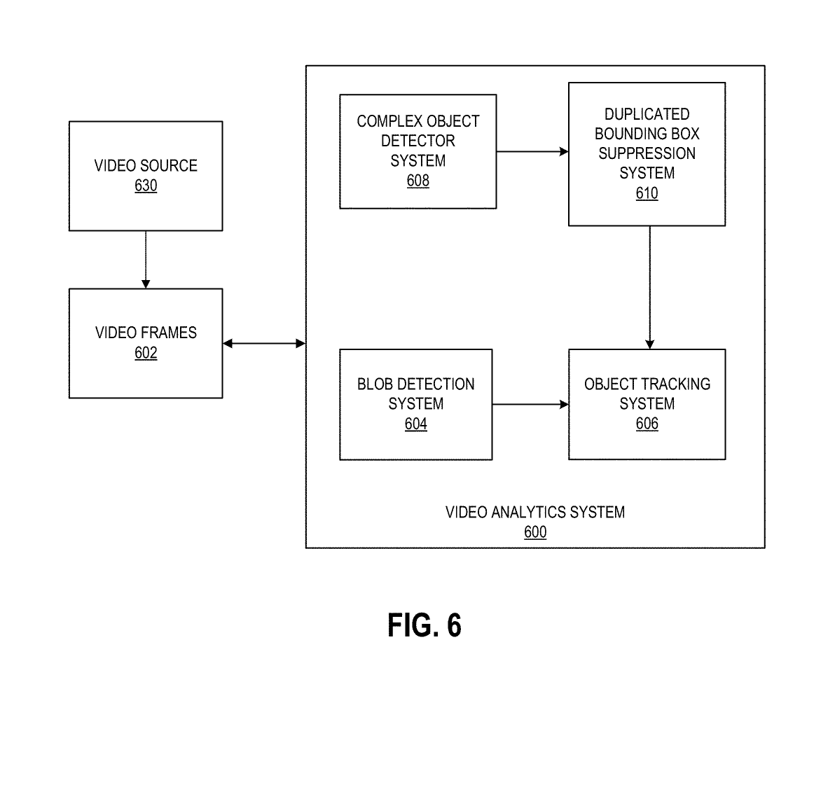

FIG. 6 is an example of a hybrid video analytics system 600 that can be used to perform object detection and tracking. The hybrid video analytics system 600 combines, for example, blob detection and complex object detection using a deep learning system to detect and track objects in images with high-accuracy and in real-time. As used herein, the term “real-time” refers to detecting and tracking objects in a video sequence as the video sequence is being captured. Video analytics system 600 includes a blob detection system 604, an object tracking system 606, a complex object detector system 608, and a duplicated bounding box suppression system 610. Blob detection system 604 is similar to and can perform the same operations as the blob detection system 104 described above with respect to FIG. 1-FIG. 4. For example, blob detection system 604 can receive video frames 602 of a video sequence provided by a video source 630. Blob detection system 604 can perform object detection to detect one or more blobs (representing one or more objects) for the video frames 602. Blob bounding boxes associated with the blobs are generated by the blob detection system 604. The blobs and/or the blob bounding boxes can be output for further processing by the video analytics system 600. While examples are described herein using bounding boxes as examples of bounding regions, one of ordinary skill will appreciate that any other suitable bounding region could be used instead of bounding boxes, such as bounding circles, bounding ellipses, or any other suitably-shaped regions representing trackers, blobs, and/or objects.

Complex object detector 608 can apply one or more deep learning networks to one or more of the frames 602 of the received video sequence to locate and classify objects in the one or more frames. An output of complex object detector 608 can include a set of detector bounding boxes representing the detected and classified objects. Examples of deep learning networks that can be applied by complex object detector 608 can include an SSD detector, a YOLO detector, or any other suitable classification system. Complex object detector 608 can generate detector bounding boxes for the detected and classified objects.

Duplicated bounding box suppression system 610 can receive a set of detector bounding boxes from complex object detector 608, and may remove or filter out one or more duplicated bounding boxes from the set of detector bounding boxes. The output from the duplicated bounding box suppression system 610 can include a filtered set of detector bounding boxes. Duplicated bounding box suppression system 610 can then provide the filtered set of detector bounding boxes to object tracking system 606. As discussed above, duplicated bounding box suppression system 610 can identify, based on a set of metrics associated with the set of detector bounding boxes, a set of candidate bounding boxes to be removed (or suppressed). The set of metrics may include, for example, an area of an intersection region among the set of detector bounding boxes, the areas of the detector bounding boxes, the locations of the detector bounding boxes, any combination thereof, and/or any other suitable metrics. In addition, the duplicated bounding box suppression system 610 can identify the set of candidate bounding boxes based on the confidence levels associated with the set of detector bounding boxes. After identifying the set of candidate bounding boxes, the duplicated bounding box suppression system 610 can select a bounding box to be removed from the set of detector bounding boxes based on, for example, the confidence level of the selected bounding box being below a pre-determined confidence threshold, the candidate bounding boxes being associated with the same object, any combination thereof, and/or based on other suitable criteria.

Once the detector bounding boxes are filtered by the duplicated bounding box suppression system 610, a final set of bounding boxes can be determined using the filtered detector bounding boxes and the blob bounding boxes produced by blob detection system 604. For example, the blob bounding boxes (generated by blob detection system 604) and the filtered detector bounding boxes (output by the duplicated bounding box suppression system 610) can be generated for a same video frame, and can be analyzed to determine a final set of bounding boxes for the video frame. A status can also be determined for each of the bounding boxes in the final set of bounding boxes. Each of the bounding boxes in the final set can represent a blob detected for the video frame.

The final set of bounding boxes determined for a video frame (representing blobs in the video frame) can be provided, for example, for blob processing, object tracking, and/or for other video analytics functions. For example, final bounding boxes can be provided to object tracking system 606, which can perform object tracking to track the detected blobs and the objects represented by the blobs. Object tracking system 606 is similar to and can perform the same operations as the object tracking system 106 described above with respect to FIG. 1-FIG. 4. As described above, the object tracking system 606 can associate trackers and their bounding boxes with the one or more the blobs (using the blob bounding boxes) detected by blob detection system 604. A tracker bounding box can then be displayed as tracking a tracked object/blob when certain conditions are met (e.g., the blob has been tracked for a certain number of frames, a certain period of time, and/or other suitable conditions).

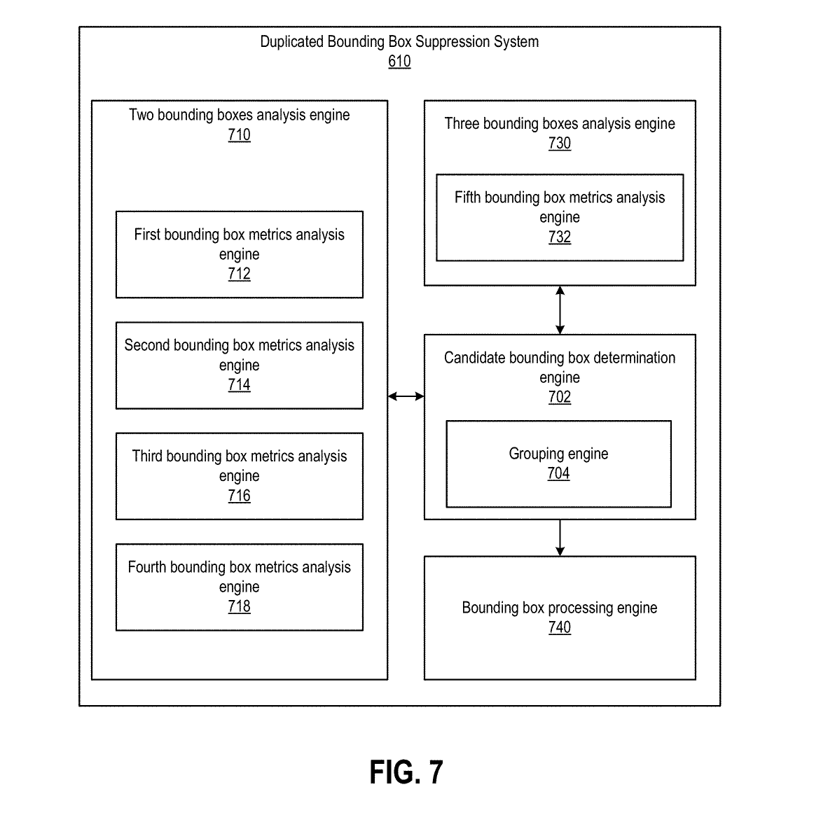

FIG. 7 is a diagram illustrating a more detailed example of a duplicated bounding box suppression system 610. As shown in FIG. 7, duplicated bounding box suppression system 610 includes a candidate bounding box determination engine 702, a two bounding boxes analysis engine 710, a three bounding boxes analysis engine 730, and a bounding box processing engine 740. Candidate bounding box determination engine 702 can obtain a set of detector bounding boxes from complex object detector system 608, and can process the set of detector bounding boxes using the two bounding boxes analysis engine 710 and/or the three bounding boxes analysis engine 730 to determine, from the set of detector bounding boxes, a set of groups of detector bounding boxes. Each group of detector bounding boxes within the set of groups can include a candidate bounding box for removal. For example, a group of detector bounding boxes can include two, three, or more detector bounding boxes, with one of the detector bounding boxes in the group being detected as a candidate bounding box for removal. Candidate bounding box determination engine 702 can then forward the set of groups to bounding box processing engine 740, which can remove one or more candidate bounding boxes from the set of detector bounding boxes based on additional criteria, such as the confidence levels of the candidate bounding boxes, whether the set of groups include detector bounding boxes from different objects, or other suitable criteria to minimize the likelihood of removing true-positive bounding boxes.

Candidate bounding box determination engine 702 can obtain a set of metrics associated with a set of detector bounding boxes from, for example, complex object detector system 608. For each detector bounding box, candidate bounding box determination engine 702 may receive a set of metrics including, for example, the upper-left coordinates (e.g., the top-left x-coordinate and the top-left y-coordinate) of the detector bounding box in a video frame (e.g., one of video frames 602), a width and a height of the detector bounding box, and other information related to a geometry and a location of the detector bounding box. The candidate bounding box determination engine 702 may also obtain confidence levels of the detector bounding boxes (e.g., from complex object detector system 608).

Candidate bounding box determination engine 702 further includes a grouping engine 704 configured to identify groups of detector bounding boxes from the set of detector bounding boxes. The groups can include groups of two detector bounding boxes and/or groups of three detector bounding boxes. In some cases, the groups of detector bounding boxes can include more than two or three detector bounding boxes. The groups can be identified based on various criteria. For example, grouping engine 704 can calculate a center coordinate for each detector bounding box of the set of detector bounding boxes (e.g., based on the upper-left coordinates, width and height information, etc.), and can determine a location for each detector bounding box in the video frame. Based on the location information, the detector bounding boxes can be grouped based on a degree of proximity between two boxes (for groups of two boxes) and/or among three boxes (for groups of three boxes). For example, referring back to FIG. 5A, grouping engine 704 may include detector bounding boxes 502 and 504 in a group of two detector bounding boxes due to the proximity between the two bounding boxes 502 and 504. Also, referring back to FIG. 5D, grouping engine 704 may include detector bounding boxes 552, 562, and 572 in a group of three bounding boxes, and include detector bounding boxes 562 and 572 in a group of two bounding boxes, based on the locations of these bounding boxes. Grouping engine 704 may also group the detector bounding boxes based on other criteria, such as based on full permutations, to identify all possible groups of two and three boxes from the set of detector bounding boxes.

After identifying the groups, candidate bounding box determination engine 702 can provide metrics data associated with each identified group of two detector bounding boxes to two bounding boxes analysis engine 710. The two bounding boxes analysis engine 710 can determine whether the groups of two detector bounding boxes include candidate bounding boxes to be possibly removed from the set of detector bounding boxes. Candidate bounding box determination engine 702 can also send metrics data associated with each identified group of three detector bounding boxes to three bounding boxes analysis engine 730. The three bounding boxes analysis engine 730 can determine whether the groups of three detector bounding boxes include candidate bounding boxes for possible removal from the set of detector bounding boxes.

Two bounding boxes analysis engine 710 includes a first bounding box metrics analysis engine 712, a second bounding box metrics analysis engine 714, a third bounding box metrics analysis engine 716, and a fourth bounding box metrics analysis engine 718. Each of analysis engines 712, 714, 716, and 718 can perform analysis on the metrics of a group of two bounding boxes according to different sets of rules, to determine whether the group contains candidate bounding boxes for possible removal.

First bounding box metrics analysis engine 712 may determine whether the group of two detector bounding boxes contains a candidate bounding box based on an IoU ratio. As discussed above with respect to FIG. 5B, an IoU ratio can be determined based on a ratio between an area of an intersecting region between two bounding boxes and an area of a union region formed by the two bounding boxes. If the IoU ratio exceeds a first threshold, first bounding box metrics analysis engine 712 may determine that it is likely that one of the bounding boxes in the group is a duplicated bounding box, and that the group includes a candidate bounding box to be removed. The first threshold can also be referred to herein as an IoU threshold (denoted as IoURatioTh). Referring back to the example of FIG. 5A, first bounding box metrics analysis engine 712 may determine that the group of detector bounding boxes 502 and 504 includes a candidate bounding box for removal based on the IoU ratio. In some embodiments, the first threshold can be set to any suitable value, such as at 0.25, 0.3, 0.35, 0.4, or any other suitable value.

Second bounding box metrics analysis engine 714 may determine whether the group of two detector bounding boxes contains a candidate bounding box to be removed based on a degree of enclosure of one bounding box by another bounding box. Second bounding box metrics analysis engine 714 can determine an area of the smaller bounding box of the two detector bounding boxes (or the area of any one of the two bounding boxes if they have identical size). Second bounding box metrics analysis engine 714 can also determine an area of an intersection region between the two bounding boxes. To determine the degree of enclosure, second bounding box metrics analysis engine 714 can determine a full enclosure indicator based on a ratio between the area of the intersection region and the area of the smaller bounding box (or any one of the bounding boxes if they have the same size). For example, the full enclosure indicator between a bounding box A and a bounding box B (with bounding box B being the smaller bounding box) can be denoted as

$$Enc = \frac{Area of Intersecting {region}_{BBA , BBB}}{Area of BBB} .$$

A higher degree of enclosure can lead to a higher value for the full enclosure indicator. For example, when the smaller bounding box (e.g., bounding box B) is fully enclosed by the other bounding box (e.g., bounding box A) in the group, the area of the smaller bounding box and the area of intersection becomes equal, and the full enclosure indicator can max out at a value of 1. If the full enclosure indicator exceeds a second threshold, second bounding box metrics analysis engine 714 may determine that a substantial portion of a bounding box is enclosed by another bounding box, which indicates high likelihood that one of the bounding box is a duplicated bounding box. In some embodiments, the second threshold can be set to any suitable value, such as at 0.60, 0.65, 0.70, 0.79, 0.80, or any other suitable value. The second threshold can also be referred to herein as an enclosure threshold (denoted as bboxfullyIncludedRatioTh).

In some examples, based on the full enclosure indicator, second bounding box metrics analysis engine 714 can detect potential duplicated bounding boxes within a group, which may have been missed by first bounding box metrics analysis engine 712 (based on the IoU analysis). For example, referring to FIG. 5C, second bounding box metrics analysis engine 714 may indicate that one of detector bounding boxes 532 and 534 may be a duplicated bounding box, due to detector bounding box 532 being almost fully enclosed by detector bounding box 534. Because detector bounding box 532 is largely enclosed by the detector bounding box 534, the second bounding box metrics analysis engine 714 can determine a high inclusion ratio. On the other hand, the IoU ratio for detector bounding boxes 532 and 534 may be relatively low if the intersection region between the two bounding boxes 532 and 534 is small compared with the union region. Such a small IoU ratio can occur in the example of FIG. 5C if, for example, detector bounding box 532 is much smaller than detector bounding box 534.

Third bounding box metrics analysis engine 716 may determine the group of two detector bounding boxes contains a candidate bounding box to be removed based on a relative position between the two bounding boxes, as well as the aforementioned full enclosure indicator. The relative position determination can reflect that duplicate bounding boxes may be generated for different parts of the same object. For example, from a video frame depicting a person in a standing or walking posture (such as video frame 500B of FIG. 5C), the object detector may generate two bounding boxes, a first bounding box for the upper region of the body (e.g., detector bounding box 532) and a second bounding box including the lower region of the body (e.g., detector bounding box 534). In this case, the first bounding box may intersect with a top portion of the second bounding box in the video frame. In another example, from a video frame depicting a dog in a walking posture, the object detector may also generate two bounding boxes, a first bounding box covering the head, and a second bounding box covering the body including the tail. In this case, the first bounding box may intersect with a side portion of the second bounding box in the video frame.

By matching the relative positions of the two bounding boxes with a pre-determined pattern (e.g., whether the two bounding boxes overlap along a vertical axis or a horizontal axis), as well as the aforementioned full inclusion indicator (based on a ratio between the area of the intersection region and the area of the smaller bounding box), third bounding box metrics analysis engine 716 may determine whether one of the two bounding boxes within the group may be a duplicated bounding box. For example, if the full inclusion indicator exceeds a third threshold (which can be lower than the second threshold used by second bounding box metrics analysis engine 714 for full enclosure determination), and that the smaller bounding box overlaps with the top portion of the other bounding box along a vertical direction, third bounding box metrics analysis engine 716 may determine that there is a high likelihood that one of the bounding box is a duplicated bounding box, and that the group contains a candidate bounding box for removal. In some embodiments, the third threshold can be set to any suitable value that is lower than the second threshold, such as 0.55, 0.60, 0.70, 0.78, 0.79, or any other suitable value. The third threshold can also be referred to herein as a partial enclosure threshold (denoted as bboxpartiallyIncludedRatioTh).

Based on the relative location information, the third bounding box metrics analysis engine 716 can detect potential duplicated boxes which may have been missed by first bounding box metrics analysis engine 712 and second bounding box metrics analysis engine 714. For example, referring back to FIG. 5C, second bounding box metrics analysis engine 714 may determine that detector bounding boxes 532 and 534 does not include a duplicated bounding box because the full enclosure indicator is below the second threshold. However, based on a determination that detector bounding box 532 overlaps a top portion of detector bounding box 534, and that the full enclosure indicator is above the third threshold, third bounding box metrics analysis engine 716 may determine that detector bounding boxes 532 and 534 includes a candidate duplicated bounding box.

The fourth bounding box metrics analysis engine 718 may determine whether the group of two detector bounding boxes contains a candidate bounding box to be removed based on a confidence level associated with each of the two detector bounding boxes, as well as the aforementioned full enclosure indicator. As discussed above, the confidence level can be based on a confidence score output by a YOLO detector, a probability vector output by an SSD, or any suitable indicator (generated by any suitable object detector) of a likelihood that a detector bounding box encloses, or otherwise corresponds to, a particular object. If the fourth bounding box metrics analysis engine 718 determines that the confidence level of any one of the two detector bounding boxes is below a first confidence threshold (denoted as minConfTh), and that the full enclosure indicator is above a fourth threshold (which can be below the third threshold used by third bounding box metrics analysis engine 716 and the second threshold used by second bounding box metrics analysis engine 714), fourth bounding box metrics analysis engine 718 may determine that the group contains a candidate bounding box that will be considered for removal. In some embodiments, the first confidence threshold can be set to any suitable value, such as 0.25, 0.3, 0.35, 0.40, or any other suitable value. The fourth threshold can be set to any suitable value that is lower than the second threshold, such 0.45, 0.50, 0.60, 0.65, 0.7, 0.75, or any other suitable value. The fourth threshold can also be referred to herein as an overlapping enclosure threshold (denoted as bboxOverlapWidthConfGapTh).

By taking the confidence level of a bounding box into account, fourth bounding box metrics analysis engine 718 can signal removal of bounding boxes that are associated with low confidence levels. These bounding boxes are unlikely to provide a good representation of the tracked object, and including those bounding boxes may introduce errors in the tracking of the object. The inclusion of the confidence level in the duplicated bounding box determination can also allow the fourth bounding box metrics analysis engine 718 to detect potential duplicated bounding boxes that may have been missed by first bounding box metrics analysis engine 712, second bounding box metrics analysis engine 714, and third bounding box metrics analysis engine 716.

There are different ways by which the two bounding boxes analysis engine 710 employs the first bounding box metrics analysis engine 712, the second bounding box metrics analysis engine 714, the third bounding box metrics analysis engine 716, and the fourth bounding box metrics analysis engine 718 to determine groups of detector bounding boxes with candidate bounding boxes for removal. In some examples, two bounding boxes analysis engine 710 may perform the analysis in a serial fashion. For example, the first bounding box metrics analysis engine 712 may be controlled to perform analysis on a group of two detector bounding boxes first, followed by the second bounding box metrics analysis engine 712 (if first bounding box metrics analysis engine 712 finds no candidate bounding box), then the third bounding box metrics analysis engine 716 (if second bounding box metrics analysis engine 714 finds no candidate bounding box), and then followed by the fourth bounding box metrics analysis engine 718 (if third bounding box metrics analysis engine 716 finds no candidate bounding box). In some cases, the analysis on a group of two detector bounding boxes may stop at one of analysis engines 712, 714, 716, and 718 whenever one of the engine determines that the group includes a candidate bounding box, in which case the next analysis engine will not process the group. In other examples, two bounding boxes analysis engine 710 may perform the analysis in a parallel fashion, where two or more of the analysis engines 712, 714, 716, and 718 can perform the analysis on the same group of two detector bounding boxes in parallel. The two bounding boxes analysis engine 710 may determine that the group includes a candidate bounding box if one or more of analysis engines 712, 714, 716, and 718 indicates that a candidate bounding box exists.

The three bounding boxes analysis engine 730 may include a fifth bounding box metrics analysis engine 732 to determine whether a group of three detector bounding boxes contains a candidate bounding box to be removed. The fifth bounding box metrics analysis engine 732 can make the determination based on the relative positions of the three detector bounding boxes and their confidence levels. For example, if a first bounding box intersects, simultaneously and substantially, with a second bounding box and a third bounding box, the first bounding box is associated with a relatively low confidence level below a low confidence threshold (denoted as lowConfBoxTh), and the second and third bounding boxes are associated with relatively high confidence levels above a high confidence threshold (denoted as highConfBoxTh), the fifth bounding box metrics analysis engine 372 may determine that the first bounding box is likely tracking the same object (albeit at a low confidence level) tracked by the second bounding box or by the third bounding box. In such cases, the fifth bounding box metrics analysis engine 372 may determine that the first bounding box is a candidate bounding box for removal.

As noted above, the fifth bounding box metrics analysis engine 732 can determine whether a group of three detector bounding boxes includes a candidate bounding box based on the location and confidence level information. For example, based on the locations of three bounding boxes in a group of bounding boxes, the fifth bounding box metrics analysis engine 732 can determine whether one of the bounding boxes (e.g., a first bounding box) intersects with the other two bounding boxes (a second bounding box and a third bounding box) simultaneously. The fifth bounding box metrics analysis engine 732 can then determine a first intersection region between the first bounding box and the second bounding box, and can determine a second intersection region between the first bounding box and the third bounding box. The fifth bounding box metrics analysis engine 732 can further determine a combined region between the first intersection region and the second intersection region, and an area of the combined region. The area can be determined as a sum of the areas of the first intersection region and the second intersection region if the first and second intersection regions do not intersect with each other. In a case where the first and second intersection regions intersect each other to form a third intersection region, the aggregate area will be determined as the sum of the areas of the first intersection region and the second intersection region subtracted by the area of the third intersection region.

Continuing with the above example, the fifth bounding box metrics analysis engine 732 can then determine a ratio between the area of the first bounding box and the aggregate area, and whether the ratio exceeds a fifth threshold. If the ratio exceeds the fifth threshold, which can indicate substantial overlap between the first bounding box and each of the second and third bounding boxes, the fifth bounding box metrics analysis engine 732 can further determine whether the confidence level of the first bounding box is below the low confidence threshold, and whether the confidence levels of the second and third bounding boxes are above the high confidence threshold. If the total area of the intersection regions (or the area of the combined region of the intersection regions) exceeds the fifth threshold, the confidence level of the first bounding box is below the low confidence threshold, and the confidence levels of the second and third bounding boxes are above the high confidence threshold, the fifth bounding box metrics analysis engine 732 may determine that the first bounding box is a candidate bounding box for removal. In some embodiments, the fifth threshold can be set to any suitable value, such as 0.70, 0.75, 0.80, 0.85, 0.90, or other suitable value. The low confidence threshold can be set to any suitable value, such as 0.30, 035, 0.40, 0.45, or other suitable value, and the high confidence threshold can be set to 0.50, 0.60, 0.70, 0.75, 0.80, or other suitable value. In one illustrative example, the low confidence threshold can be set to 0.40, and the high confidence threshold can be set to 0.70.

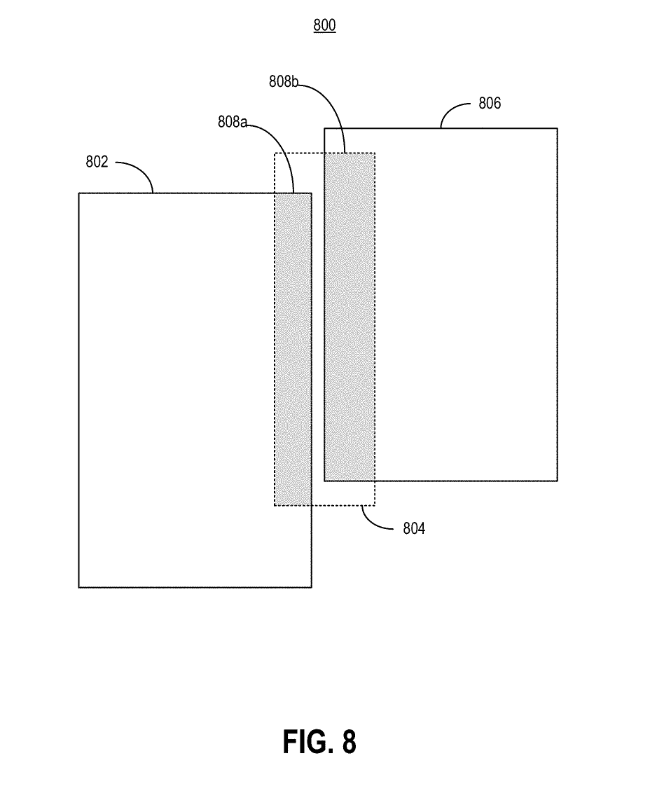

FIG. 8 provides an illustration of an operation by the fifth bounding box metrics analysis engine 732. In the example of FIG. 8, an object detector may generate, from a video frame 800, a detector bounding box 802 (represented by a solid line box), a detector bounding box 804 (represented by dotted line box), and a detector bounding box 806 (represented by a solid line box). Detector bounding box 804 may be associated with a very low confidence level (e.g., below a confidence level of 0.40), whereas detector bounding boxes 802 and 806 may be associated with a relatively high confidence level (e.g., above a confidence level of 0.70). The detector bounding box 802 intersects with the detector bounding box 804 to a form a first intersection region 808a, and the detector bounding box 804 intersects with the detector bounding box 806 to form a second intersection region 808b. The fifth bounding box metrics analysis engine 732 can determine a ratio between the area of the detector bounding box 804 and the total area of the first and second intersection regions 808a and 808b, or an area of a combined region of the first and second intersection regions 808a and 808b if the two intersection regions overlap. Based on a determination that ratio exceeds the fifth threshold, that the confidence level of detector bounding boxes 802 and 806 exceeds the high confidence threshold, and that the confidence level of detector bounding box 804 exceeds the low confidence threshold, the fifth bounding box metrics analysis engine 732 may determine that the detector bounding box 804 is a candidate bounding box for removal.

Referring back to FIG. 7, there are different ways by which the candidate bounding box determination engine 702 interacts with the two bounding boxes analysis engine 710 and the three bounding boxes analysis engine 730. For example, candidate bounding box determination engine 702 can first provide groups of two detector bounding boxes (provided by grouping engine 704) to the two bounding boxes analysis engine 710. If the two bounding boxes analysis engine 710 returns a subset of the groups containing candidate bounding boxes for removal, the candidate bounding box determination engine 702 can stop the analysis and forward the subset of groups to bounding box processing engine 740. If the two bounding boxes analysis engine 710 fails to find a group of two detector bounding boxes containing a candidate bounding box for removal, the candidate bounding box determination engine 702 can provide groups of three detector bounding boxes (provided by the grouping engine 704) to the three bounding boxes analysis engine 730, and provide subset of groups of three detector bounding boxes containing candidate bounding boxes (if any) to the bounding box processing engine 740. As another example, the candidate bounding box determination engine 702 can also provide groups of two detector bounding boxes to the two bounding boxes analysis engine 710, and groups of three detector bounding boxes to the three bounding boxes analysis engine 730, in parallel. The candidate bounding box determination engine 702 can then provide the subsets of groups of two or three detector bounding boxes to the bounding box processing engine 740.

The bounding box processing engine 740 can process a set of groups of two or three detector bounding boxes with a candidate bounding box received from the candidate bounding box determination engine 702. For each group of the set of groups, the bounding box processing engine 740 can determine a candidate bounding box for removal based on, for example, identifying the bounding box associated with the minimum confidence level within the group. The bounding box processing engine 740 can further determine whether to select the identified candidate bounding box for removal based on additional criteria, to avoid removing bounding boxes that are useful for tracking an object. For example, bounding box processing engine 740 may determine whether the confidence level of the identified candidate bounding box is above a global confidence threshold (denoted globalConfTh). The bounding box processing engine 740 may remove a candidate bounding box if the confidence level of the candidate bounding box is below the global confidence threshold. In some embodiments, the global confidence threshold can be set at 0.85.

The bounding box processing engine 740 may also determine whether a group of the detector bounding boxes includes bounding boxes associated with different objects, to avoid removing bounding boxes that overlap with each other due to merging (e.g., following the movement of the tracked objects). For example, referring back to FIG. 5D, bounding boxes 562 and 572 are associated with different objects. However, due to a substantial amount of overlap between the bounding boxes 562 and 572, two bounding boxes analysis engine 710 (or three bounding boxes analysis engine 730) may signal that a group of bounding boxes 562 and 572 includes a candidate bounding box for removal. The bounding box processing engine 740 may perform additional processing to, for example, overrule two bounding boxes analysis engine 710, to avoid removing one of bounding boxes 562 and 572.

There are different ways by which the bounding box processing engine 740 can determine whether two bounding boxes are associated with the same object or with different objects. For example, the bounding box processing engine 740 may track the trajectories of the two bounding boxes over a number of video frames. As an illustrative example, the bounding box processing engine 740 may detect that at an earlier video frame, the two bounding boxes are separated by a large distance, and then at the current frame the two bounding boxes are close to each other. Based on such information, the bounding box processing engine 740 may determine that the two bounding boxes are associated with different objects and are merged together due to the movement of the objects. Based on this determination, the box processing engine 740 may determine to keep the two bounding boxes and not to remove one of them as a duplicated bounding box.

A detailed illustrative implementation of determining a bounding box for removal by the third bounding box metrics analysis engine 716 and the bounding box processing engine 740 is provided below. For example, the following implementation illustrates the condition test to verify that a small box is at the upper part of a large box and that one of the bounding box should be removed:

Input: IpcCnnBoundingBox &bbox1, IpcCnnBoundingBox &bbox2

Output: return true to remove the bounding box (bbox1/bbox2) with lower confidence level, otherwise not to remove the bounding box with lower confidence level.

The inputs to the above implementation include: the height, width, and location information of a first bounding box of a first bounding box (bbox1) and of a second bounding box (bbox2). The Global confidence threshold (globalConfTh) is set at 0.8. The partial enclosure threshold (bboxPartiallyIncludedRatioTh) is set at 0.78. The implementation shown above will not be described.

First, determine the intersection area between the first and second bounding boxes:

ipcBoundingBox intersectBBox;

Intersect(bbox3.ipcCnnBBox, bbox2.ipcCnnBBox, intersectBBox);

int intersectBBoxSize=bbSize(intersectBBox);

Next, determine which of the first and the second bounding boxes is the smaller bounding box. If the two bounding boxes are of the same size, set the second bounding box as the smaller bounding box. Also determine the size of the smaller bounding box.

ipcBoundingBox smallBox, largeBox;
if (bbSize(bbox1.ipcCnnBBox) < bbSize(bbox2.ipcCnnBBox))
{

copyCC(bbox1.ipcCnnBBox, smallBox);
copyCC(bbox2.ipcCnnBBox, largeBox);

}
else
{

copyCC(bbox2.ipcCnnBBox, smallBox);
copyCC(bbox1.ipcCnnBBox, largeBox);

}
int smallBoxSize = bbSize(smallBox);

Next, determine the full inclusion indicator (smallBBoxIncludeRatio) based on a ratio between the area of the intersection area and the smaller bounding box area:

Float smallBBoxIncludedRatio=(float)intersectBBoxSize/smallBoxSize;

Next, determine the relative positions of the smaller bounding box and of the larger bounding box based on the top left corner coordinates of the bounding boxes and their height.

int smallBoxBottomY=smallBox.rectTopLeftY+smallBox.rectHeight;

int largeBoxBottomY=largeBox.rectTopLeftY+largeBox.rectHeight;

int intersectBoxBottomY=intersectBBox.rectTopLeftY+intersectBBox.rectHeight;

Next, if the smaller bounding box overlaps with a top part of the larger bounding box, and the full inclusion indicator (smallBBoxIncludeRatio) exceeds the partial enclosure threshold (bboxPartiallyIncludedRatioTh), the first and second bounding boxes may be determined to include a candidate bounding box for removal, and the candidate bounding box will be the one with the lower confidence level among the two bounding boxes. Further, if the confidence level of the candidate bounding box is below the global confidence threshold (globalConfTh), the candidate bounding box can be removed (indicated by “return true”):

if (smallBBoxIncludedRatio > bboxPartiallyIncludedRatioTh &&
(smallBoxBottomY < largeBoxBottomY && smallBoxBottomY >
largeBox.rectTopLeftY) && (intersectBBox.rectTopLeftY −
largeBox.rectTopLeftY < largeBoxBottomY − smallBoxBottomY)) {

if (MIN(bbox1.ipcCnnConf, bboxX.ipcCnnConf) < globalConfTh)
return true;

}

A detailed illustrative implementation of determining a bounding box for removal by the three bounding boxes analysis engine 730 is provided below. For example, the following implementation illustrates the condition test to verify a low confidence box is covered by two high confidence box:

Input: rsvBBoxes[i].ipcCnnBBox, rsvBBoxes[j].ipcCnnBBox, rsvBBoxes[k].ipcCnnBBox

Output: return true to remove rsvBBoxes[i].ipcCnnBBox, otherwise not to remove rsvBBoxes[i].ipcCnnBBox

The inputs to the above implementation include: the height, width, and location information of a first bounding box of a first bounding box (rsvBBoxes[i]), a second bounding box (rsvBBoxes[j]), and a third bounding box (rsvBBoxes[k]). The low confidence threshold (lowConfBoxTh) is set at 0.4. The high confidence threshold (highConfBoxTh) is set at 0.7. The fifth threshold (lowBBoxCoverageByHighBoxT) is set at 0.85. The implementation shown above will not be described.

First, determine the first intersection region between the first bounding box and the second bounding box, and the second intersection region between the first bounding box and the third bounding box.

Intersect(rsvBBoxes[i].ipcCnnBBox, rsvBBoxes[j].ipcCnnBBox, intersectBBoxA);

Intersect(rsvBBoxes[i].ipcCnnBBox, rsvBBoxes[k].ipcCnnBBox, intersectBBoxB);

Next, determine a combined area of the first and the second intersection regions based on a sum of areas of the first and second intersection regions. If the there is a third intersection region (intersectBBoxC) between the first and the second intersection regions, subtract the area of the third intersection region from the sum.

Intersect(intersectBBoxA, intersectBBoxB, intersectBBoxC);

CombinedSize=bbSize(intersectBBoxA)+bbSize(intersectBBoxB)−bbSize(intersectBBoxC);

Next, determine a ratio between the combined area and the area of the first bounding box. If the ratio exceeds the fifth threshold, that the first bounding box overlaps with each of the second and third bounding boxes simultaneously, that the confidence level of the first bounding box is below the low confidence threshold (lowConfBoxTh), and that the confidence levels of the second and third bounding boxes are above the high confidence threshold (highConfBoxTh), the first bounding box is determined to be a candidate bounding box for removal (“return true”):

bboxSize = bbSize(rsvBBoxes[i].ipcCnnBBox);
bbCoverage = (float)CombinedSize / bboxSize;
if (bbCoverage > lowBBoxCoverageByHighBoxTh &&
bbSize(intersectBBoxA) > 0 && bbSize(intersectBBoxB) > 0 &&
rsvBBoxes[i].ipcCnnConf < lowConfBoxTh &&
MIN(rsvBBoxes[j].ipcCnnConf, rsvBBoxes[k].ipcCnnConf) >
highConfBoxTh)
{

return true;

}

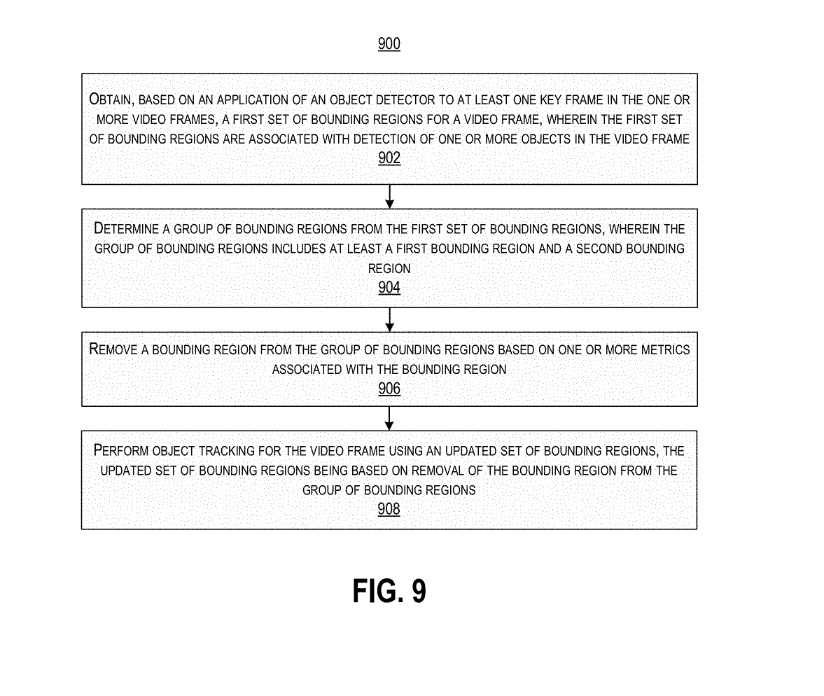

FIG. 9 is a flow chart illustrating an example of an object tracking process 900 for one or more video frames using the techniques disclosed herein. At block 902, process 900 includes obtaining, based on an application of an object detector to at least one key frame in the one or more video frames, a first set of bounding regions for a video frame. The first set of one or more bounding regions are associated with detection of one or more objects in the video frame. A key frame can be a frame from the one or more video frames to which the object detector is applied. The object detector may include a feature-based detector. The object detector may also be a complex object detector. In some cases, the object detector can be based on a trained classification network. For example, the complex detector can include, for example, a SSD detector, a YOLO detector, or other suitable complex detector, and can be part of complex object detector system 608 of FIG. 6. The first set of bounding regions may include detector bounding regions output by the object detector based on a result of classifying (or identifying) and/or localizing certain objects in one or more images.

At block 904, process 900 includes determining a group of bounding regions from the first set of bounding regions, the group including at least a first bounding region and a second bounding region. The group can be identified by grouping engine 704 based on various criteria. For example, grouping engine 704 can calculate a center coordinate for each of the first set of bounding regions, and can determine a location for each bounding region in the video frame. Based on the location information, the bounding regions can be grouped based on a degree of proximity between two bounding regions (for groups of two bounding regions) or among three bounding regions (for groups of three bounding regions). The bounding regions can also be grouped based on other criteria, such as based on full permutations, to identify all possible groups of two and three bounding regions from the first set of bounding regions.

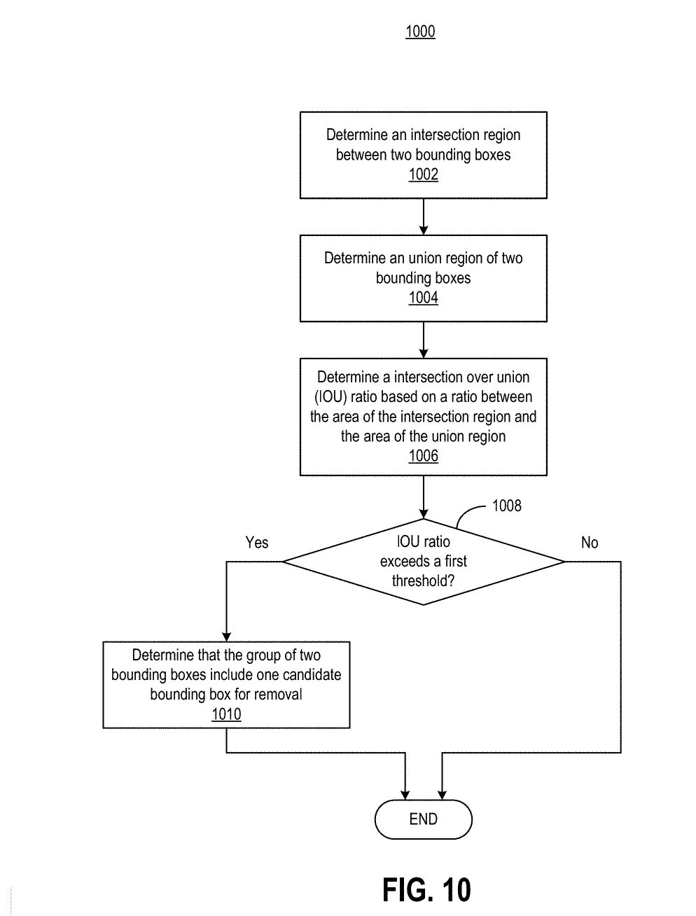

At block 906, process 900 includes removing a bounding region from the group of bounding regions based on one or more metrics associated with the bounding region. In some cases, the process 900 can include determining the one or more of metrics associated with at least the first bounding region and the second bounding region. The one or more metrics may include, for example, an intersection-over-union ratio between the first bounding region and the second bounding region, an area of an intersection region between the first and second bounding regions, the areas of the first and second bounding regions, the relative locations between the first and second bounding regions (e.g., to determine whether the first bounding region overlaps with a portion of the second bounding region along a particular axis), any combination thereof, and/or any other suitable metrics. In some cases, the process 900 can include determining, based on the one or more metrics, that the group of bounding regions includes a candidate bounding region for removal, where the candidate bounding region includes the bounding region that is removed from the group of bounding regoins. The determination can be performed based on the techniques disclosed above with respect to two bounding boxes analysis engine 710 and three bounding boxes analysis engine 730, and with respect to FIG. 10-FIG. 15 as described in detail below.

In some examples, the process 900 can include determining whether to remove the candidate bounding region from the group of bounding regions based on a confidence level associated with the candidate bounding region. For example, the process 900 can process, based on determining whether to remove the candidate bounding region from the first group, the first group based on the confidence level associated with the candidate bounding region. The processing can be performed by, for example, bounding box processing engine 740. For example, from the first group, a candidate bounding region can be selected for removal based on, for example, the candidate bounding region being associated with the minimum confidence level within the first group. As another example, if the first group contains bounding regions associated with different objects, the candidate bounding region may not be removed.

In some examples, the process 900 can include determining a second set of bounding regions based on whether the candidate bounding region is removed from the group of bounding regions. For example, the second set of bounding regions can be determined based on the group of bounding regions including the processed first group. As discussed above, the processed first group may or may not have the candidate bounding region removed. In a case where the candidate bounding region is selected to be removed at block 910, the candidate bounding region will be removed from the first group and from the second set of bounding regions. At block 914, process 900 includes performing object tracking for the video frame using the second set of bounding regions. For example, the second set of bounding regions can be combined with another set of bounding regions obtained from blob detector to perform the object tracking.

At block 908, process 900 includes performing object tracking for the video frame using an updated set of bounding regions. The updated set of bounding regions is based on removal of the bounding region from the group of bounding regions. The updated set of bounding regions can be the second set of bounding regions discussed above (e.g., when the second set of bounding regions is determined based on whether the candidate bounding region is removed from the group of bounding region).

As described above, a key frame is a frame from the sequence of video frames to which the object detector is applied. In some cases, blob detection is performed for each video frame of the sequence of video frames to detect one or more blobs in each video frame, and the object detector is applied only to key frames of the sequence of video frames.

In some examples, the process 900 can include determining the one or more metrics. Determining the one or more metrics can include determining an intersection-over-union (IoU) ratio associated with the first bounding region and the second bounding region in the group, and determining the IoU ratio exceeds a first ratio threshold. In such examples, the bounding region can be removed from the group based on determining that the IoU ratio exceeds the first ratio threshold.

In some examples, determining the one or more metrics can include determining a first area of a first intersection region between the first bounding region and the second bounding region in the group, and determining a second area of the first bounding region. In such examples, the first bounding region is smaller than the second bounding region. Determining the one or more metrics can further include determining a second ratio between the first area and the second area. In some cases, the process 900 can include determining that the second ratio exceeds a second ratio threshold. In such cases, the second ratio threshold is higher than the first ratio threshold. The bounding region can be removed based on the second ratio exceeding the second ratio threshold.

In some examples, the process 900 can include determining that the second ratio exceeds a third ratio threshold, where the third ratio threshold is lower than the second ratio threshold. The process 900 can further include determining that the first bounding region intersects with the second bounding region at a pre-determined location. The bounding region can be removed based on the second ratio exceeding the third ratio threshold and the first bounding region intersecting with the second bounding region at the pre-determined location.

In some examples, the process 900 can include determining that the second ratio exceeds a fourth ratio threshold. In such examples, the fourth ratio threshold is lower than each of the second ratio threshold and the third ratio threshold. The process 900 can further include determining that a confidence level of at least one of the first bounding region and the second bounding region is below a first confidence threshold. The bounding region can be removed based on the second ratio exceeding the fourth ratio threshold and the confidence level of at least one of the first bounding region and the second bounding region being below the first confidence threshold.

In some examples, the group of bounding regions can further include a third bounding region. In some aspects, determining the one or more metrics can include determining a third area of a third intersection region between the first bounding region and the third bounding region, determining a fourth area of a fourth intersection region between the second bounding region and the third bounding region, determining an aggregate area based on the third area and the fourth area, and determining a third ratio between an area of the third bounding region and the aggregate area. In such examples, the bounding region can be removed based on determining that the third ratio exceeds a fifth ratio threshold, that each of a first confidence level of the first bounding region and a second confidence level of the second bounding region exceeds a second confidence threshold, and that a third confidence level of the third bounding region is below a third confidence threshold, the third confidence threshold being lower than the second confidence threshold.

In some examples, the bounding region is removed from the group further based on a confidence level associated with the candidate bounding region. In such examples, the process 900 can include determining the bounding region is associated with a minimum confidence level within the group of bounding regions, and determining the minimum confidence level is below a fourth confidence threshold. In some cases, the bounding region is removed from the group of bounding regions based on the minimum confidence level being below the fourth confidence threshold. The object tracking for the video frame may be performed without the bounding region. In some aspects, the confidence level associated with the candidate bounding region indicates a probability of the candidate bounding region enclosing an object of the one or more obj ects.

In some examples, the process 900 can include determining the first bounding region is the bounding region to be removed from the group of bounding regions, determining whether the first bounding region and the second bounding region are associated with different objects, and maintaining the first bounding region in the group in response to determining that the first bounding region and the second bounding region are associated with different objects. In such examples, the object tracking for the video frame is performed with the updated set of bounding regions including the first bounding region. In some cases, the determination of whether the first bounding region and the second bounding region are associated with different objects can be based on trajectories of the first bounding region and the second bounding region across a plurality of video frames.

In some examples, the process 900 can include detecting one or more blobs for the video frame, and obtaining a set of blob bounding regions based on the detected one or more blobs. The object tracking can be performed based on a combination of the updated set of bounding regions and the set of blob bounding regions.

In some examples, the object detector comprises a feature-based detector. In some aspects, the object detector is a complex object detector. In some aspects, the object detector is based on a trained classification network. For example, the object detector can be a complex object detector that is based on a trained classification network.

FIG. 10 is a flow chart illustrating an example of a process 1000 for determining whether a group of two bounding boxes includes a candidate bounding box for removal from object tracking using the techniques disclosed herein. Process 1000 may be part of block 906 of process 900, and can be performed by, for example, first bounding box metrics analysis engine 712 of FIG. 7. At block 1002, process 1000 includes determining an intersection region between a group of two bounding boxes. At block 1004, process 1000 includes determining an union region between a group of two bounding boxes. The determination of the intersection region and the union region can be based on the coordinates, widths, and heights of the bounding boxes as described with respect to FIG. 5B. At block 1006, process 1000 includes determining a intersection over union (IoU) ratio based on a ratio between the area of the intersection region and the area of the union region. The IoU ratio can indicate a degree of overlap between the two bounding boxes. A higher IoU ratio can indicate a higher likelihood that one of the two bounding boxes is a duplicated bounding box. At block 1008, process 1000 includes determining whether the IoU ratio exceeds a first threshold. In some embodiments, the first threshold can be set at 0.3. Process 1000 may include, at block 1010, determining that the group of two bounding boxes include one candidate bounding box for removal, if the IoU ratio exceeds the first threshold. If the IoU ratio does not exceed the first threshold, process 1000 may proceed to the end.

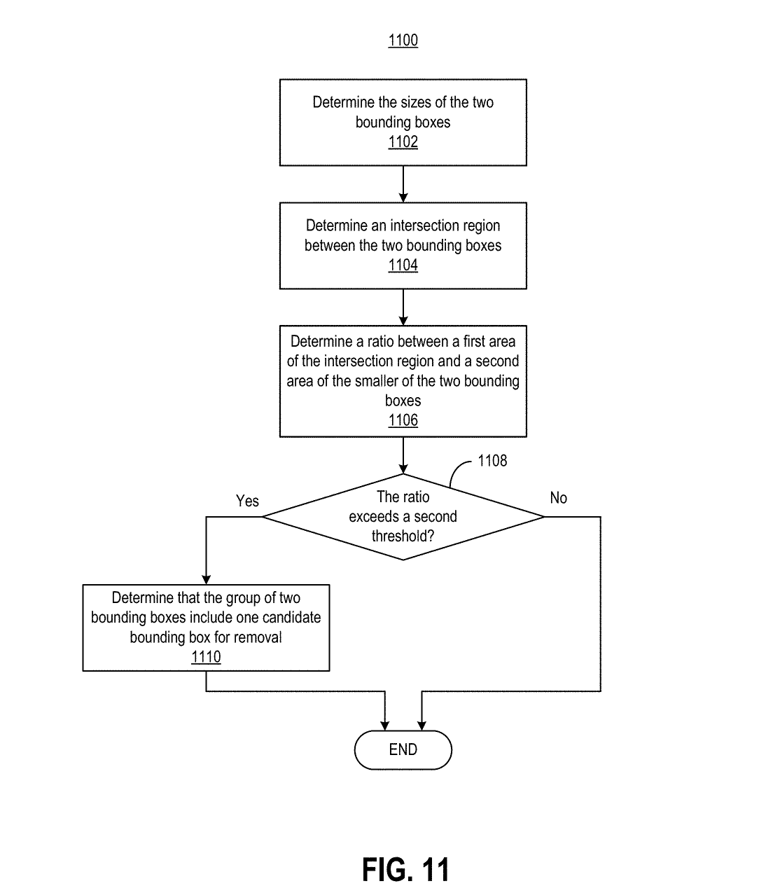

FIG. 11 is a flow chart illustrating an example of a process 1100 for determining whether a group of two bounding boxes includes a candidate bounding box for removal from object tracking using the techniques disclosed herein. Process 1100 may be part of block 906 of process 900, and can be performed by, for example, second bounding box metrics analysis engine 714 of FIG. 7. At block 1102, process 1100 includes determining the sizes of the two bounding boxes. The sizes can be determined based on, of example, the widths and heights of the boxes. At block 1104, process 1100 includes determining an intersection region between the two bounding boxes. At block 1106, process 1100 includes determining a ratio between a first area of the intersection region and a second area of the smaller of the two bounding boxes. If the two bounding boxes have the same size, the second area can be set at the size of one of the two bounding boxes. The ratio can be a full inclusion indicator to reflect a percentage of the smaller of the two bounding boxes is enclosed by the larger of the two bounding boxes. A higher ratio can indicate a higher likelihood that one of the two bounding boxes is a duplicated bounding box. At block 1108, process 1100 includes determining whether the ratio exceeds a second threshold. The second threshold can be higher than the first threshold of FIG. 11. In some embodiments, the second threshold can be set at 0.79. Process 1100 may include, at block 1110, determining that the group of two bounding boxes include one candidate bounding box for removal, if the ratio exceeds the second threshold. If the ratio does not exceed the second threshold, process 1100 may proceed to the end.

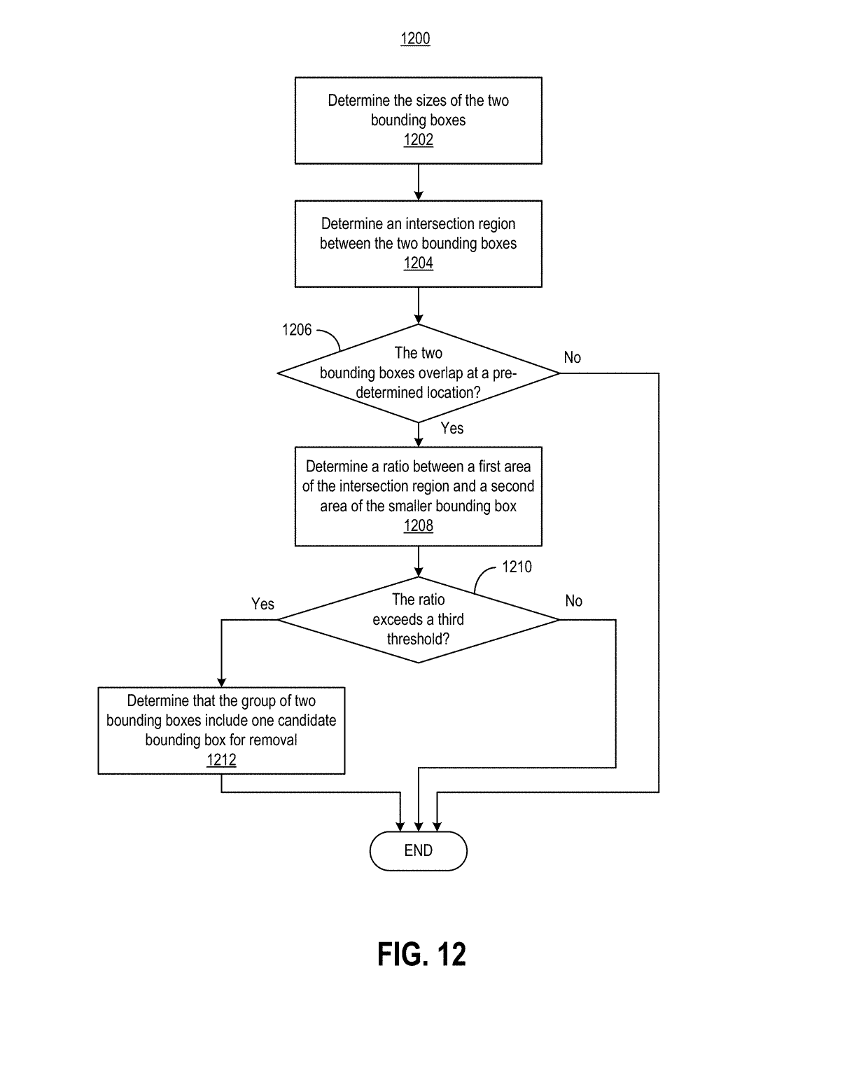

FIG. 12 is a flow chart illustrating an example of a process 1200 for determining whether a group of two bounding boxes includes a candidate bounding box for removal from object tracking using the techniques disclosed herein. Process 1200 may be part of block 906 of process 900, and can be performed by, for example, third bounding box metrics analysis engine 716 of FIG. 7. At block 1202, process 1200 includes determining the sizes of the two bounding boxes. The sizes can be determined based on, of example, the widths and heights of the boxes. At block 1204, process 1200 includes determining an intersection region between the two bounding boxes. At block 1206, process 1200 includes determining whether the two bounding boxes overlap at a pre-determined location. The pre-determined location can be based on a characteristic of the object being tracked. For example, as discussed above, if the object being tracked is a human being in a standing posture, the system may determine whether the a first bounding box overlaps with a top portion of the second bounding box. If the object being tracked is a dog in a walking posture, the system may determine whether the first bounding box overlaps with a side portion of the second bounding box. Process 1200 may further include, at block 1208, determining a ratio between a first area of the intersection region and a second area of the smaller of the two bounding boxes, if the two bounding boxes overlap at the pre-determined location. If the two bounding boxes have the same size, the second area can be set at the size of one of the two bounding boxes. At block 1210, process 1200 further includes determining whether the ratio exceeds a third threshold. The third threshold can be lower than the second threshold of process 1100. In some embodiments, the third threshold can be set at 0.78. Process 1200 may include, at block 1212, determining that the group of two bounding boxes include one candidate bounding box for removal, if the ratio exceeds the third threshold. If the ratio does not exceed the third threshold, process 1200 may proceed to the end. Moreover, if the two bounding boxes does not overlap at the pre-determined location (but at other locations) as determined in block 1206, process 1200 may proceed to the end as well.

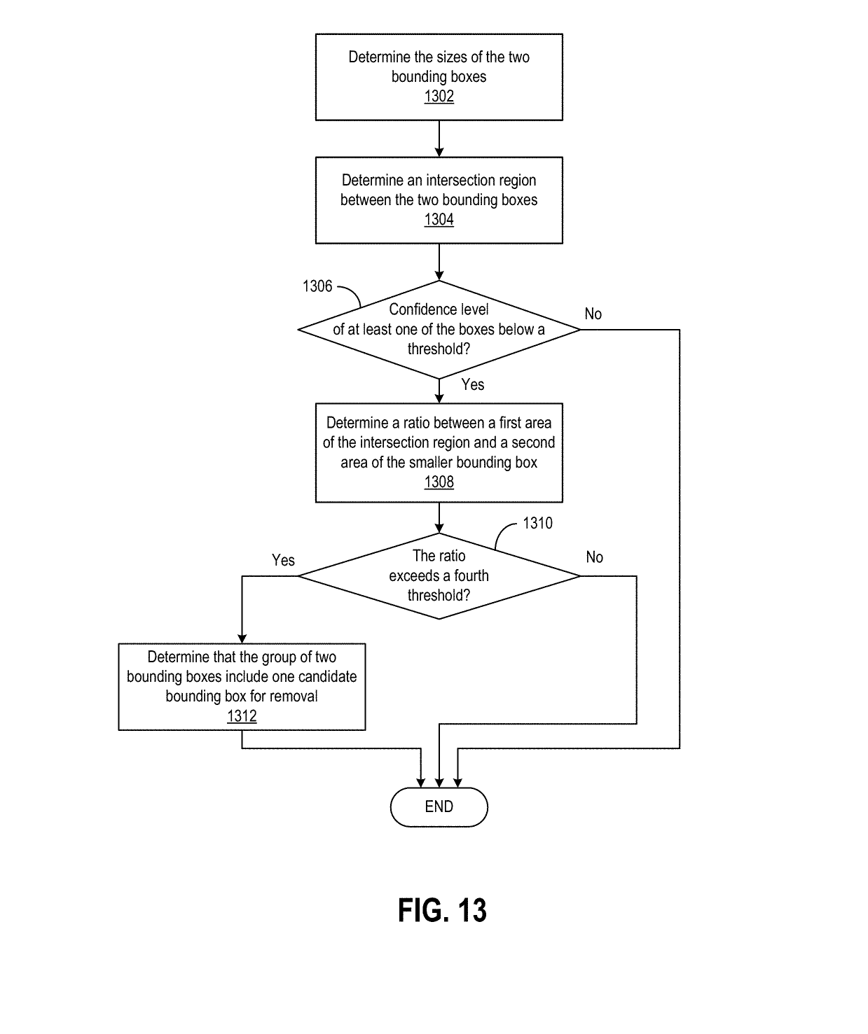

FIG. 13 is a flow chart illustrating an example of a process 1300 for determining whether a group of two bounding boxes includes a candidate bounding box for removal from object tracking using the techniques disclosed herein. Process 1300 may be part of block 906 of process 900, and can be performed by, for example, fourth bounding box metrics analysis engine 718 of FIG. 7. At block 1302, process 1300 includes determining the sizes of the two bounding boxes. The sizes can be determined based on, of example, the widths and heights of the boxes. At block 1304, process 1300 includes determining an intersection region between the two bounding boxes. At block 1306, process 1300 includes determining whether the confidence level of at least one of the two bounding boxes is below a confidence threshold. A bounding box being associated with a low confidence level may indicate that it may not be useful for object tracking and is likely to be a duplicated bounding box. In some embodiments, the confidence threshold can be set at 0.3. Process 1300 may further include, at block 1308, determining a ratio between a first area of the intersection region and a second area of the smaller of the two bounding boxes, if the confidence level of at least one of the two bounding boxes is below the confidence threshold. If the two bounding boxes have the same size, the second area can be set at the size of one of the two bounding boxes. At block 1310, process 1300 further includes determining whether the ratio exceeds a fourth threshold. The fourth threshold can be lower than the third threshold of process 1200. In some embodiments, the fourth threshold can be set at 0.7. Process 1300 may include, at block 1312, determining that the group of two bounding boxes include one candidate bounding box for removal, if the ratio exceeds the fourth threshold. If the ratio does not exceed the fourth threshold, process 1300 may proceed to the end. Moreover, if the confidence levels of both of the two bounding boxes exceed the confidence threshold, process 1300 may proceed to the end as well.

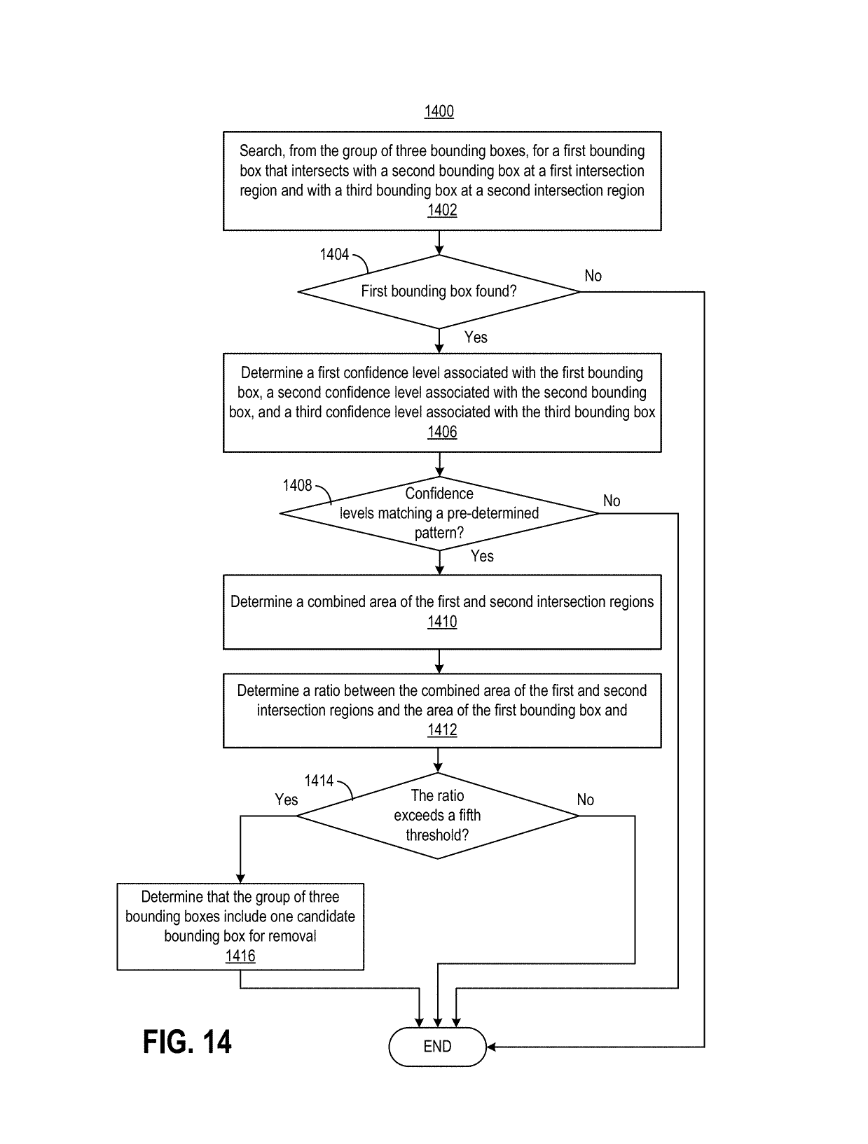

FIG. 14 is a flow chart illustrating an example of a process 1400 for determining whether a group of three bounding boxes includes a candidate bounding box for removal from object tracking using the techniques disclosed herein. Process 1400 may be part of block 906 of process 900, and can be performed by, for example, fifth bounding box metrics analysis engine 732 of FIG. 7. At block 1402, process 1400 includes searching, from the group of three bounding boxes, for a first bounding box that intersects with a second bounding box at a first intersection region and with a third bounding box at a second intersection region. At block 1404, process 1400 may determine whether the first bounding box is found. At block 1406, process 1400 may include determining a first confidence level associated with the first bounding box, a second confidence level associated with the second bounding box, and a third confidence level associated with the third bounding box, if the first bounding box can be found at block 1404. At block 1408, process 1400 may include determining whether the first, second, and third confidence levels match a pre-determined pattern. For example, process 1400 may determine whether the first confidence level is below a low confidence threshold and whether the second and third confidence levels are above a high confidence threshold. The determination at block 1408 can provide an indication about whether the first bounding box is likely to be a duplicated bounding box for the other two bounding boxes. Process 1400 may include, at block 1410, determining a combined area of the first and second intersection regions, if the first, second, and third confidence levels match the pre-determined pattern. The combined area can be determined based on, for example, summing the areas of the first and second intersection regions and subtracting away any overlap areas between the first and second intersection regions. Process 1400 may include, at block 1412, determining a ratio between the combined area and the area of the first bounding box. The ratio reflects a degree of overlap of the first bounding box with each of the second and third bounding boxes, and a high ratio may indicate that the first bounding box is likely to be a duplicated bounding box. At block 1414, process 1400 further includes determining whether the ratio exceeds a fifth threshold (denoted as lowBBoxCoverageByHighBoxT). In some embodiments, the fifth threshold can be set at 0.85. Process 1400 may include, at block 1416, determining that the group of three bounding boxes includes one candidate bounding box for removal, if the ratio exceeds the fifth threshold. If the ratio does not exceed the fifth threshold, process 1400 may proceed to the end. Moreover, if the first bounding box is not found at block 1404, or if the confidence levels do not match the pre-determined pattern at block 1408, process 1400 may proceed to the end.

In some examples, processes 900-1400 may be performed by a computing device or an apparatus, such as the video analytics system 100. In one illustrative example, the processes can be performed by the video analytics system 600 shown in FIG. 6. In some cases, the computing device or apparatus may include a processor, microprocessor, microcomputer, or other component of a device that is configured to carry out the steps of the processes. In some examples, the computing device or apparatus may include a camera configured to capture video data (e.g., a video sequence) including video frames. For example, the computing device may include a camera device (e.g., an IP camera or other type of camera device) that may include a video codec. In some examples, a camera or other capture device that captures the video data is separate from the computing device, in which case the computing device receives the captured video data. The computing device may further include a network interface configured to communicate the video data. The network interface may be configured to communicate Internet Protocol (IP) based data.

Processes 900-1400 are illustrated as logical flow diagrams, the operation of which represent a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, processes 900-1400 may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program comprising a plurality of instructions executable by one or more processors. The computer-readable or machine-readable storage medium may be non-transitory.

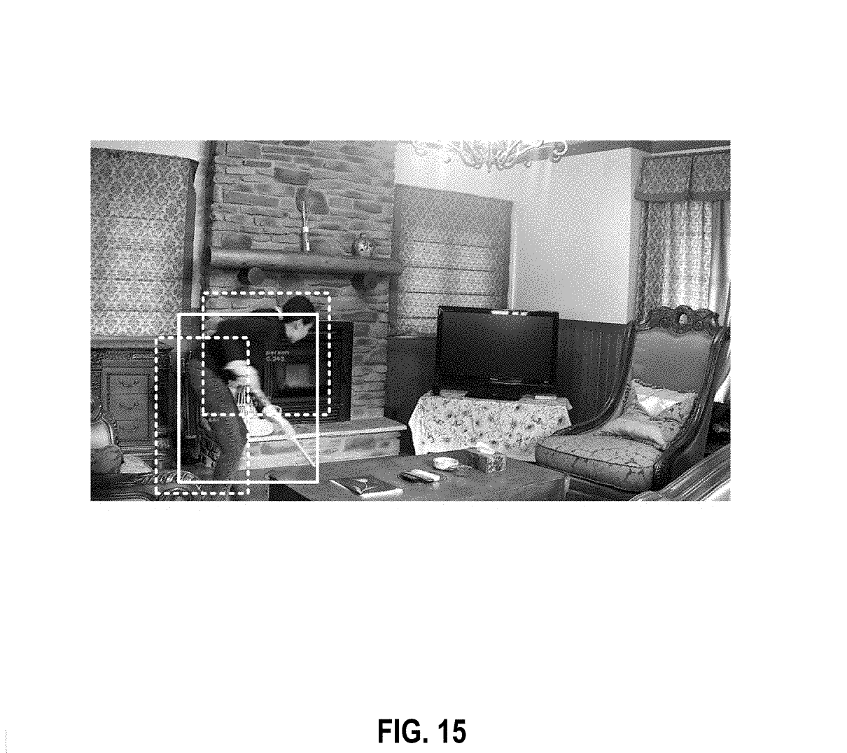

FIG. 15-FIG. 32 are video frames illustrating several subjective examples comparing the duplicated bounding box detection techniques described herein (using a hybrid video analytics system) and a conventional video analytics system that does not use the duplicated bounding box detection technique. In the examples shown in FIG. 15-FIG. 32, the bounding boxes in solid lines are retained by a duplicated bounding box suppression system employing techniques described herein. The duplicated bounding box techniques described herein are applied to the indoor sequences shown in FIG. 15-FIG. 32 for home security, which include videos from different scenarios including different persons (one person, two persons, three persons, five persons), different human behaviors (still, moving, interaction), and different lighting conditions (normal, dark). The bounding boxes in dotted lines are anchor versions which can be removed by the duplicated bounding box suppression system.

FIG. 15 is a video frame of an environment with a person. The bounding boxes with dotted lines are determined to be duplicate bounding boxes of the bounding box in solid lines and are removed.

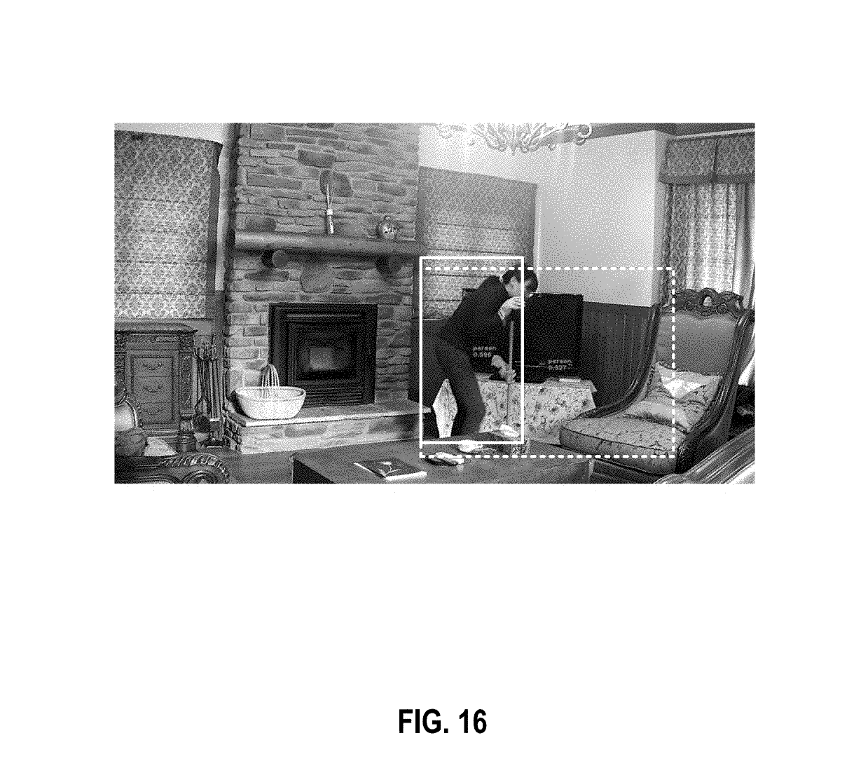

FIG. 16 is a video frame of an environment with a person. The bounding box with dotted lines is determined to be a duplicate bounding box of the bounding box in solid lines and is removed.

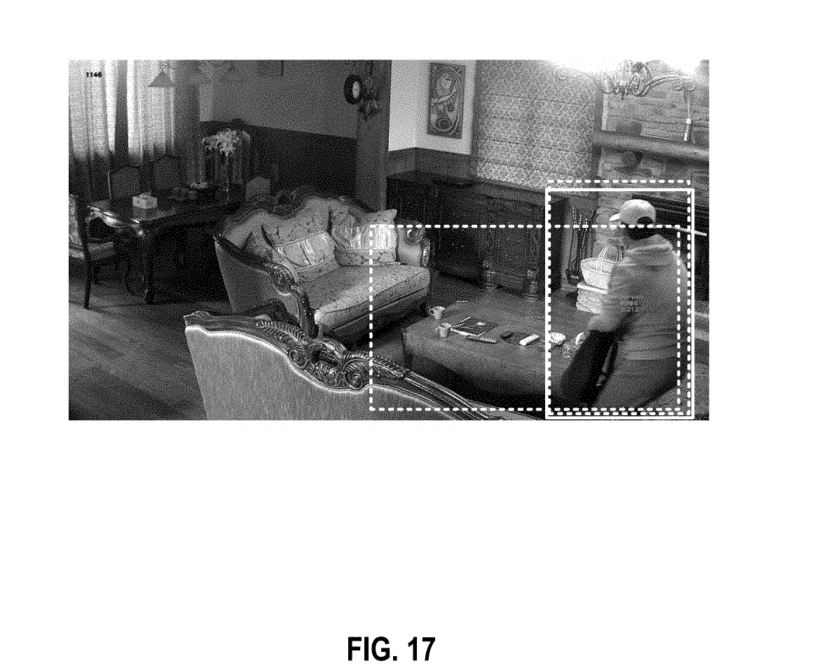

FIG. 17 is a video frame of an environment with a person. The bounding boxes with dotted lines are determined to be duplicate bounding boxes of the bounding box in solid lines and are removed.

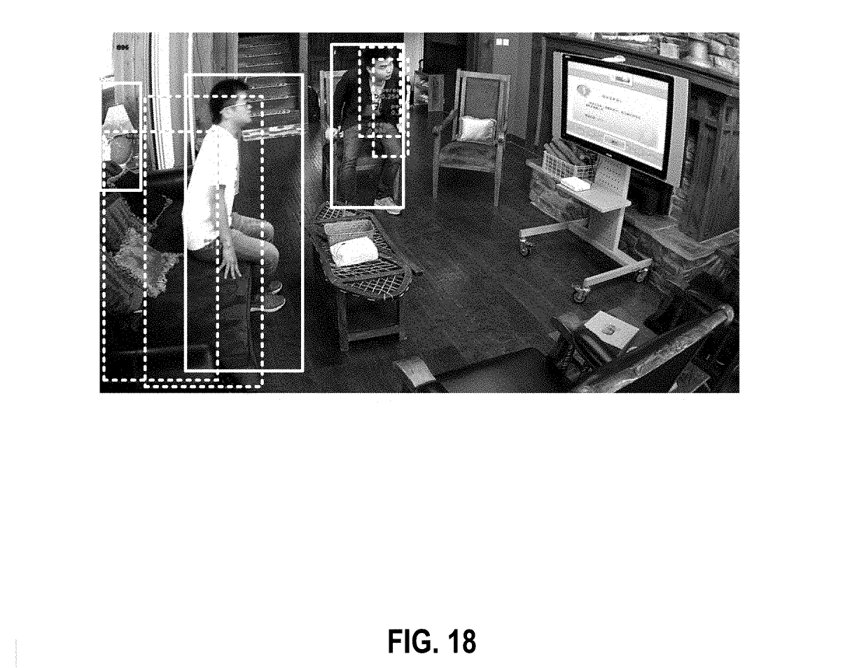

FIG. 18 is a video frame of an environment with two people. The bounding boxes with dotted lines are determined to be duplicate bounding boxes of the bounding boxes in solid lines and are removed.

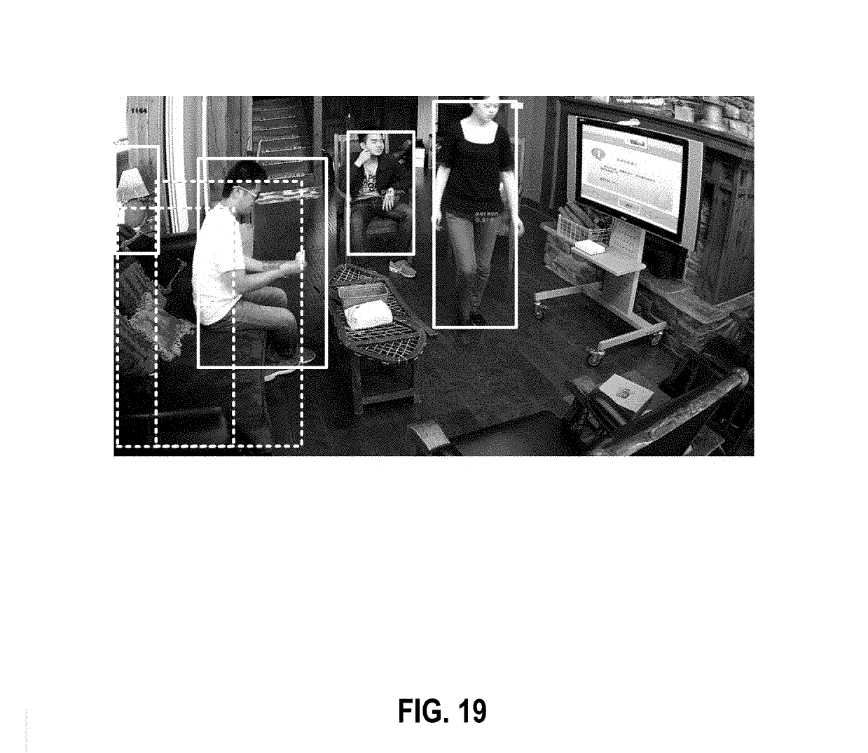

FIG. 19 is a video frame of an environment with three people. The bounding boxes with dotted lines are determined to be duplicate bounding boxes of one of the bounding boxes in solid lines and are removed.

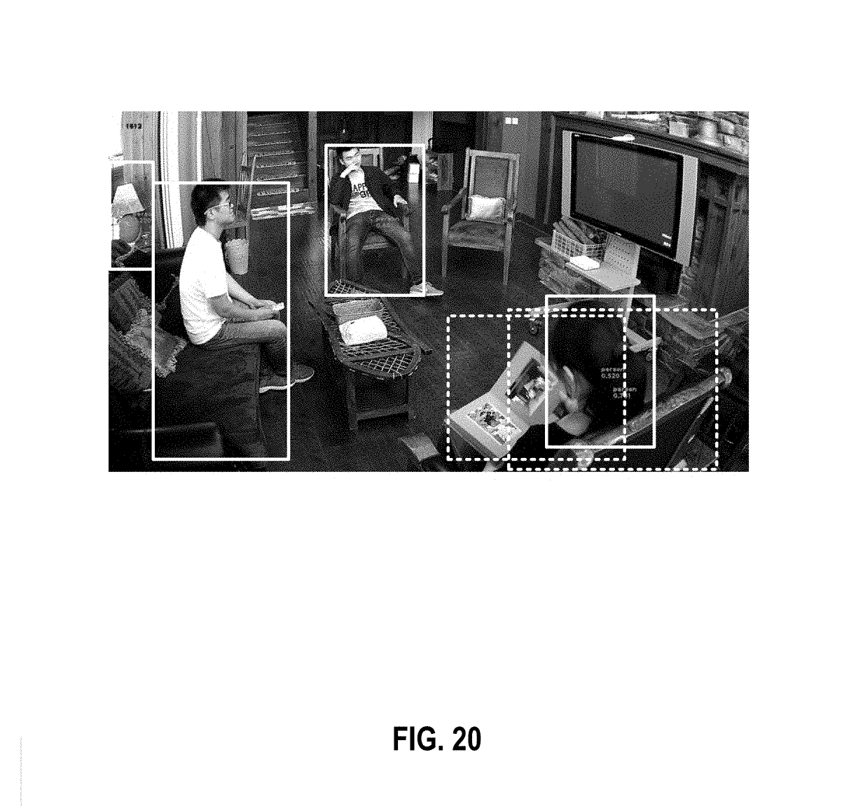

FIG. 20 is a video frame of an environment with three people. The bounding boxes with dotted lines are determined to be duplicate bounding boxes of one of the bounding boxes in solid lines and are removed.

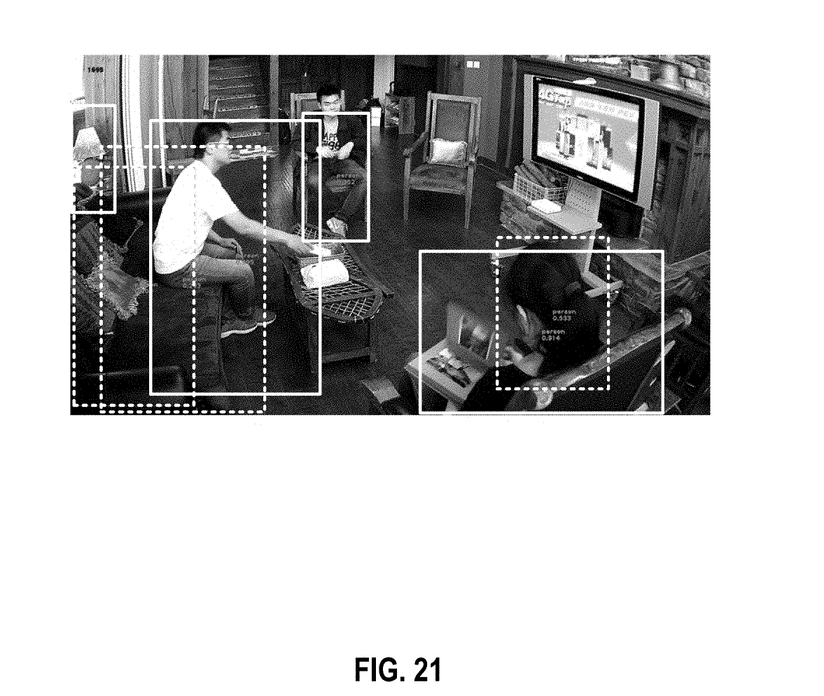

FIG. 21 is a video frame of an environment with three people. The bounding boxes with dotted lines are determined to be duplicate bounding boxes of two of the bounding boxes in solid lines and are removed.

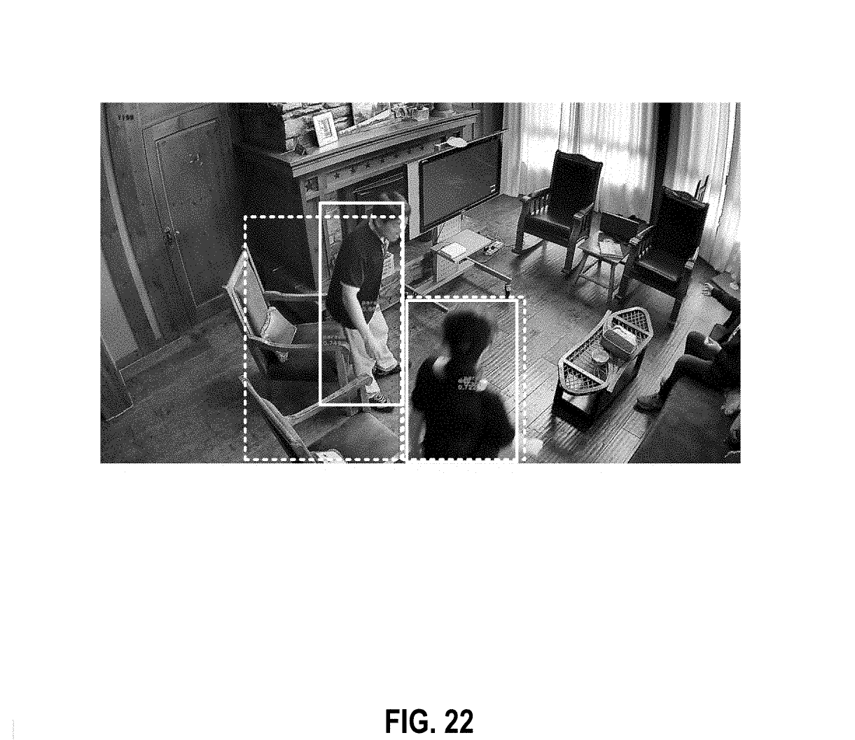

FIG. 22 is a video frame of an environment with two people. The bounding boxes with dotted lines are determined to be duplicate bounding boxes of the bounding boxes in solid lines and are removed.

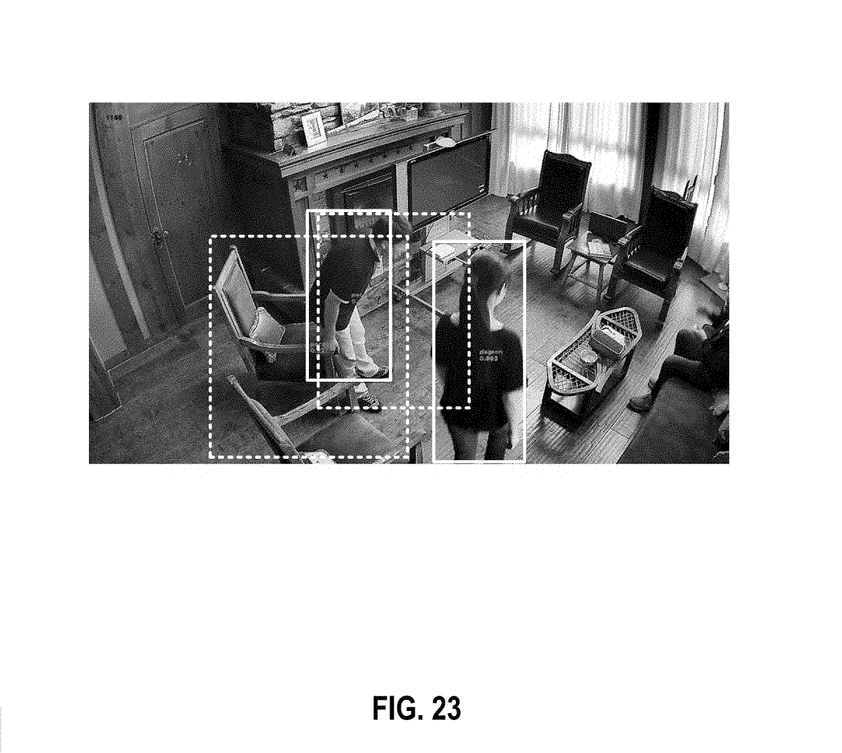

FIG. 23 is a video frame of an environment with two people. The bounding boxes with dotted lines are determined to be duplicate bounding boxes of one of the bounding boxes in solid lines and are removed.

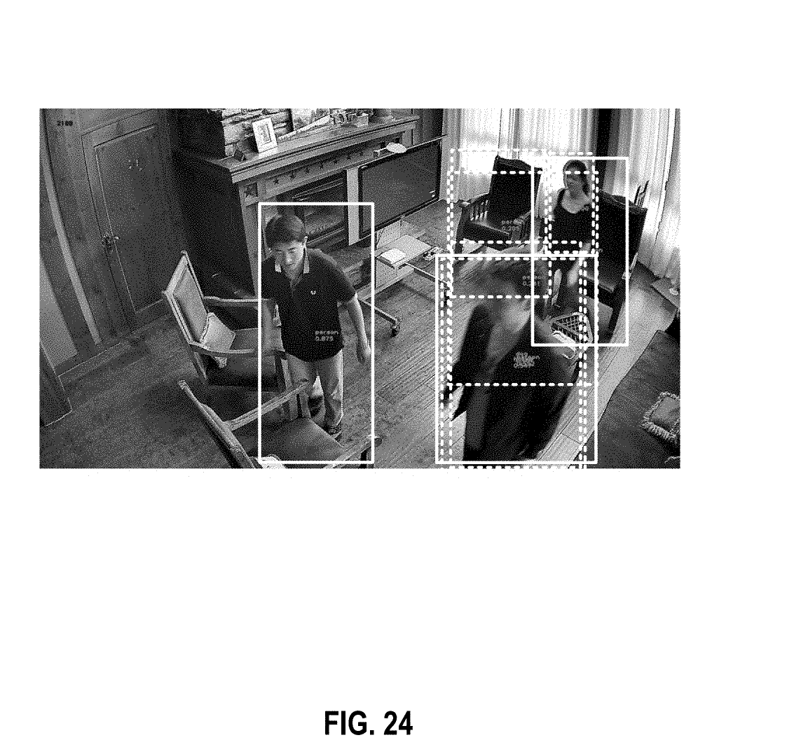

FIG. 24 is a video frame of an environment with three people. The bounding boxes with dotted lines are determined to be duplicate bounding boxes of two of the bounding boxes in solid lines and are removed.

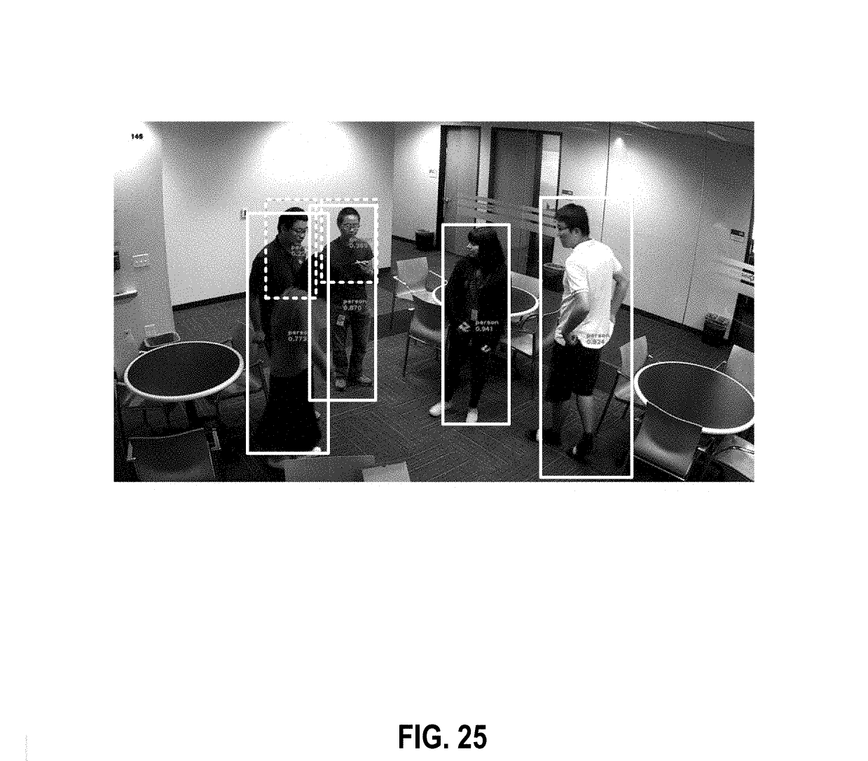

FIG. 25 is a video frame of an environment with five people. The bounding boxes with dotted lines are determined to be duplicate bounding boxes of two of the bounding boxes in solid lines and are removed.

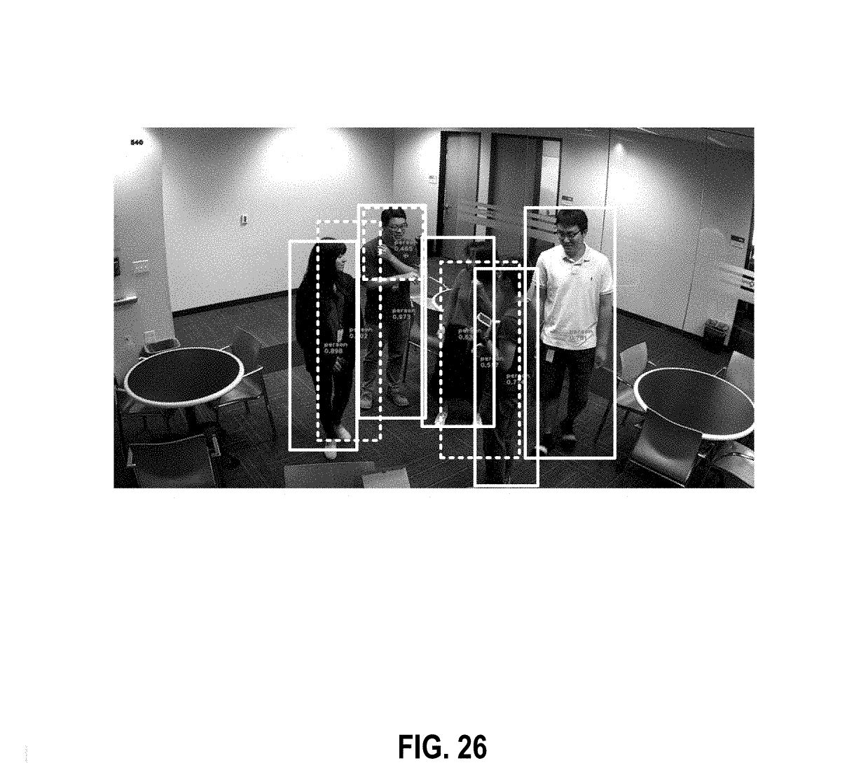

FIG. 26 is a video frame of an environment with five people. The bounding boxes with dotted lines are determined to be a duplicate bounding boxes of three of the bounding boxes in solid lines and are removed.

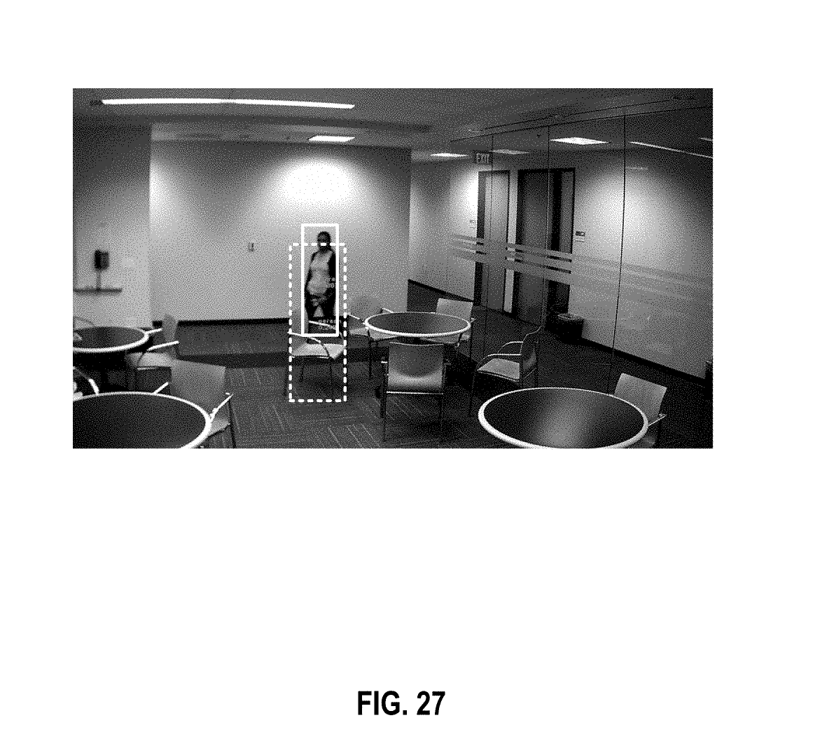

FIG. 27 is a video frame of an environment with a person. The bounding box with dotted lines is determined to be a duplicate bounding box of the bounding box in solid lines and is removed.

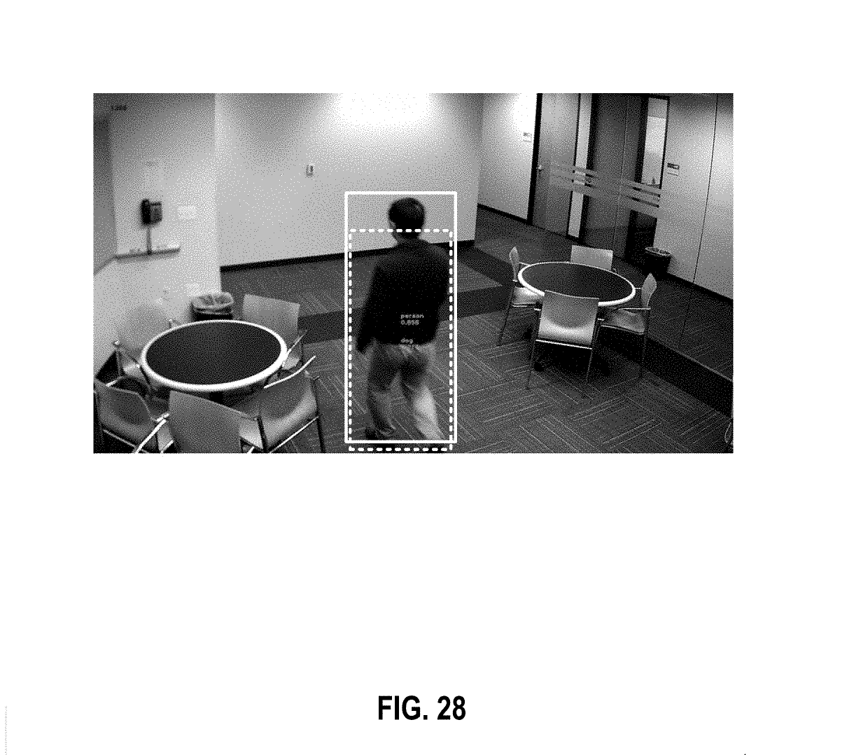

FIG. 28 is a video frame of an environment with a person. The bounding box with dotted lines is determined to be duplicate bounding box of the bounding box in solid lines and is removed.

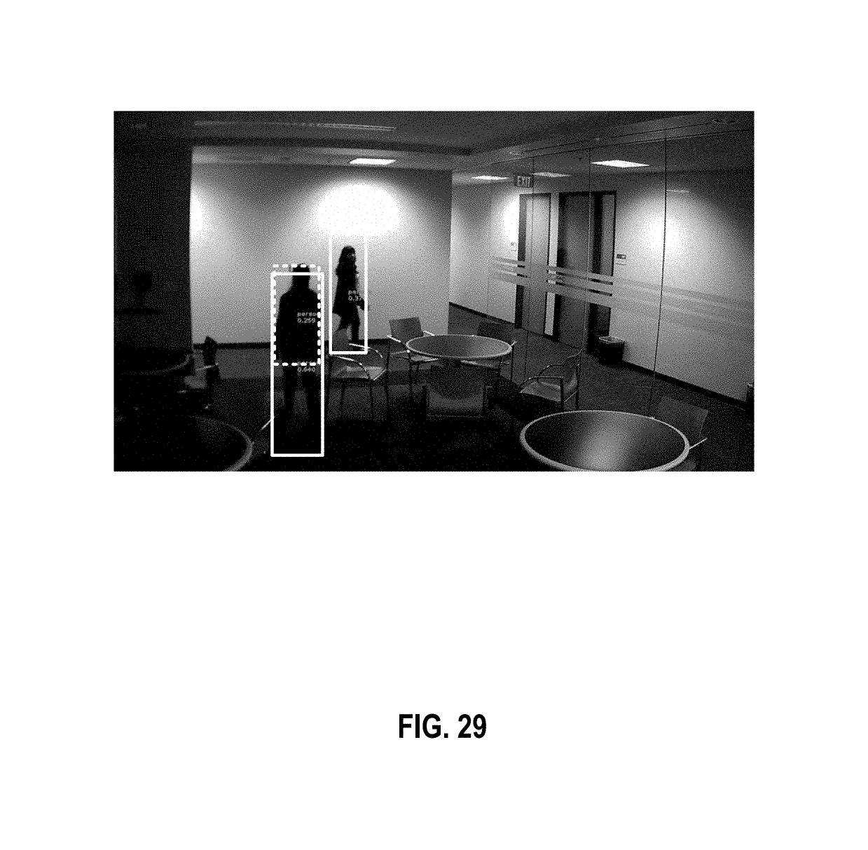

FIG. 29 is a video frame of an environment with two people. The bounding box with dotted lines is determined to be a duplicate bounding box of one of the bounding boxes in solid lines and is removed.

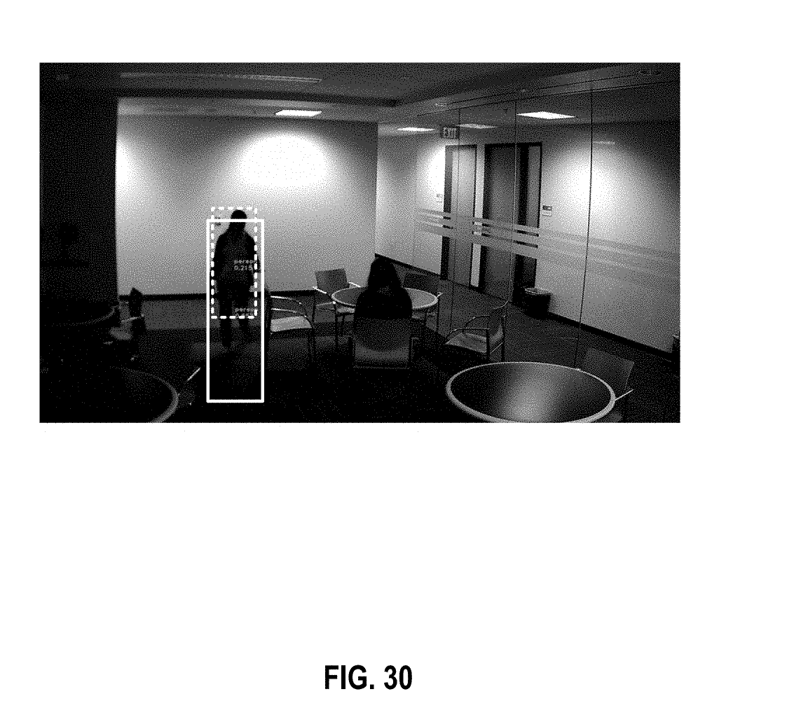

FIG. 30 is a video frame of an environment with two people, with a set of bounding boxes associated with one of the two people. The bounding box with dotted lines is determined to be a duplicate bounding box of the bounding box in solid lines and is removed.

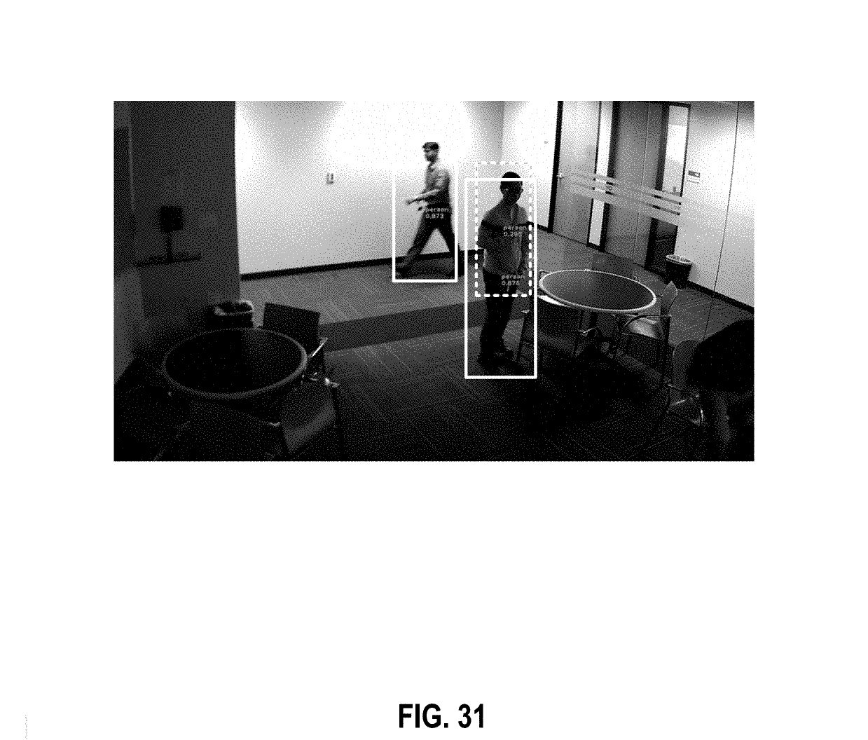

FIG. 31 is a video frame of an environment with two people. The bounding box with dotted lines is determined to be a duplicate bounding box of the bounding box in solid lines and is removed.

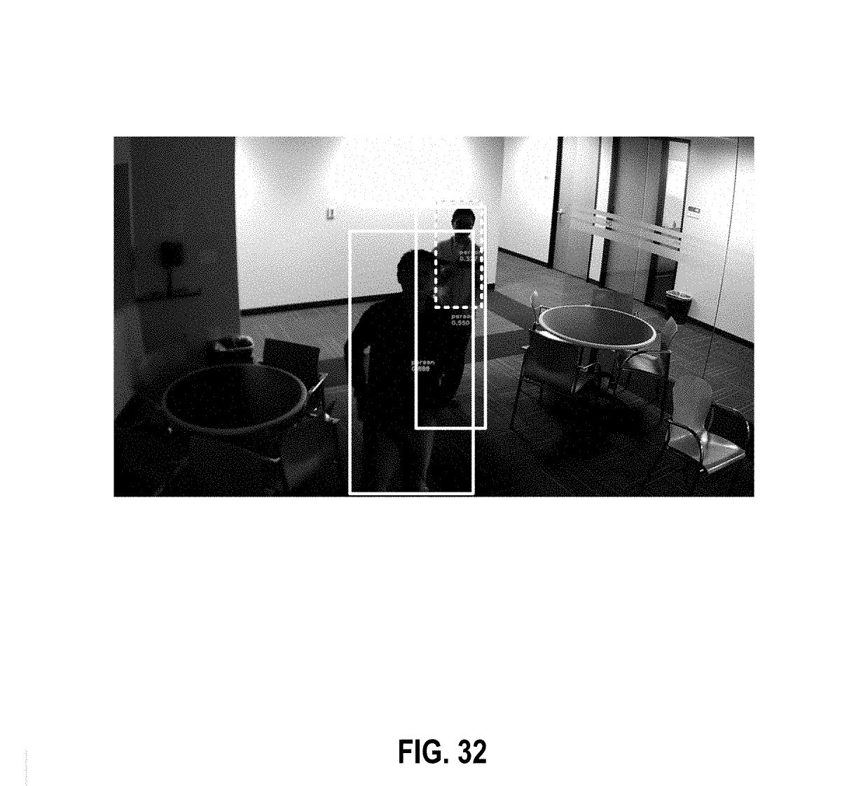

FIG. 32 is a video frame of an environment with two people. The bounding box with dotted lines is determined to be a duplicate bounding box of one of the bounding boxes in solid lines and is removed.

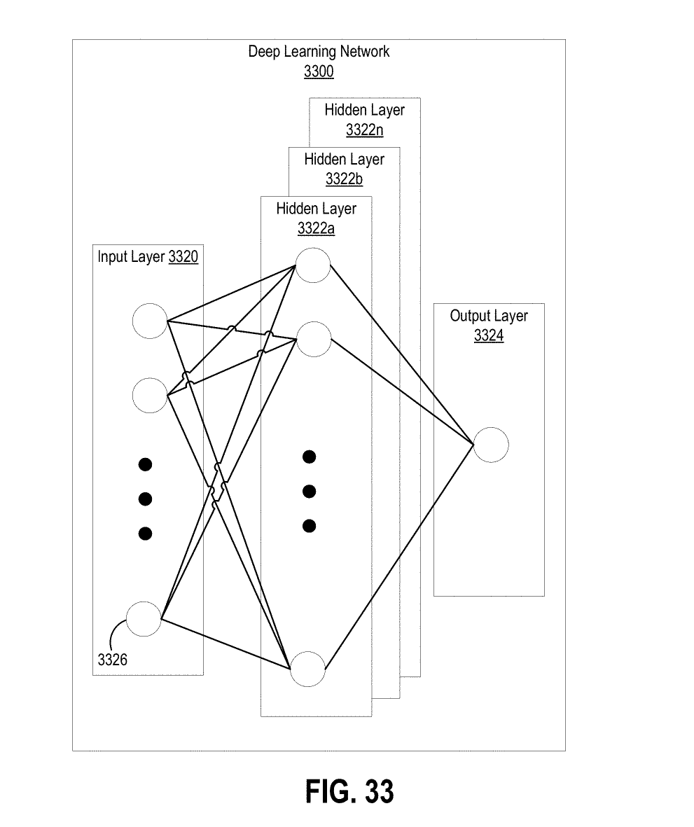

FIG. 33 is an illustrative example of a deep learning neural network 3300 that can be used by complex object detector system 608. An input layer 3320 includes input data. In one illustrative example, the input layer 3320 can include data representing the pixels of an input video frame. The deep learning network 3300 includes multiple hidden layers 3322a, 3322b, through 3322n. The hidden layers 3322a, 3322b, through 3322n include “n” number of hidden layers, where “n” is an integer greater than or equal to one. The number of hidden layers can be made to include as many layers as needed for the given application. The deep learning network 3300 further includes an output layer 3324 that provides an output resulting from the processing performed by the hidden layers 3322a, 3322b, through 3322n. In one illustrative example, the output layer 3324 can provide a classification and/or a localization for an object in an input video frame. The classification can include a class identifying the type of object (e.g., a person, a dog, a cat, or other object) and the localization can include a bounding box indicating the location of the object.

The deep learning network 3300 is a multi-layer neural network of interconnected nodes. Each node can represent a piece of information. Information associated with the nodes is shared among the different layers and each layer retains information as information is processed. In some cases, the deep learning network 3300 can include a feed-forward network, in which case there are no feedback connections where outputs of the network are fed back into itself In some cases, the network 3300 can include a recurrent neural network, which can have loops that allow information to be carried across nodes while reading in input.

Information can be exchanged between nodes through node-to-node interconnections between the various layers. Nodes of the input layer 3320 can activate a set of nodes in the first hidden layer 3322a. For example, as shown, each of the input nodes of the input layer 3320 is connected to each of the nodes of the first hidden layer 3322a. The nodes of the hidden layer 3322 can transform the information of each input node by applying activation functions to these information. The information derived from the transformation can then be passed to and can activate the nodes of the next hidden layer 3322b, which can perform their own designated functions. Example functions include convolutional, up-sampling, data transformation, and/or any other suitable functions. The output of the hidden layer 3322b can then activate nodes of the next hidden layer, and so on. The output of the last hidden layer 3322n can activate one or more nodes of the output layer 3324, at which an output is provided. In some cases, while nodes (e.g., node 3326) in the deep learning network 3300 are shown as having multiple output lines, a node has a single output and all lines shown as being output from a node represent the same output value.

In some cases, each node or interconnection between nodes can have a weight that is a set of parameters derived from the training of the deep learning network 3300. For example, an interconnection between nodes can represent a piece of information learned about the interconnected nodes. The interconnection can have a tunable numeric weight that can be tuned (e.g., based on a training dataset), allowing the deep learning network 3300 to be adaptive to inputs and able to learn as more and more data is processed.

The deep learning network 3300 is pre-trained to process the features from the data in the input layer 3320 using the different hidden layers 3322a, 3322b, through 3322n in order to provide the output through the output layer 3324. In an example in which the deep learning network 3300 is used to identify objects in images, the network 3300 can be trained using training data that includes both images and labels. For instance, training images can be input into the network, with each training image having a label indicating the classes of the one or more objects in each image (basically, indicating to the network what the objects are and what features they have). In one illustrative example, a training image can include an image of a number 2, in which case the label for the image can be [0 0 1 0 0 0 0 0 0 0].

In some cases, the deep neural network 3300 can adjust the weights of the nodes using a training process called backpropagation. Backpropagation can include a forward pass, a loss function, a backward pass, and a weight update. The forward pass, loss function, backward pass, and parameter update is performed for one training iteration. The process can be repeated for a certain number of iterations for each set of training images until the network 3300 is trained well enough so that the weights of the layers are accurately tuned.

For the example of identifying objects in images, the forward pass can include passing a training image through the network 3300. The weights are initially randomized before the deep neural network 3300 is trained. The image can include, for example, an array of numbers representing the pixels of the image. Each number in the array can include a value from 0 to 255 describing the pixel intensity at that position in the array. In one example, the array can include a 28×28×3 array of numbers with 28 rows and 28 columns of pixels and 3 color components (such as red, green, and blue, or luma and two chroma components, or the like).

For a first training iteration for the network 3300, the output will likely include values that do not give preference to any particular class due to the weights being randomly selected at initialization. For example, if the output is a vector with probabilities that the object includes different classes, the probability value for each of the different classes may be equal or at least very similar (e.g., for ten possible classes, each class may have a probability value of 0.1). With the initial weights, the network 3300 is unable to determine low level features and thus cannot make an accurate determination of what the classification of the object might be. A loss function can be used to analyze error in the output. Any suitable loss function definition can be used. One example of a loss function includes a mean squared error (MSE). The MSE is defined as Eₜₒₜₐₗ=Σ½(target−output)², which calculates the sum of one-half times the actual answer minus the predicted (output) answer squared. The loss can be set to be equal to the value of Eₜₒₜₐₗ.

The loss (or error) will be high for the first training images since the actual values will be much different than the predicted output. The goal of training is to minimize the amount of loss so that the predicted output is the same as the training label. The deep learning network 3300 can perform a backward pass by determining which inputs (weights) most contributed to the loss of the network, and can adjust the weights so that the loss decreases and is eventually minimized.

A derivative of the loss with respect to the weights (denoted as dL/dW, where W are the weights at a particular layer) can be computed to determine the weights that contributed most to the loss of the network. After the derivative is computed, a weight update can be performed by updating all the weights of the filters. For example, the weights can be updated so that they change in the opposite direction of the gradient. The weight update can be denotea as

$$w = {w}_{i} - η \frac{dL}{dW} ,$$

where w denotes a weight, wᵢ denotes the initial weight, and η denotes a learning rate. The learning rate can be set to any suitable value, with a high learning rate including larger weight updates and a lower value indicating smaller weight updates.

The deep learning network 3300 can include any suitable deep network. One example includes a convolutional neural network (CNN), which includes an input layer and an output layer, with multiple hidden layers between the input and out layers. The hidden layers of a CNN include a series of convolutional, nonlinear, pooling (for downsampling), and fully connected layers. The deep learning network 3300 can include any other deep network other than a CNN, such as an autoencoder, a deep belief nets (DBNs), a Recurrent Neural Networks (RNNs), among others.

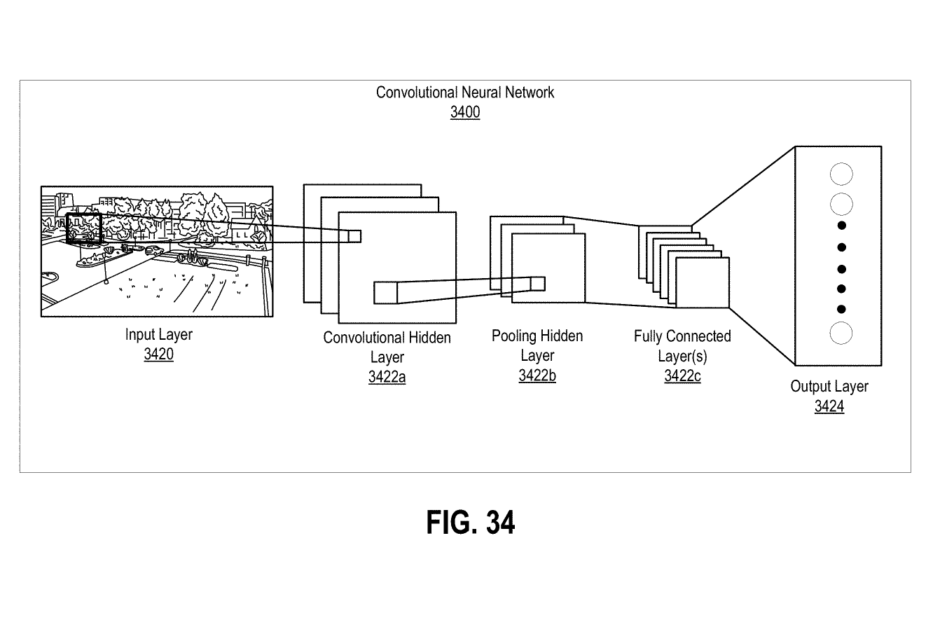

FIG. 34 is an illustrative example of a convolutional neural network 3400 (CNN 3400). The input layer 3420 of the CNN 3400 includes data representing an image. For example, the data can include an array of numbers representing the pixels of the image, with each number in the array including a value from 0 to 255 describing the pixel intensity at that position in the array. Using the previous example from above, the array can include a 28×28×3 array of numbers with 28 rows and 28 columns of pixels and 3 color components (e.g., red, green, and blue, or luma and two chroma components, or the like). The image can be passed through a convolutional hidden layer 3422a, an optional non-linear activation layer, a pooling hidden layer 3422b, and fully connected hidden layers 3422c to get an output at the output layer 3424. While only one of each hidden layer is shown in FIG. 34, one of ordinary skill will appreciate that multiple convolutional hidden layers, non-linear layers, pooling hidden layers, and/or fully connected layers can be included in the CNN 3400. As previously described, the output can indicate a single class of an object or can include a probability of classes that best describe the object in the image.

The first layer of the CNN 3400 is the convolutional hidden layer 3422a. The convolutional hidden layer 3422a analyzes the image data of the input layer 3420. Each node of the convolutional hidden layer 3422a is connected to a region of nodes (pixels) of the input image called a receptive field. The convolutional hidden layer 3422a can be considered as one or more filters (each filter corresponding to a different activation or feature map), with each convolutional iteration of a filter being a node or neuron of the convolutional hidden layer 3422a. For example, the region of the input image that a filter covers at each convolutional iteration would be the receptive field for the filter. In one illustrative example, if the input image includes a 28×28 array, and each filter (and corresponding receptive field) is a 5×5 array, then there will be 24×24 nodes in the convolutional hidden layer 3422a. Each connection between a node and a receptive field for that node learns a weight and, in some cases, an overall bias such that each node learns to analyze its particular local receptive field in the input image. Each node of the hidden layer 3422a will have the same weights and bias (called a shared weight and a shared bias). For example, the filter has an array of weights (numbers) and the same depth as the input. A filter will have a depth of 3 for the video frame example (according to three color components of the input image). An illustrative example size of the filter array is 5×5×3, corresponding to a size of the receptive field of a node.

The convolutional nature of the convolutional hidden layer 3422a is due to each node of the convolutional layer being applied to its corresponding receptive field. For example, a filter of the convolutional hidden layer 3422a can begin in the top-left corner of the input image array and can convolve around the input image. As noted above, each convolutional iteration of the filter can be considered a node or neuron of the convolutional hidden layer 3422a. At each convolutional iteration, the values of the filter are multiplied with a corresponding number of the original pixel values of the image (e.g., the 5×5 filter array is multiplied by a 5×5 array of input pixel values at the top-left corner of the input image array). The multiplications from each convolutional iteration can be summed together to obtain a total sum for that iteration or node. The process is next continued at a next location in the input image according to the receptive field of a next node in the convolutional hidden layer 3422a. For example, a filter can be moved by a step amount to the next receptive field. The step amount can be set to 1 or other suitable amount. For example, if the step amount is set to 1, the filter will be moved to the right by 1 pixel at each convolutional iteration. Processing the filter at each unique location of the input volume produces a number representing the filter results for that location, resulting in a total sum value being determined for each node of the convolutional hidden layer 3422a.

The mapping from the input layer to the convolutional hidden layer 3422a is referred to as an activation map (or feature map). The activation map includes a value for each node representing the filter results at each locations of the input volume. The activation map can include an array that includes the various total sum values resulting from each iteration of the filter on the input volume. For example, the activation map will include a 24×24 array if a 5×5 filter is applied to each pixel (a step amount of 1) of a 28×28 input image. The convolutional hidden layer 3422a can include several activation maps in order to identify multiple features in an image. The example shown in FIG. 34 includes three activation maps. Using three activation maps, the convolutional hidden layer 3422a can detect three different kinds of features, with each feature being detectable across the entire image.

In some examples, a non-linear hidden layer can be applied after the convolutional hidden layer 3422a. The non-linear layer can be used to introduce non-linearity to a system that has been computing linear operations. One illustrative example of a non-linear layer is a rectified linear unit (ReLU) layer. A ReLU layer can apply the function f(x)=max(0, x) to all of the values in the input volume, which changes all the negative activations to 0. The ReLU can thus increase the non-linear properties of the network 2300 without affecting the receptive fields of the convolutional hidden layer 3422a.

The pooling hidden layer 3422b can be applied after the convolutional hidden layer 3422a (and after the non-linear hidden layer when used). The pooling hidden layer 3422b is used to simplify the information in the output from the convolutional hidden layer 3422a. For example, the pooling hidden layer 3422b can take each activation map output from the convolutional hidden layer 3422a and generates a condensed activation map (or feature map) using a pooling function. Max-pooling is one example of a function performed by a pooling hidden layer. Other forms of pooling functions be used by the pooling hidden layer 3422a, such as average pooling, L2-norm pooling, or other suitable pooling functions. A pooling function (e.g., a max-pooling filter, an L2-norm filter, or other suitable pooling filter) is applied to each activation map included in the convolutional hidden layer 3422a. In the example shown in FIG. 34, three pooling filters are used for the three activation maps in the convolutional hidden layer 3422a.

In some examples, max-pooling can be used by applying a max-pooling filter (e.g., having a size of 2×2) with a step amount (e.g., equal to a dimension of the filter, such as a step amount of 2) to an activation map output from the convolutional hidden layer 3422a. The output from a max-pooling filter includes the maximum number in every sub-region that the filter convolves around. Using a 2×2 filter as an example, each unit in the pooling layer can summarize a region of 2×2 nodes in the previous layer (with each node being a value in the activation map). For example, four values (nodes) in an activation map will be analyzed by a 2×2 max-pooling filter at each iteration of the filter, with the maximum value from the four values being output as the “max” value. If such a max-pooling filter is applied to an activation filter from the convolutional hidden layer 3422a having a dimension of 24×24 nodes, the output from the pooling hidden layer 3422b will be an array of 12×12 nodes.

In some examples, an L2-norm pooling filter could also be used. The L2-norm pooling filter includes computing the square root of the sum of the squares of the values in the 2×2 region (or other suitable region) of an activation map (instead of computing the maximum values as is done in max-pooling), and using the computed values as an output.

Intuitively, the pooling function (e.g., max-pooling, L2-norm pooling, or other pooling function) determines whether a given feature is found anywhere in a region of the image, and discards the exact positional information. This can be done without affecting results of the feature detection because, once a feature has been found, the exact location of the feature is not as important as its approximate location relative to other features. Max-pooling (as well as other pooling methods) offer the benefit that there are many fewer pooled features, thus reducing the number of parameters needed in later layers of the CNN 3400.

The final layer of connections in the network is a fully-connected layer that connects every node from the pooling hidden layer 3422b to every one of the output nodes in the output layer 3424. Using the example above, the input layer includes 28×28 nodes encoding the pixel intensities of the input image, the convolutional hidden layer 3422a includes 3×24×24 hidden feature nodes based on application of a 5×5 local receptive field (for the filters) to three activation maps, and the pooling layer 3422b includes a layer of 3×12×12 hidden feature nodes based on application of max-pooling filter to 2×2 regions across each of the three feature maps. Extending this example, the output layer 3424 can include ten output nodes. In such an example, every node of the 3×12×12 pooling hidden layer 3422b is connected to every node of the output layer 3424.

The fully connected layer 3422c can obtain the output of the previous pooling layer 3422b (which should represent the activation maps of high-level features) and determines the features that most correlate to a particular class. For example, the fully connected layer 3422c layer can determine the high-level features that most strongly correlate to a particular class, and can include weights (nodes) for the high-level features. A product can be computed between the weights of the fully connected layer 3422c and the pooling hidden layer 3422b to obtain probabilities for the different classes. For example, if the CNN 3400 is being used to predict that an object in a video frame is a person, high values will be present in the activation maps that represent high-level features of people (e.g., two legs are present, a face is present at the top of the object, two eyes are present at the top left and top right of the face, a nose is present in the middle of the face, a mouth is present at the bottom of the face, and/or other features common for a person).

In some examples, the output from the output layer 3424 can include an M-dimensional vector (in the prior example, M=10), where M can include the number of classes that the program has to choose from when classifying the object in the image. Other example outputs can also be provided. Each number in the N-dimensional vector can represent the probability the object is of a certain class. In one illustrative example, if a 10-dimensional output vector represents ten different classes of objects is [0 0 0.05 0.8 0 0.15 0 0 0 0], the vector indicates that there is a 5% probability that the image is the third class of object (e.g., a dog), an 80% probability that the image is the fourth class of object (e.g., a human), and a 15% probability that the image is the sixth class of object (e.g., a kangaroo). The probability for a class can be considered a confidence level that the object is part of that class.

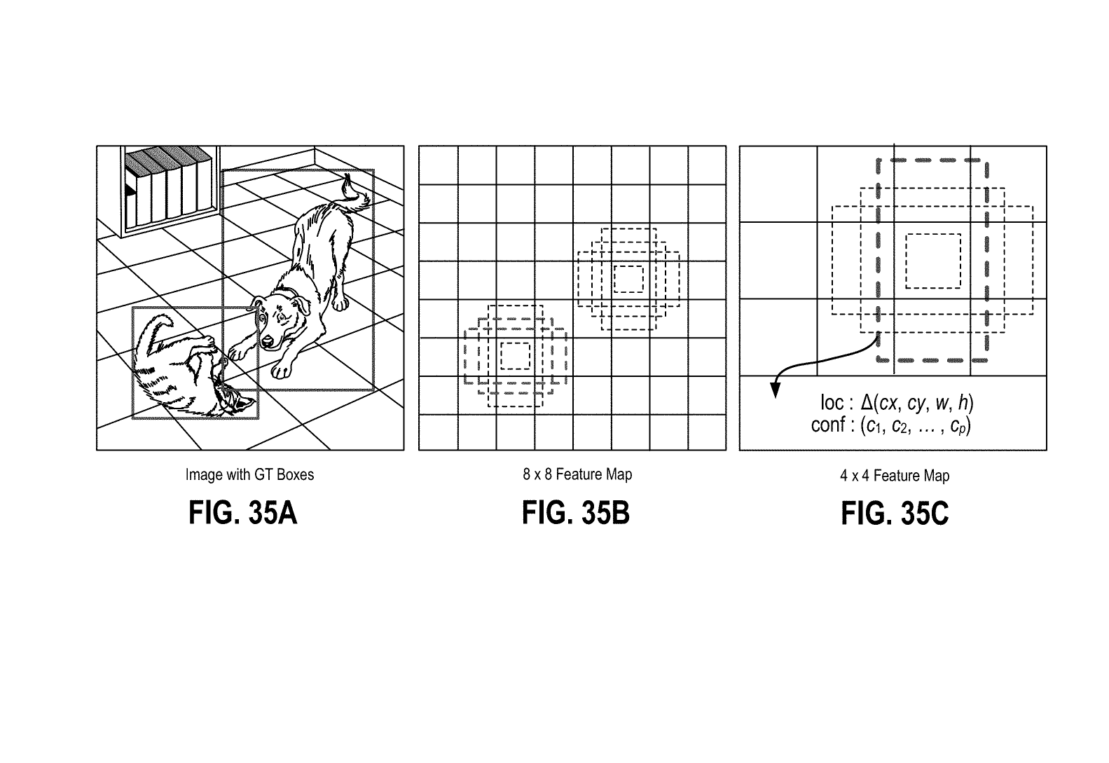

As previously noted, complex object detector system 608 can use any suitable neural network based detector. One example includes the SSD detector, which is a fast single-shot object detector that can be applied for multiple object categories or classes. The SSD model uses multi-scale convolutional bounding box outputs attached to multiple feature maps at the top of the neural network. Such a representation allows the SSD to efficiently model diverse box shapes. FIG. 35A includes an image and FIG. 35B and FIG. 35C include diagrams illustrating how an SSD detector (with the VGG deep network base model) operates. For example, SSD matches objects with default boxes of different aspect ratios (shown as dashed rectangles in FIG. 35B and FIG. 35C). Each element of the feature map has a number of default boxes associated with it. Any default box with an intersection-over-union with a ground truth box over a threshold (e.g., 0.4, 0.5, 0.6, or other suitable threshold) is considered a match for the object. For example, two of the 8×8 boxes (shown in blue in FIG. 35B) are matched with the cat, and one of the 4×4 boxes (shown in red in FIG. 35C) is matched with the dog. SSD has multiple features maps, with each feature map being responsible for a different scale of objects, allowing it to identify objects across a large range of scales. For example, the boxes in the 8×8 feature map of FIG. 35B are smaller than the boxes in the 4×4 feature map of FIG. 35C. In one illustrative example, an SSD detector can have six feature maps in total.

For each default box in each cell, the SSD neural network outputs a probability vector of length c, where c is the number of classes, representing the probabilities of the box containing an object of each class. In some cases, a background class is included that indicates that there is no object in the box. The SSD network also outputs (for each default box in each cell) an offset vector with four entries containing the predicted offsets required to make the default box match the underlying object's bounding box. The vectors are given in the format (cx, cy, w, h), with cx indicating the center x, cy indicating the center y, w indicating the width offsets, and h indicating height offsets. The vectors are only meaningful if there actually is an object contained in the default box. For the image shown in FIG. 35A, all probability labels would indicate the background class with the exception of the three matched boxes (two for the cat, one for the dog).

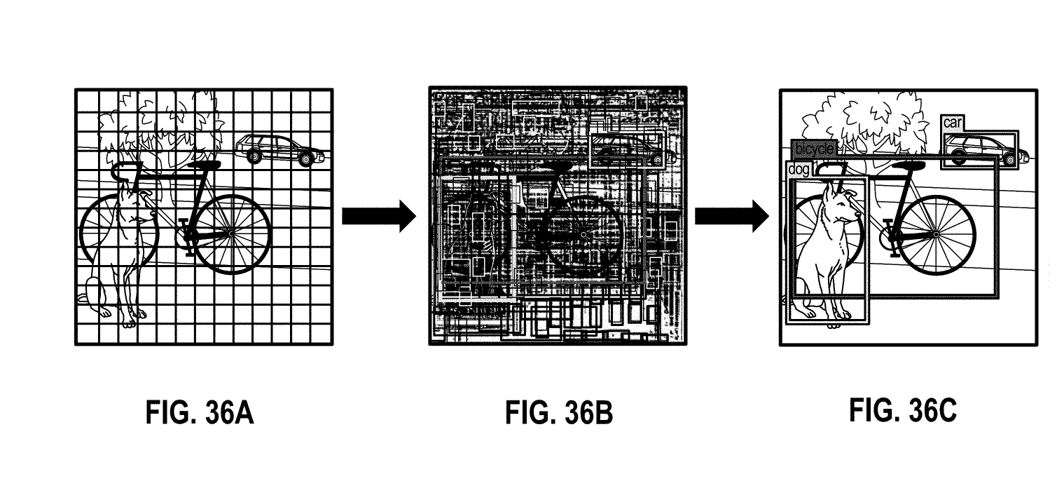

Another deep learning-based detector that can be used by complex object detector system 608 to detect or classify objects in images includes the You only look once (YOLO) detector, which is an alternative to the SSD object detection system. FIG. 36A includes an image and FIG. 36B and FIG. 36C include diagrams illustrating how the YOLO detector operates. The YOLO detector can apply a single neural network to a full image. As shown, the YOLO network divides the image into regions and predicts bounding boxes and probabilities for each region. These bounding boxes are weighted by the predicted probabilities. For example, as shown in FIG. 36A, the YOLO detector divides up the image into a grid of 13-by-13 cells. Each of the cells is responsible for predicting five bounding boxes. A confidence score is provided that indicates how certain it is that the predicted bounding box actually encloses an object. This score does not include a classification of the object that might be in the box, but indicates if the shape of the box is suitable. The predicted bounding boxes are shown in FIG. 36B. The boxes with higher confidence scores have thicker borders.

Each cell also predicts a class for each bounding box. For example, a probability distribution over all the possible classes is provided. Any number of classes can be detected, such as a bicycle, a dog, a cat, a person, a car, or other suitable object class. The confidence score for a bounding box and the class prediction are combined into a final score that indicates the probability that that bounding box contains a specific type of object. For example, the yellow box with thick borders on the left side of the image in FIG. 36B is 85% sure it contains the object class “dog.” There are 169 grid cells (13×13) and each cell predicts 5 bounding boxes, resulting in 1845 bounding boxes in total. Many of the bounding boxes will have very low scores, in which case only the boxes with a final score above a threshold (e.g., above a 30% probability, 40% probability, 50% probability, or other suitable threshold) are kept. FIG. 36C shows an image with the final predicted bounding boxes and classes, including a dog, a bicycle, and a car. As shown, from the 2545 total bounding boxes that were generated, only the three bounding boxes shown in FIG. 36C were kept because they had the best final scores.

The video analytics operations discussed herein may be implemented using compressed video or using uncompressed video frames (before or after compression). An example video encoding and decoding system includes a source device that provides encoded video data to be decoded at a later time by a destination device. In particular, the source device provides the video data to destination device via a computer-readable medium. The source device and the destination device may comprise any of a wide range of devices, including desktop computers, notebook (i.e., laptop) computers, tablet computers, set-top boxes, telephone handsets such as so-called “smart” phones, so-called “smart” pads, televisions, cameras, display devices, digital media players, video gaming consoles, video streaming device, or the like. In some cases, the source device and the destination device may be equipped for wireless communication.

The destination device may receive the encoded video data to be decoded via the computer-readable medium. The computer-readable medium may comprise any type of medium or device capable of moving the encoded video data from source device to destination device. In one example, computer-readable medium may comprise a communication medium to enable source device to transmit encoded video data directly to destination device in real-time. The encoded video data may be modulated according to a communication standard, such as a wireless communication protocol, and transmitted to destination device. The communication medium may comprise any wireless or wired communication medium, such as a radio frequency (RF) spectrum or one or more physical transmission lines. The communication medium may form part of a packet-based network, such as a local area network, a wide-area network, or a global network such as the Internet. The communication medium may include routers, switches, base stations, or any other equipment that may be useful to facilitate communication from source device to destination device.

In some examples, encoded data may be output from output interface to a storage device. Similarly, encoded data may be accessed from the storage device by input interface. The storage device may include any of a variety of distributed or locally accessed data storage media such as a hard drive, Blu-ray discs, DVDs, CD-ROMs, flash memory, volatile or non-volatile memory, or any other suitable digital storage media for storing encoded video data. In a further example, the storage device may correspond to a file server or another intermediate storage device that may store the encoded video generated by source device. Destination device may access stored video data from the storage device via streaming or download. The file server may be any type of server capable of storing encoded video data and transmitting that encoded video data to the destination device. Example file servers include a web server (e.g., for a website), an FTP server, network attached storage (NAS) devices, or a local disk drive. Destination device may access the encoded video data through any standard data connection, including an Internet connection. This may include a wireless channel (e.g., a Wi-Fi connection), a wired connection (e.g., DSL, cable modem, etc.), or a combination of both that is suitable for accessing encoded video data stored on a file server. The transmission of encoded video data from the storage device may be a streaming transmission, a download transmission, or a combination thereof.

The techniques of this disclosure are not necessarily limited to wireless applications or settings. The techniques may be applied to video coding in support of any of a variety of multimedia applications, such as over-the-air television broadcasts, cable television transmissions, satellite television transmissions, Internet streaming video transmissions, such as dynamic adaptive streaming over HTTP (DASH), digital video that is encoded onto a data storage medium, decoding of digital video stored on a data storage medium, or other applications. In some examples, system may be configured to support one-way or two-way video transmission to support applications such as video streaming, video playback, video broadcasting, and/or video telephony.

In one example the source device includes a video source, a video encoder, and a output interface. The destination device may include an input interface, a video decoder, and a display device. The video encoder of source device may be configured to apply the techniques disclosed herein. In other examples, a source device and a destination device may include other components or arrangements. For example, the source device may receive video data from an external video source, such as an external camera. Likewise, the destination device may interface with an external display device, rather than including an integrated display device.

The example system above merely one example. Techniques for processing video data in parallel may be performed by any digital video encoding and/or decoding device. Although generally the techniques of this disclosure are performed by a video encoding device, the techniques may also be performed by a video encoder/decoder, typically referred to as a “CODEC.” Moreover, the techniques of this disclosure may also be performed by a video preprocessor. Source device and destination device are merely examples of such coding devices in which source device generates coded video data for transmission to destination device. In some examples, the source and destination devices may operate in a substantially symmetrical manner such that each of the devices include video encoding and decoding components. Hence, example systems may support one-way or two-way video transmission between video devices, e.g., for video streaming, video playback, video broadcasting, or video telephony.

The video source may include a video capture device, such as a video camera, a video archive containing previously captured video, and/or a video feed interface to receive video from a video content provider. As a further alternative, the video source may generate computer graphics-based data as the source video, or a combination of live video, archived video, and computer-generated video. In some cases, if video source is a video camera, source device and destination device may form so-called camera phones or video phones. As mentioned above, however, the techniques described in this disclosure may be applicable to video coding in general, and may be applied to wireless and/or wired applications. In each case, the captured, pre-captured, or computer-generated video may be encoded by the video encoder. The encoded video information may then be output by output interface onto the computer-readable medium.

As noted, the computer-readable medium may include transient media, such as a wireless broadcast or wired network transmission, or storage media (that is, non-transitory storage media), such as a hard disk, flash drive, compact disc, digital video disc, Blu-ray disc, or other computer-readable media. In some examples, a network server (not shown) may receive encoded video data from the source device and provide the encoded video data to the destination device, e.g., via network transmission. Similarly, a computing device of a medium production facility, such as a disc stamping facility, may receive encoded video data from the source device and produce a disc containing the encoded video data. Therefore, the computer-readable medium may be understood to include one or more computer-readable media of various forms, in various examples.

In the foregoing description, aspects of the application are described with reference to specific embodiments thereof, but those skilled in the art will recognize that the application is not limited thereto. Thus, while illustrative embodiments of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, embodiments can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate embodiments, the methods may be performed in a different order than that described.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

The various illustrative logical blocks, modules, circuits, and algorithm steps described in connection with the embodiments disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein. In addition, in some aspects, the functionality described herein may be provided within dedicated software modules or hardware modules configured for encoding and decoding, or incorporated in a combined video encoder-decoder (CODEC).

What is claimed is:

1. An apparatus for tracking objects in one or more video frames, comprising:
a memory configured to store the one or more video frames; and
a processor coupled to the memory and configured to:
obtain, based on an application of an object detector to at least one key frame in the one or more video frames, a first set of bounding regions for a video frame, wherein the first set of bounding regions are associated with detection of one or more objects in the video frame;
determine a group of bounding regions from the first set of bounding regions, wherein the group of bounding regions includes at least a first bounding region and a second bounding region;
remove a bounding region from the group of bounding regions based on one or more metrics associated with the bounding region; and
perform object tracking for the video frame using an updated set of bounding regions, the updated set of bounding regions being based on removal of the bounding region from the group of bounding regions.

2. The apparatus of claim 1, wherein a key frame is a frame from the one or more video frames to which the object detector is applied.

3. The apparatus of claim 1, wherein the processor is further configured to determine the one or more metrics, and wherein determining the one or more metrics comprises:
determining an intersection-over-union (IoU) ratio associated with the first bounding region and the second bounding region in the group of bounding regions; and
determining the IoU ratio exceeds a first ratio threshold.

4. The apparatus of claim 3, wherein the bounding region is removed based on determining that the IoU ratio exceeds the first ratio threshold.

5. The apparatus of claim 1, wherein the processor is further configured to determine the one or more metrics, and wherein determining the one or more metrics comprises:
determining a first area of a first intersection region between the first bounding region and the second bounding region in the group of bounding regions;
determining a second area of the first bounding region, the first bounding region being smaller than the second bounding region; and
determining a ratio between the first area and the second area.

6. The apparatus of claim 5, wherein the processor is further configured to determine that the ratio exceeds a second ratio threshold, the second ratio threshold being higher than a first ratio threshold, wherein the bounding region is removed based on the ratio exceeding the second ratio threshold.

7. The apparatus of claim 5, wherein the processor is further configured to:
determine that the ratio exceeds a third ratio threshold, the third ratio threshold being lower than a second ratio threshold; and
determine that the first bounding region intersects with the second bounding region at a pre-determined location;
wherein the bounding region is removed based on the ratio exceeding the third ratio threshold and the first bounding region intersecting with the second bounding region at the pre-determined location.

8. The apparatus of claim 5, wherein the processor is further configured to:
determine that the ratio exceeds a fourth ratio threshold, the fourth ratio threshold being lower than each of a second ratio threshold and a third ratio threshold; and
determine that a confidence level of at least one of the first bounding region and the second bounding region is below a first confidence threshold;
wherein the bounding region is removed based on the ratio exceeding the fourth ratio threshold and the confidence level of at least one of the first bounding region and the second bounding region being below the first confidence threshold.

9. The apparatus of claim 1, wherein the group of bounding regions further comprises a third bounding region, and wherein determining the one or more metrics comprises:
determining a third area of a third intersection region between the first bounding region and the third bounding region;
determining a fourth area of a fourth intersection region between the second bounding region and the third bounding region;
determining an aggregate area based on the third area and the fourth area; and
determining a ratio between an area of the third bounding region and the aggregate area.

10. The apparatus of claim 9, wherein the bounding region is removed based on determining that the ratio exceeds a fifth ratio threshold, that each of a first confidence level of the first bounding region and a second confidence level of the second bounding region exceeds a second confidence threshold, and that a third confidence level of the third bounding region is below a third confidence threshold, the third confidence threshold being lower than a second confidence threshold.

11. The apparatus of claim 1, wherein the bounding region is removed from the group of bounding regions further based on a confidence level associated with the bounding region, and wherein the processor is further configured to:
determine the bounding region is associated with a minimum confidence level within the group of bounding regions; and
determine the minimum confidence level is below a fourth confidence threshold;
wherein the bounding region is removed from the group of bounding regions based on the minimum confidence level being below the fourth confidence threshold; and
wherein the object tracking for the video frame is performed without the bounding region.

12. The apparatus of claim 11, wherein the confidence level associated with the bounding region indicates a probability of the bounding region enclosing an object of the one or more objects.

13. The apparatus of claim 1, wherein the processor is further configured to:
determine the first bounding region is the bounding region to be removed from the group of bounding regions;
determine whether the first bounding region and the second bounding region are associated with different objects; and
maintaining the first bounding region in the group of bounding regions in response to determining that the first bounding region and the second bounding region are associated with different objects, wherein the object tracking for the video frame is performed with the updated set of bounding regions including the first bounding region.

14. The apparatus of claim 13, wherein the determination of whether the first bounding region and the second bounding region are associated with different objects is based on trajectories of the first bounding region and the second bounding region across a plurality of video frames.

15. The apparatus of claim 1, wherein the processor is further configured to:
detect one or more blobs for the video frame; and
obtain a set of blob bounding regions based on the detected one or more blobs;
wherein the object tracking is performed based on a combination of the updated set of bounding regions and the set of blob bounding regions.

16. The apparatus of claim 1, wherein the object detector comprises a feature-based detector.

17. The apparatus of claim 1, wherein the object detector is based on a trained classification network.

18. The apparatus of claim 1, wherein the apparatus comprises a mobile device.

19. The apparatus of claim 18, further comprising a camera for capturing the one or more video frames.

20. The apparatus of claim 18, further comprising a display for displaying the one or more video frames.

21. A method of tracking objects in one or more video frames, the method comprising:
obtaining, based on an application of an object detector to at least one key frame in the one or more video frames, a first set of bounding regions for a video frame, wherein the first set of bounding regions are associated with detection of one or more objects in the video frame;
determining a group of bounding regions from the first set of bounding regions, wherein the group of bounding regions includes at least a first bounding region and a second bounding region;
removing the bounding region from the group of bounding regions based on one or more metrics associated with the bounding region; and
performing object tracking for the video frame using an updated set of bounding regions, the updated set of bounding regions being based on removal of the bounding region from the group of bounding regions.

22. The method of claim 21, further comprising determining the one or more metrics, wherein determining the one or more metrics comprises:
determining an intersection-over-union (IoU) ratio associated with the first bounding region and the second bounding region in the group of bounding regions; and
determining the IoU ratio exceeds a first ratio threshold;
wherein the group of bounding regions is determined to include the bounding region for removal based on determining that the IoU ratio exceeds the first ratio threshold.

23. The method of claim 21, further comprising determining the one or more metrics, wherein determining the one or more metrics comprises:
determine a first area of a first intersection region between the first bounding region and the second bounding region in the group of bounding regions;
determine a second area of the first bounding region, the first bounding region being smaller than the second bounding region; and
determine a ratio between the first area and the second area.

24. The method of claim 23, further comprising determining that the ratio exceeds a second ratio threshold, the second ratio threshold being higher than a first ratio threshold, wherein the bounding region is removed based on the ratio exceeding the second ratio threshold.

25. The method of claim 23, further comprising:
determining that the ratio exceeds a third ratio threshold, the third ratio threshold being lower than a second ratio threshold; and
determining that the first bounding region intersects with the second bounding region at a pre-determined location;
wherein the bounding region is removed based on the ratio exceeding the third ratio threshold and the first bounding region intersecting with the second bounding region at the pre-determined location.

26. The method of claim 23, further comprising:
determining that the ratio exceeds a fourth ratio threshold, the fourth ratio threshold being lower than each of a second ratio threshold and a third ratio threshold; and
determining that a confidence level of at least one of the first bounding region and the second bounding region is below a first confidence threshold;
wherein the bounding region is removed based on the ratio exceeding the fourth ratio threshold and the confidence level of at least one of the first bounding region and the second bounding region being below the first confidence threshold.

27. The method of claim 21, wherein the group further comprises a third bounding region, and wherein determining the one or more metrics comprises:
determining a third area of a third intersection region between the first bounding region and the third bounding region;
determining a fourth area of a fourth intersection region between the second bounding region and the third bounding region;
determining an aggregate area based on the third area and the fourth area; and
determining a ratio between an area of the third bounding region and the aggregate area;
wherein the bounding regions is removed based on determining that the ratio exceeds a fifth ratio threshold, that each of a first confidence level of the first bounding region and a second confidence level of the second bounding region exceeds a second confidence threshold, and that a third confidence level of the third bounding region is below a third confidence threshold, the third confidence threshold being lower than a second confidence threshold.

28. The method of claim 21, wherein the bounding region is removed from the group of bounding regions further based on a confidence level associated with the bounding region, and further comprising:
determining the bounding region is associated with a minimum confidence level within the group of bounding regions; and
determining the minimum confidence level is below a fourth confidence threshold;
wherein the bounding region is removed from the group of bounding regions based on that minimum confidence level being below the fourth confidence threshold; and
wherein the object tracking for the video frame is performed without the bounding region.

29. The method of claim 21, further comprising:
determining the first bounding region is the bounding region to be removed from the group of bounding regions;
determining whether the first bounding region and the second bounding region are associated with different objects; and
maintaining the first bounding region in the group in response to determining that the first bounding region and the second bounding region are associated with different objects, wherein the object tracking for the video frame is performed with the updated set of bounding regions including the first bounding region.

30. The apparatus of claim 21, further comprising:
detecting one or more blobs for the video frame; and
obtaining a set of blob bounding regions based on the detected one or more blobs;
wherein the object tracking is performed based on a combination of the updated set of bounding regions and the set of blob bounding regions.
